(19) United States
(12) Patent Application Publication
(10) Pub. No.: US 2007/0213502 A1
(43) Pub. Date: Sep. 13, 2007

(54) Composition for forming insulating layer and insulating film

(76) Inventors: Fumitaka Kondo, Chiba (JP); Yuuko Ootaniuchi, Chiba (JP)

Correspondence Address: WENDEROTH, LIND & PONACK, L.L.P., 2033 K STREET N. W., SUITE 800, WASHINGTON, DC, 20006-1021, US

(21) Appl. No.: 11/715,932

(22) Filed: Mar. 9, 2007

(30) Foreign Application Priority Data
Mar. 9, 2006 (JP) 2006-63596
Nov. 28, 2006 (JP) 2006-319672

(51) Int. Cl. C08G 69/08; C08G 69/26

(52) U.S. Cl. 528/310; 528/353

(57) ABSTRACT

Such a composition for forming an insulating layer improved in insulating property is to be obtained. A composition for forming an insulating layer of an electronic device is provided, and the composition contains at least one polymer selected from a polyamic acid and a derivative of a polyamic acid, and a compound having a functional group capable of reacting with a carboxyl group contained in a constitutional unit of the polymer.

### FIELD OF THE INVENTION

The present invention relates to a composition for forming an insulating layer of an electronic device, and an insulating layer obtained using the same.

### BACKGROUND OF THE INVENTION

A flat panel display, such as a liquid crystal display device, a plasma display panel (PDP) and an organic electroluminescent (EL) display, generally has a portion constituted by patterning a thin film layer, such as an electrode, an MIM (metal-insulator-metal) device, an active device, such as TFT (thin film transistor) and a luminescent device.

A device using an organic material is receiving attention since the device has advantages in production, such as reduction in cost and easiness in producing a large area device, and has potential of exhibiting a function that cannot be attained by an inorganic material.

A method of using a material selected from polyimide, polyamide, polyester and polyacrylate as a gate insulating film of TFT is disclosed, and a simple method for producing an electronic device by a coating operation is disclosed (in JP 2003-258256 A and JP 2003-309268 A). However, the insulating films disclosed in these literatures do not necessarily have good insulating property.

### SUMMARY OF THE INVENTION

In view of the problems associated with the conventional techniques, the invention is to provide a composition for forming an insulating layer capable of providing an insulating layer having good insulating property. The invention is also to provide an insulating film obtained by using the composition, whereby an electronic device having the insulating layer can be produced at low cost.

The invention relates to a composition for forming an insulating layer shown in the item [1] below.

[1] A composition, which is used for forming an insulating layer of an electronic device, containing at least one polymer selected from the group consisting of a polyamic acid and a derivative of a polyamic acid, and a compound having a functional group capable of reacting with a carboxyl group contained in a constitutional unit of the polymer.

### BRIEF DESCRIPTION OF THE DRAWINGS

FIG. 1 is a schematic cross sectional view showing an example of a structure of an electronic device according to the invention.

FIG. 2 is a schematic cross sectional view showing another example of a structure of an electronic device according to the invention.

FIG. 3 is a diagram showing a constitution of a device for evaluating a volume resistivity.

In the figures, numeral 1 denotes a substrate, 2 denotes a gate electrode, 3 denotes an insulating layer, 3A denotes an insulating layer, 3B denotes an insulating layer, 4 denotes a source electrode, 5 denotes a drain electrode, 6 denotes a semiconductor layer, 7 denotes an electrode, and 8 denotes a polyimide thin film.

### DETAILED DESCRIPTION OF THE INVENTION

First, the definitions of terms used in the invention will be described.

A derivative of a tetracarboxylic dianhydride is used as a generic term of a group of compounds including a tetracarboxylic acid having the same skeleton as a tetracarboxylic dianhydride, an acid halide of a tetracarboxylic acid (such as a tetracarboxylic diacid halide), a tetracarboxylate diester diacid halide and a tetracarboxylic monoanhydride diacid halide. A tetracarboxylic acid derivative is used as a generic term of derivatives of a tetracarboxylic dianhydride and a derivative of a tetracarboxylic dianhydride. A compound represented by formula (1) may be abbreviated as a compound (1). The same abbreviation rule may be applied to compounds represented by the other formulae. A symbol, such as A, B and C, surrounded by a hexagon means that the symbol shows a ring. In the chemical structural formulae, a substituent bonded to a ring without definition of a carbon atom, to which the substituent is bonded, means that the substituent is bonded to an arbitrary position of the ring. The percentages (%) referred herein mean percentages by weight unless otherwise indicated. The mass unit (g) in the examples means a value obtained by reading a scale of an electronic balance, and may be expressed as a weight.

The invention relates to the aforementioned item [1] and items [2] to [22] shown below.

[2] The composition according to the item [1], wherein the compound having a functional group capable of reacting with a carboxyl group is a compound having two or more of the functional groups in a molecule.

[3] The composition according to the item [1], wherein the compound having a functional group capable of reacting with a carboxyl group is a compound having oxiranyl, oxiranylene, oxetanyl, thiiranyl, aziridinyl, oxazolinyl or —NCO in a molecule.

[4] The composition according to the item [1], wherein the compound having a functional group capable of reacting with a carboxyl group is a homopolymer or a copolymer of an addition-polymerizable monomer; and the functional group is oxiranyl, oxiranylene, oxetanyl, thiiranyl, aziridinyl, oxazolinyl or —NCO.

[5] The composition according to the item [1], wherein the compound having a functional group capable of reacting with a carboxyl group is an N-phenylmaleimide-glycidyl methacrylate copolymer.

[6] The composition according to the item [1], wherein the polymer is at least one selected from polyamic acids obtained by reacting at least one tetracarboxylic acid derivative selected from the group consisting of tetracarboxylic dianhydrides represented by the following formulae (1) to (40) and derivatives of the tetracarboxylic dianhydrides, or a mixture of the tetracarboxylic acid derivative(s) and at least one other tetracarboxylic acid derivatives, with a diamine; and the compound having a functional group capable of reacting with a carboxyl group contained in a constitutional unit of the polymer is a compound having oxiranyl, oxiranylene, oxetanyl, thiiranyl, aziridinyl, oxazolinyl or —NCO in a molecule:

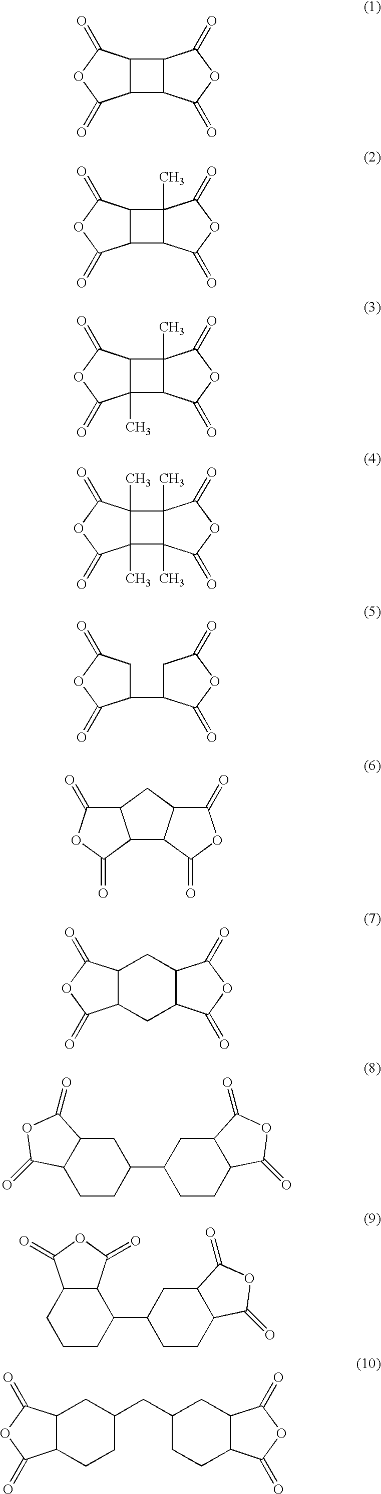

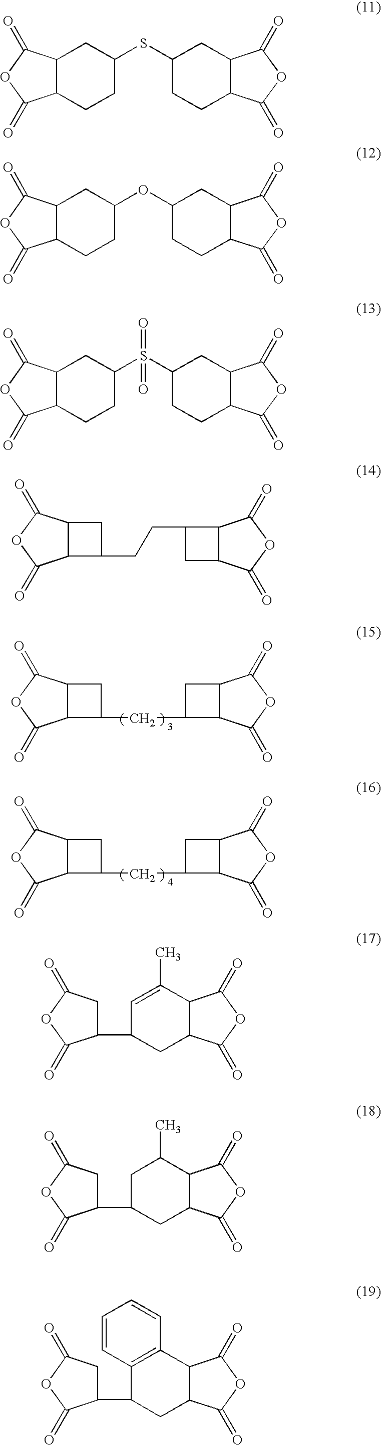

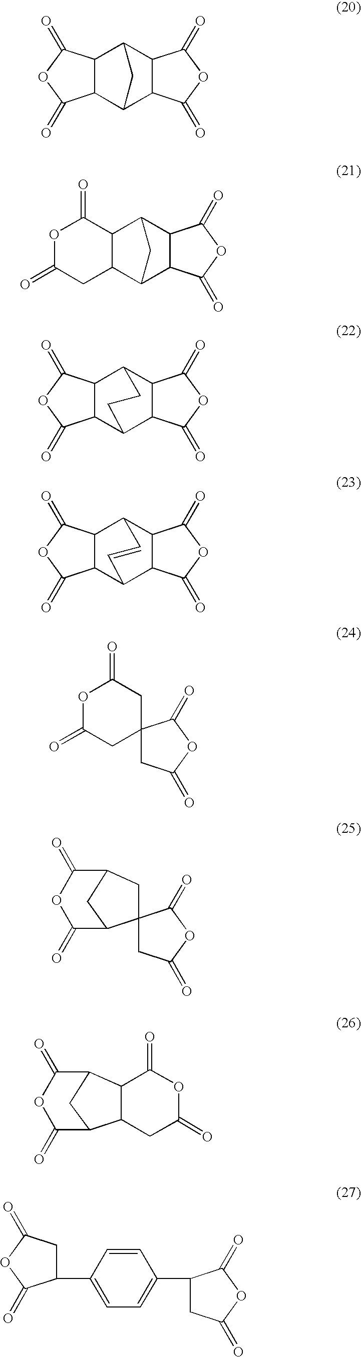

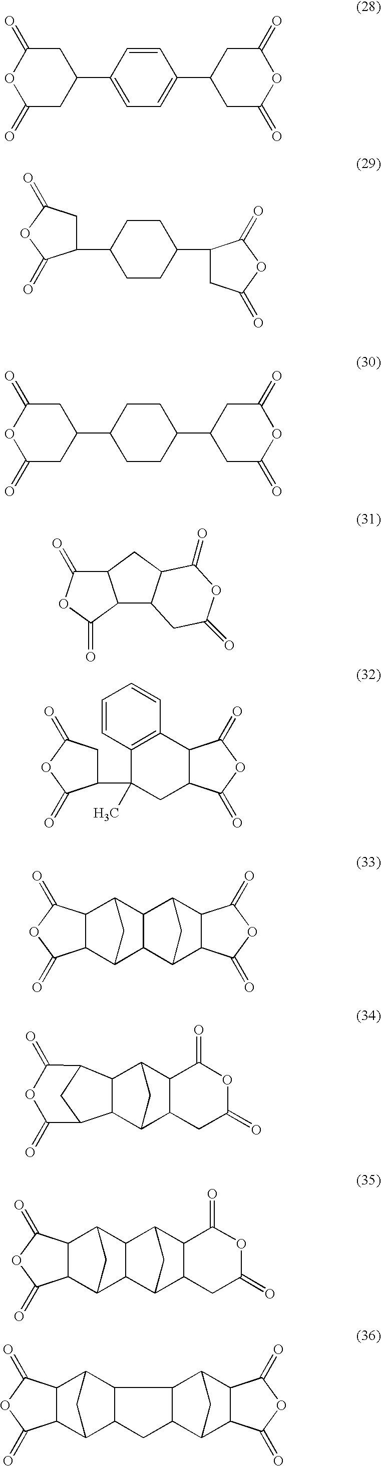

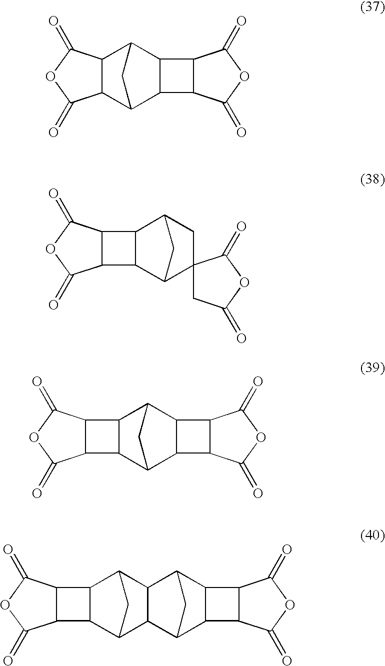

[7] The composition according to the item [6], wherein the compound having a functional group capable of reacting with a carboxyl group is a homopolymer or a copolymer of an addition-polymerizable monomer; and the functional group is oxiranyl, oxiranylene, oxetanyl, thiiranyl, aziridinyl, oxazolinyl or —NCO.

[8] The composition according to the item [6], wherein the compound having a functional group capable of reacting with a carboxyl group is an N-phenylmaleimide-glycidyl methacrylate copolymer.

[9] The composition according to the item [1], wherein the polymer is at least one selected from polyamic acids obtained by reacting at least one tetracarboxylic acid derivative selected from the group consisting of tetracarboxylic dianhydrides represented by the following formulae (1) to (58) and derivatives of the tetracarboxylic dianhydrides, with at least one diamine having a side chain or a mixture of the diamine(s) and at least one diamine having no side chain; and the compound having a functional group capable of reacting with a carboxyl group contained in a constitutional unit of the polymer is a compound having oxiranyl, oxiranylene, oxetanyl, thiiranyl, aziridinyl, oxazolinyl or —NCO in a molecule:

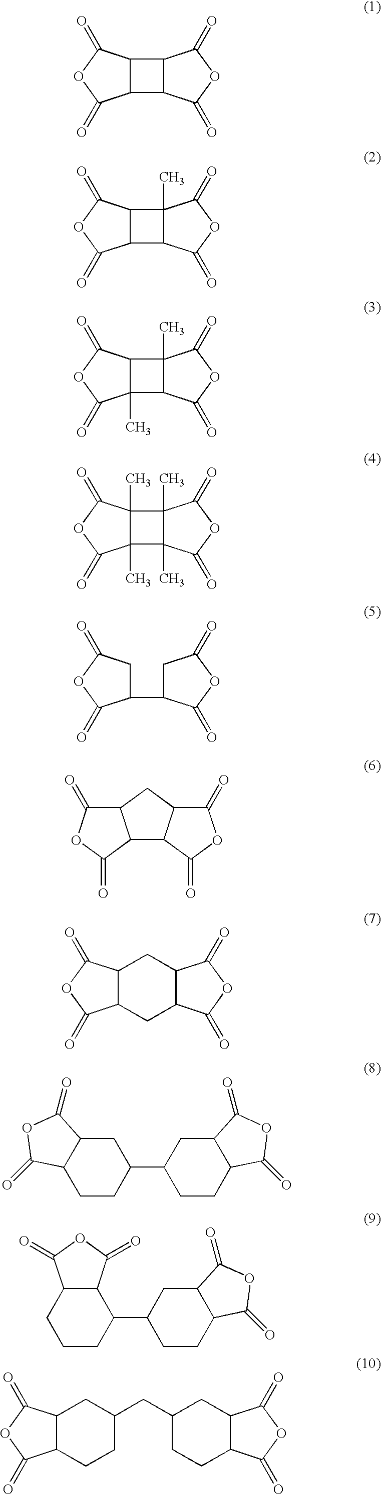

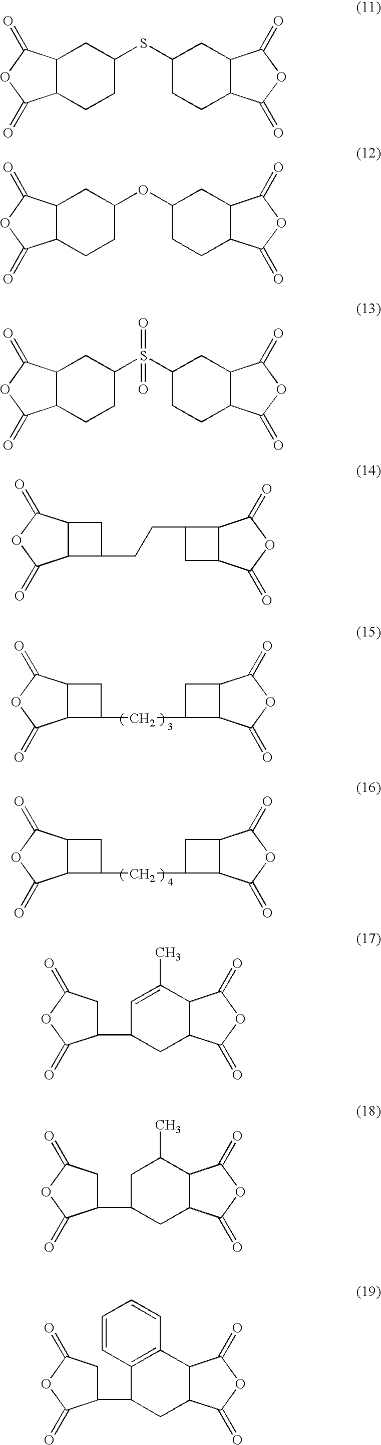

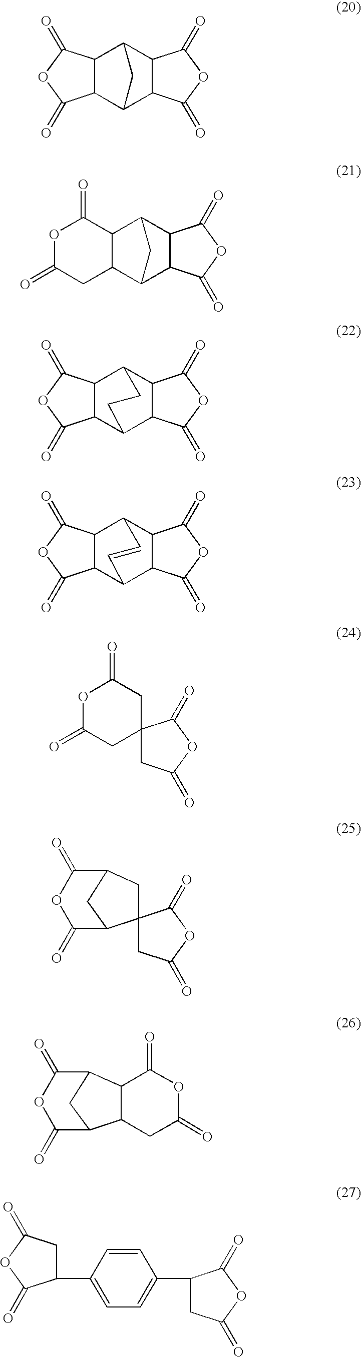

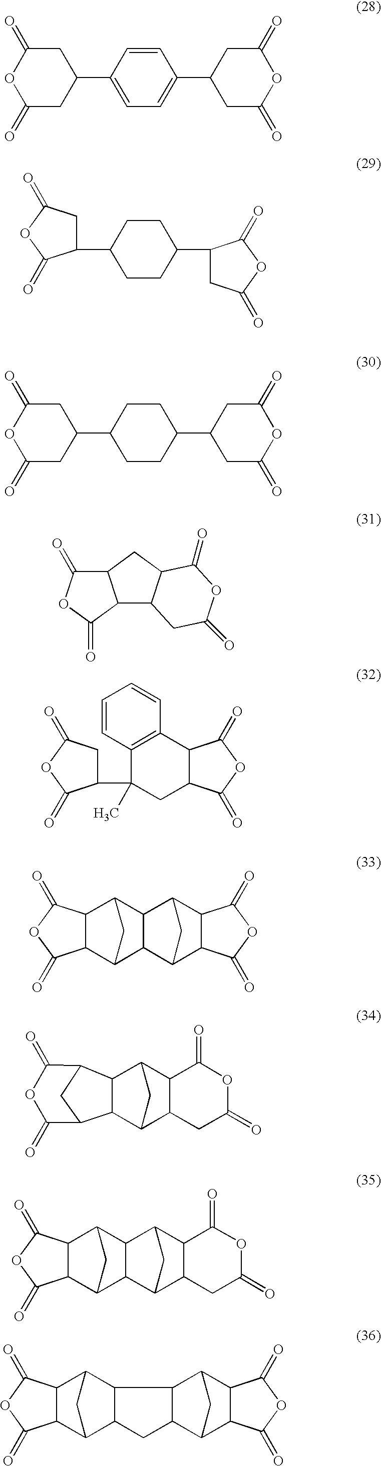

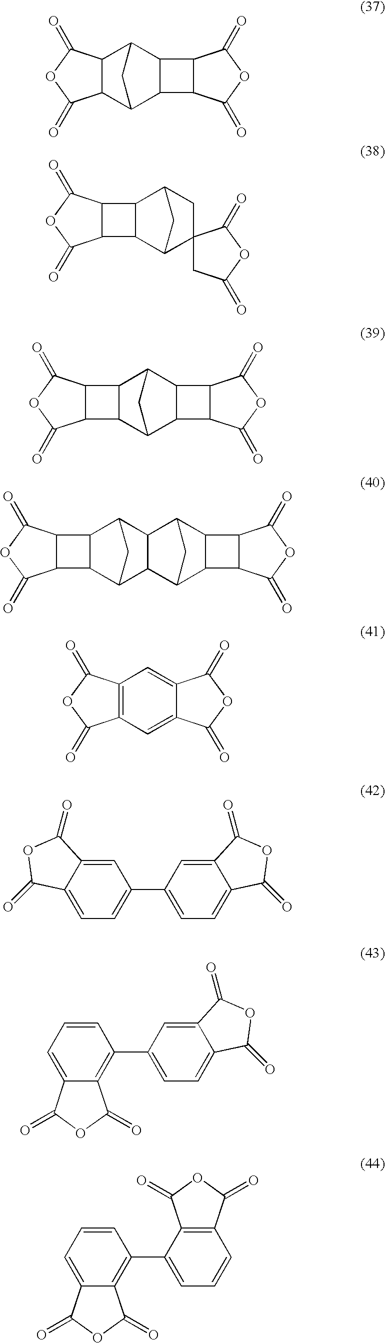

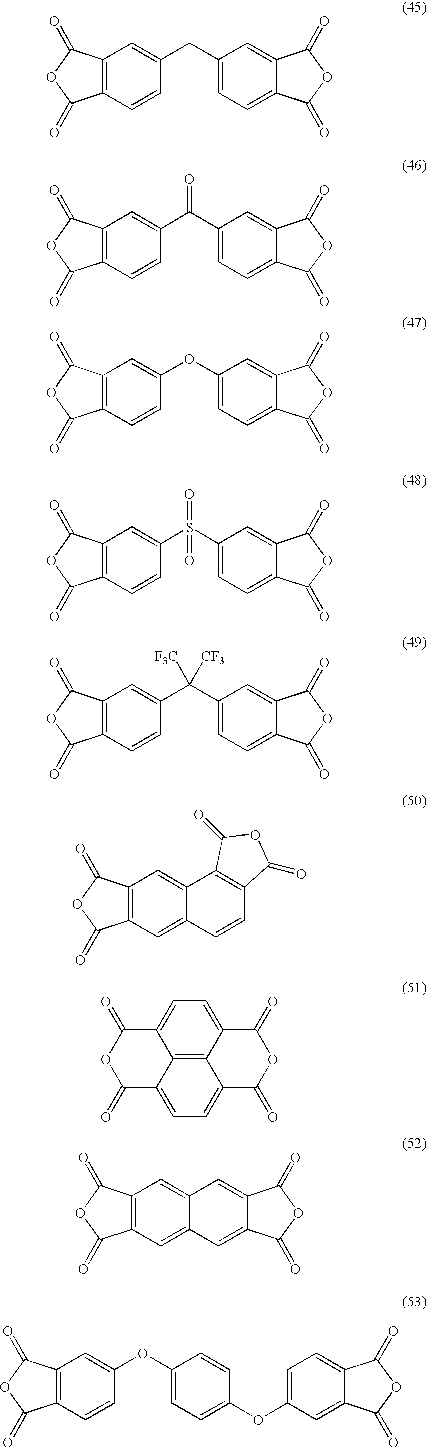

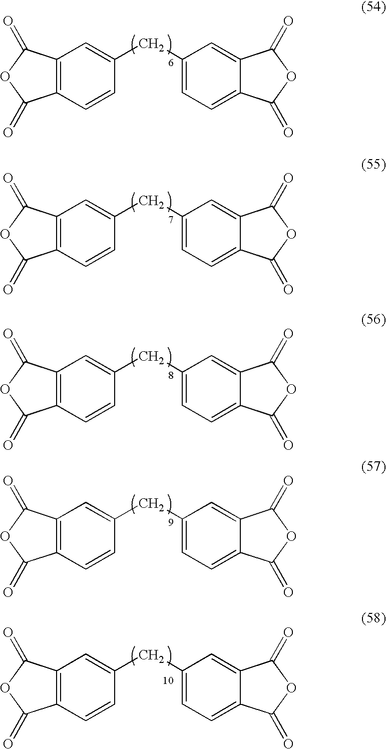

[10] The composition according to the item [9], wherein the compound having a functional group capable of reacting with a carboxyl group is a homopolymer or a copolymer of an addition-polymerizable monomer; and the functional group is oxiranyl, oxiranylene, oxetanyl, thiiranyl, aziridinyl, oxazolinyl or —NCO.

[11] The composition according to the item [9], wherein the compound having a functional group capable of reacting with a carboxyl group is an N-phenylmaleimide-glycidyl methacrylate copolymer.

[12] The composition according to the item [1], wherein the polymer is at least one selected from polyamic acids obtained by reacting at least one tetracarboxylic acid derivative selected from the group consisting of tetracarboxylic dianhydrides represented by the following formulae (1) to (58) and derivatives of the tetracarboxylic dianhydrides, with at least one diamine, which has a side chain, selected from the group consisting of compounds represented by the following formulae (I) to (V), or a mixture of the diamine(s) and at least one diamine having no side chain; and the compound having a functional group capable of reacting with a carboxyl group contained in a constitutional unit of the polymer is a compound having oxiranyl, oxiranylene, oxetanyl, thiiranyl, aziridinyl, oxazolinyl or —NCO in a molecule:

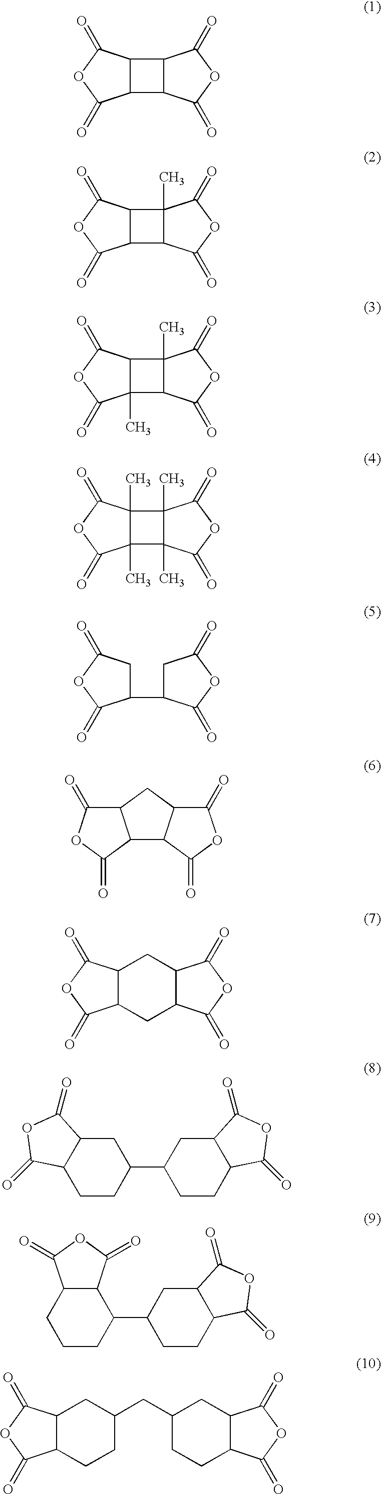

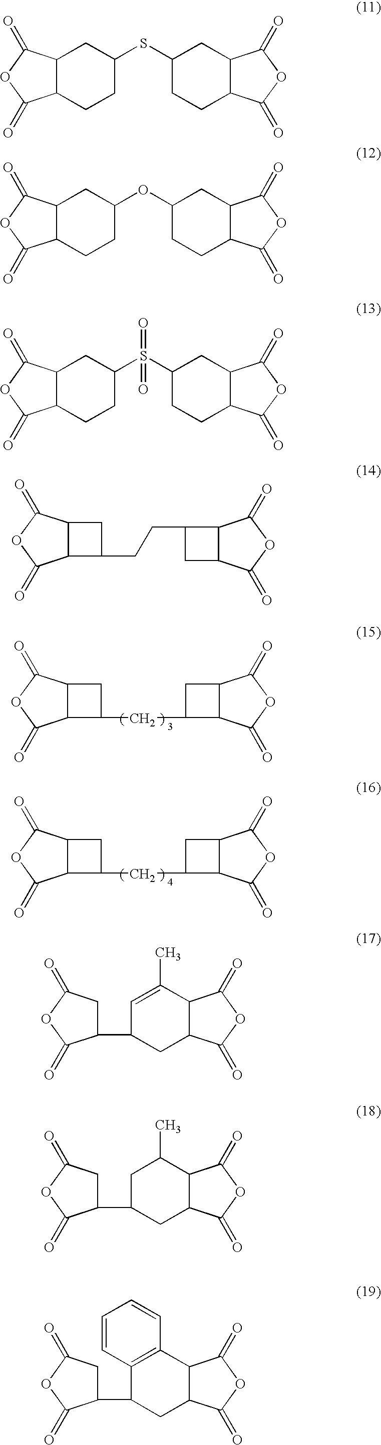

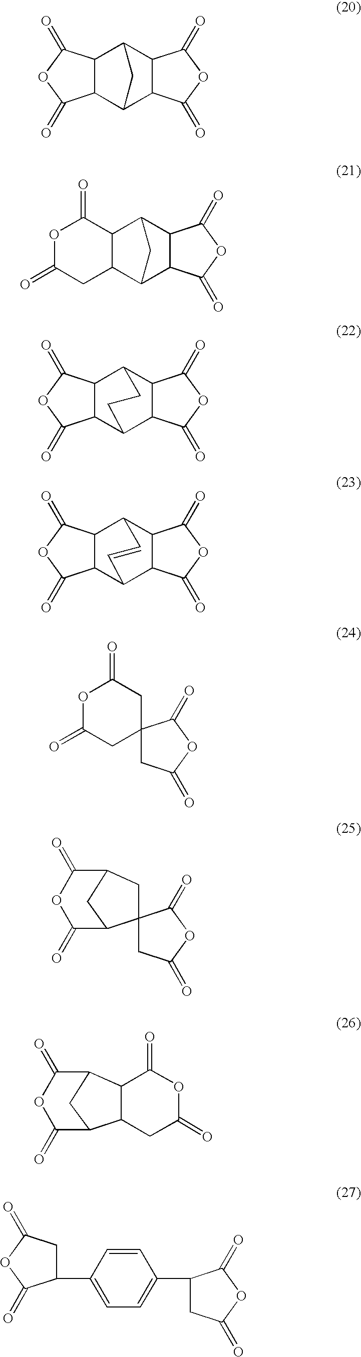

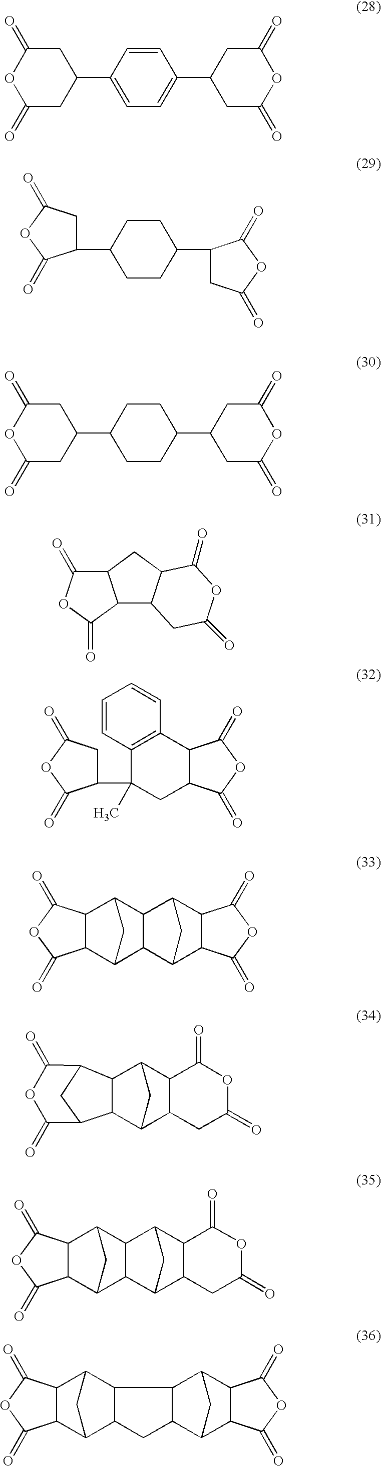

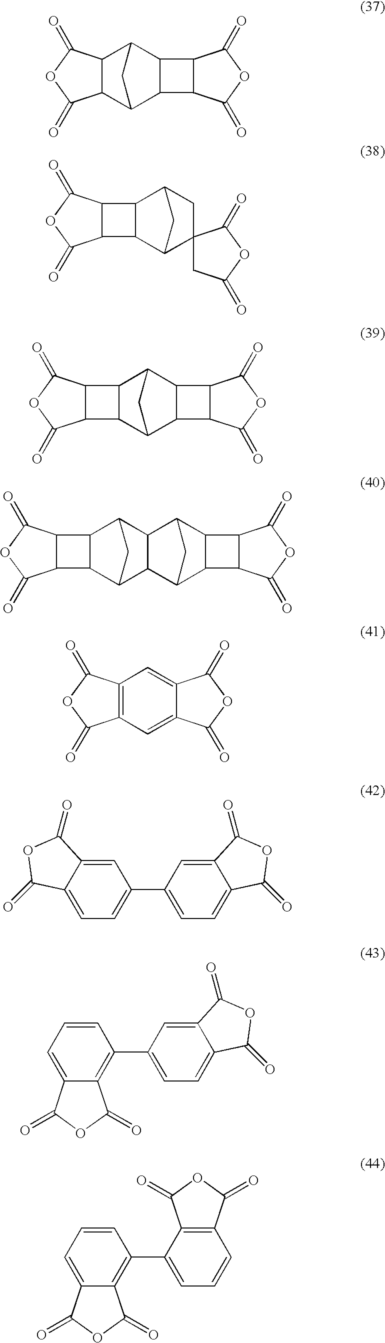

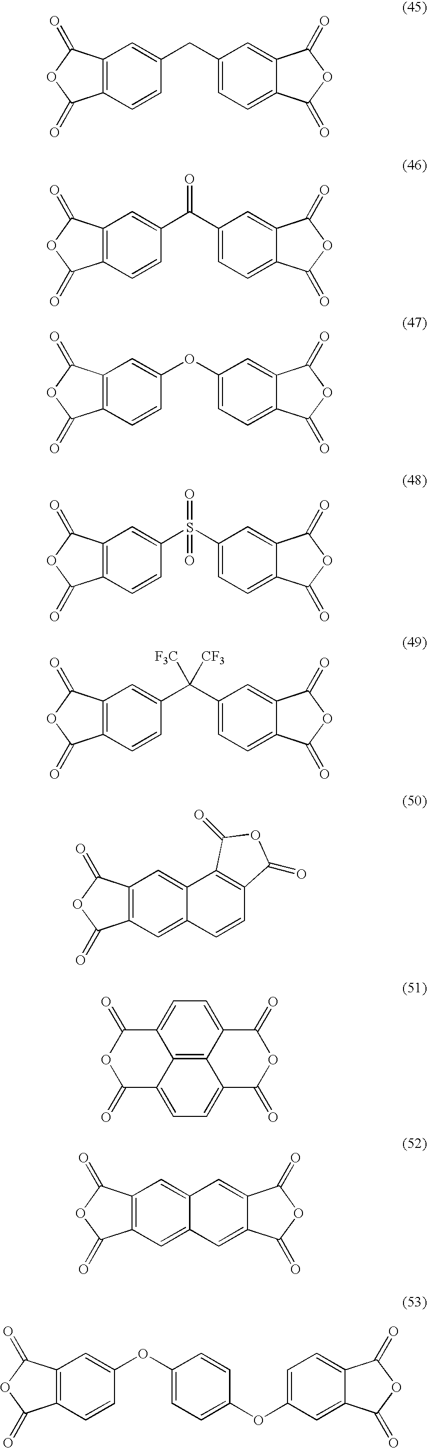

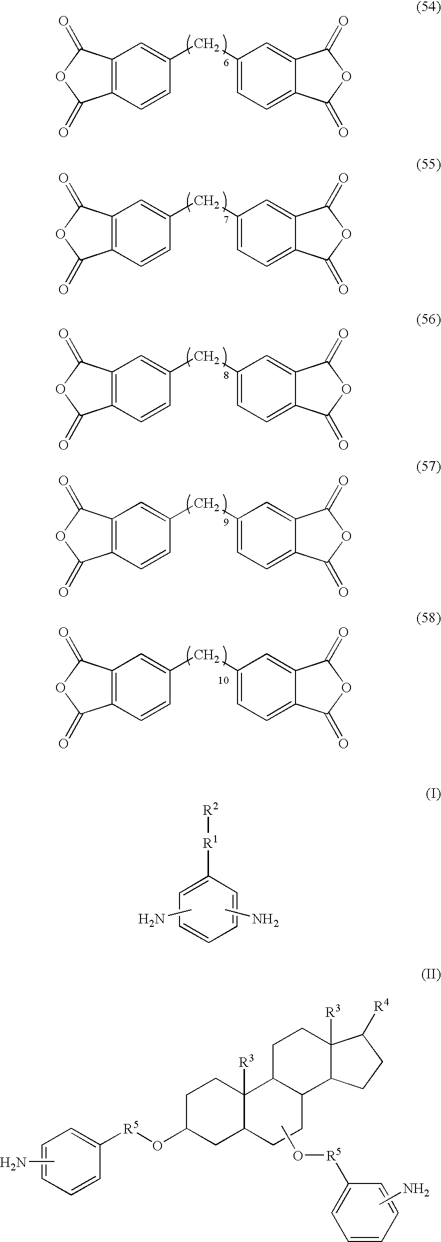

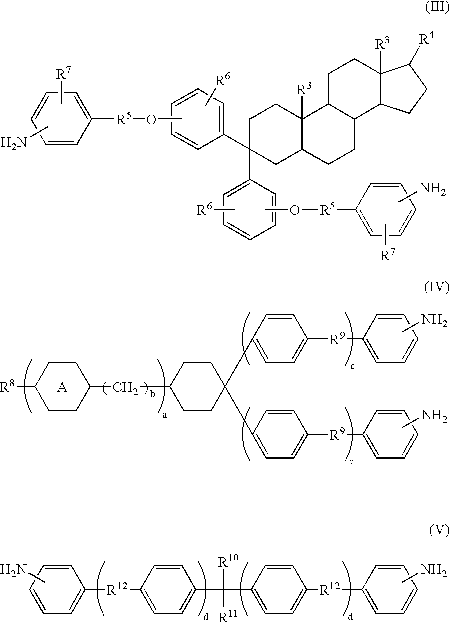

wherein:

in the formula (I), R¹ is a single bond, —O—, —CO—, —COO—, —OCO—, —CONH—, —CH₂O—, —CF₂O— or —(CH₂)ₑ—, wherein e is an integer of from 1 to 6; and R² is a group having a steroid skeleton, a group represented by the following formula (I-a), alkyl having from 1 to 30 carbon atoms, or phenyl, and when the alkyl has from 2 to 6 carbon atoms, arbitrary —CH₂— of the alkyl may be replaced by —O—, —CH═CH— or —C≡C—, and hydrogen of the phenyl may be replaced by fluorine, methyl, methoxy, fluoromethoxy, difluoromethoxy or trifluoromethoxy:

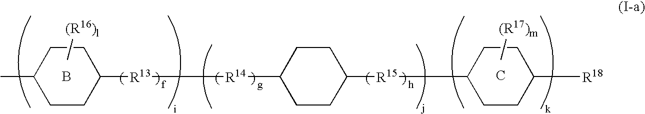

wherein R¹³, R¹⁴ and R¹⁵ are independently a single bond, —O—, —COO—, —OCO—, —CONH—, alkylene having from 1 to 4 carbon atoms, oxyalkylene having from 1 to 3 carbon atoms, or alkyleneoxy having from 1 to 3 carbon atoms; R¹⁶ and R¹⁷ are independently hydrogen, fluorine or methyl; R¹⁸ is hydrogen, fluorine, chlorine, cyano, alkyl having from 1 to 30 carbon atoms, alkoxy having from 1 to 30 carbon atoms, alkoxyalkyl having from 2 to 30 carbon atoms, fluoromethyl, difluoromethyl, trifluoromethyl, fluoromethoxy, difluoromethoxy or trifluoromethoxy, and arbitrary —CH₂— of the alkyl, alkoxy and alkoxyalkyl may be replaced by difluoromethylene or a group represented by the following formula (I-b); ring B and ring C are independently 1,4-phenylene or 1,4-cyclohexylene; f, g and h are independently an integer of from 0 to 4; i, j and k are independently an integer of from 0 to 3, and the sum of i, j and k is 1 or more; and l and m are independently 1 or 2:

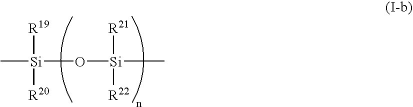

wherein R¹⁹, R²⁰, R²¹ and R²² are independently alkyl having from 1 to 10 carbon atoms or phenyl; and n is an integer of from 1 to 100;

in the formula (II), R³ is independently hydrogen or methyl; R⁴ is hydrogen or alkyl having from 1 to 30 carbon atoms; and R⁵ is independently a single bond, —CO— or —CH₂—;

in the formula (III), R³ is independently hydrogen or methyl; R⁴ is hydrogen or alkyl having from 1 to 30 carbon atoms; R⁵ is independently a single bond, —CO— or —CH₂—; and R⁶ and R⁷ are independently hydrogen, alkyl having 1 to 30 carbon atoms or phenyl;

in the formula (IV), R⁸ is hydrogen or alkyl having from 1 to 30 carbon atoms, and arbitrary —CH₂— of the alkyl may be replaced by —O—, —CH═CH— or —C≡C—; R⁹ is independently —O— or alkylene having from 1 to 6 carbon atoms; ring A is 1,4-phenylene or 1,4-cyclohexylene; a is 0 or 1; b is 0, 1 or 2; and c is independently 0 or 1; and

in the formula (V), R¹⁰ is alkyl having from 3 to 30 carbon atoms or fluorinated alkyl having from 3 to 30 carbon atoms; R¹¹ is hydrogen, alkyl having from 1 to 30 carbon atoms or fluorinated alkyl having from 1 to 30 carbon atoms; R¹² is independently —O— or alkylene having from 1 to 6 carbon atoms; and d is independently 0 or 1.

[13] The composition according to the item [12], wherein the compound having a functional group capable of reacting with a carboxyl group is a homopolymer or a copolymer of an addition-polymerizable monomer; and the functional group is oxiranyl, oxiranylene, oxetanyl, thiiranyl, aziridinyl, oxazolinyl or —NCO.

[14] The composition according to the item [12], wherein the compound having a functional group capable of reacting with a carboxyl group is an N-phenylmaleimide-glycidyl methacrylate copolymer.

[15] The composition according to the item [1], wherein the polymer is a mixture of a polyamic acid obtained by reacting at least one tetracarboxylic acid derivative selected from the group consisting of tetracarboxylic dianhydrides represented by the following formulae (1) to (40) and derivatives of the tetracarboxylic dianhydrides, or a mixture of the tetracarboxylic acid derivative(s) and at least one other tetracarboxylic acid derivatives, with a diamine, and a polyamic acid obtained by reacting at least one tetracarboxylic acid derivative selected from the group consisting of tetracarboxylic dianhydrides represented by the following formulae (1) to (58) and derivatives of the tetracarboxylic dianhydrides, with at least one diamine, which has a side chain, selected from the group consisting of compounds represented by the following formulae (I) to (V), or a mixture of the diamine(s) and at least one diamine having no side chain; and the compound having a functional group capable of reacting with a carboxyl group contained in a constitutional unit of the polymer is a compound having oxiranyl, oxiranylene, oxetanyl, thiiranyl, aziridinyl, oxazolinyl or —NCO in a molecule:

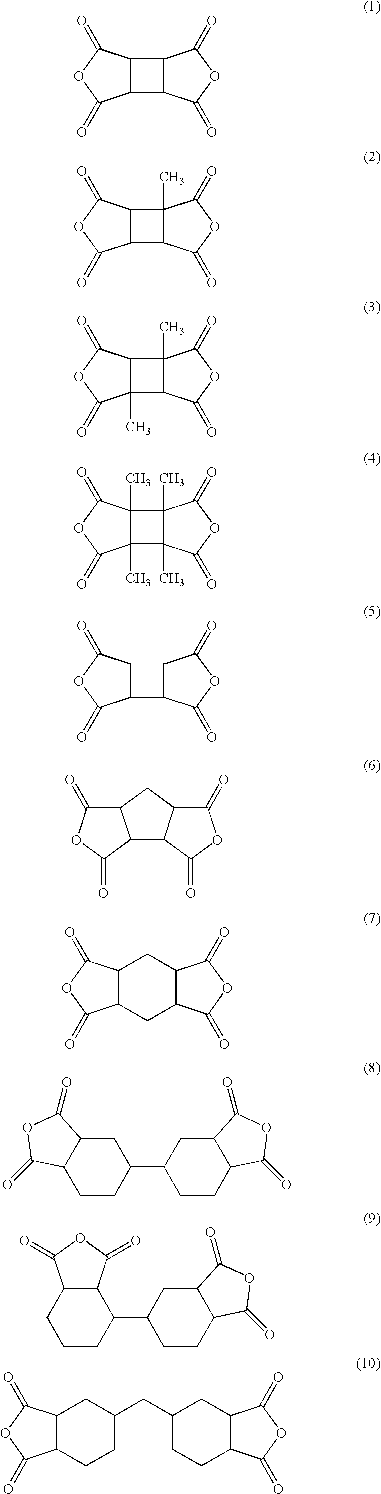

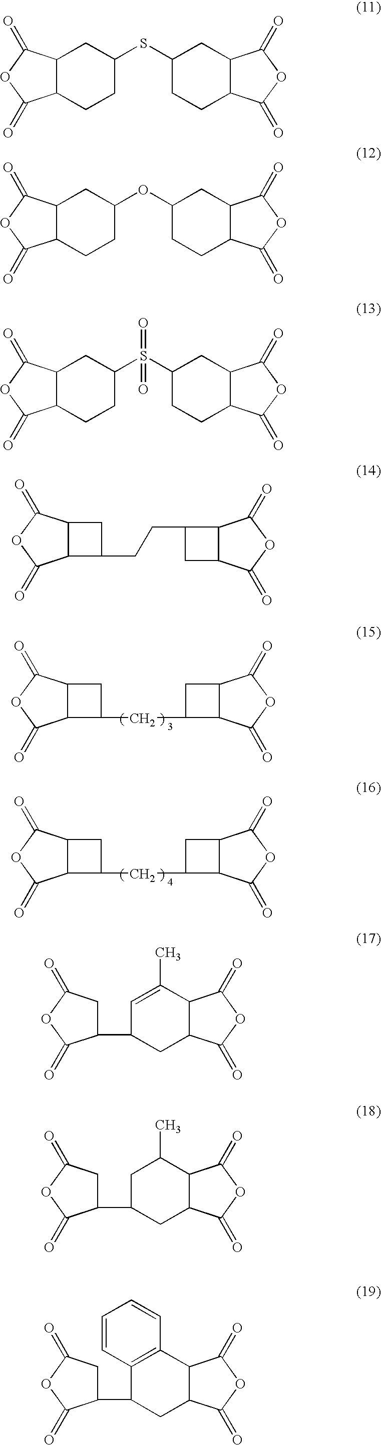

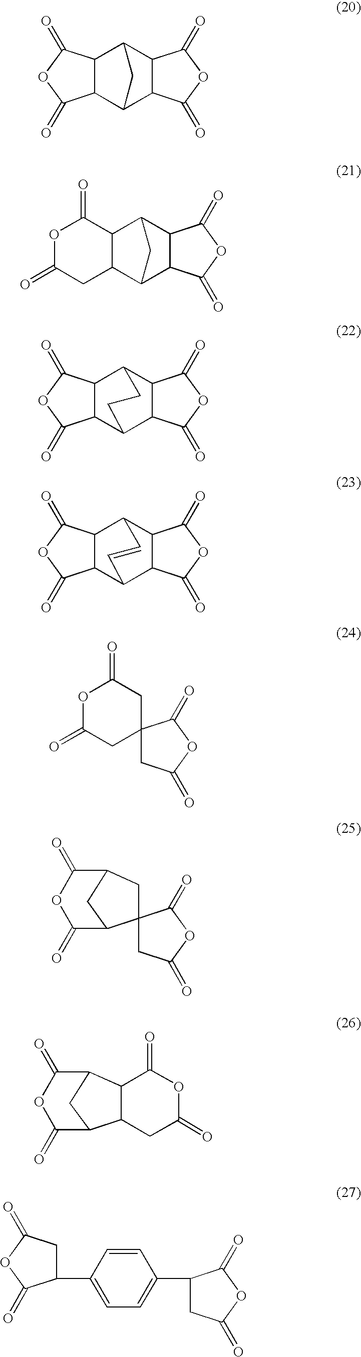

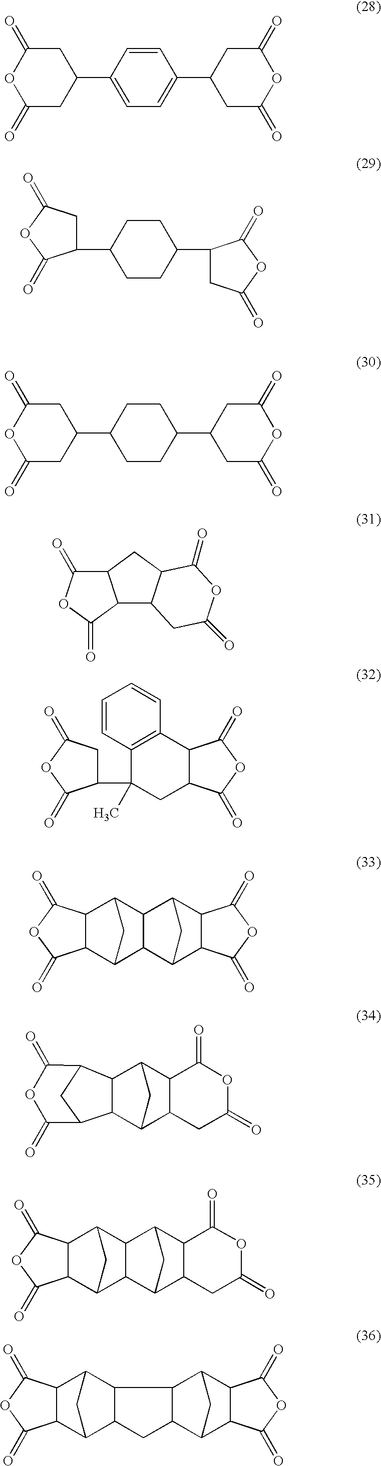

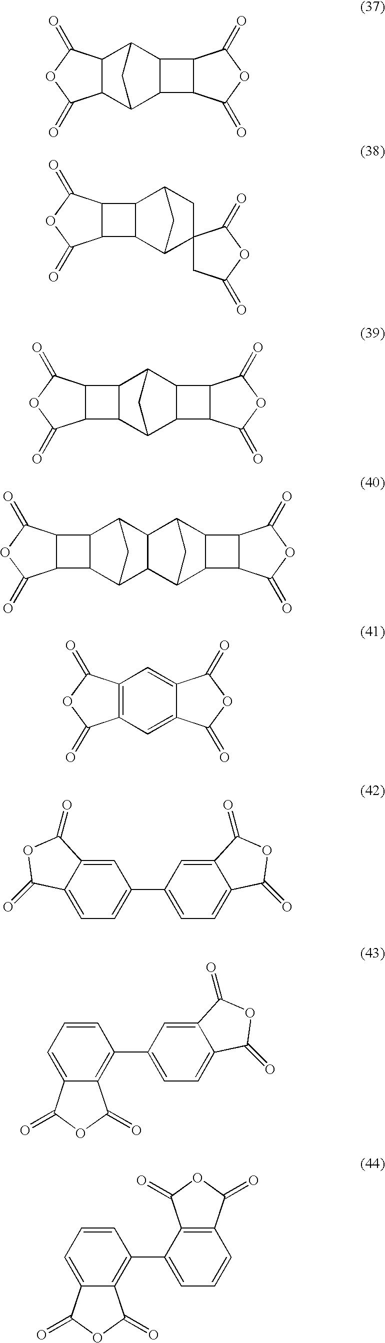

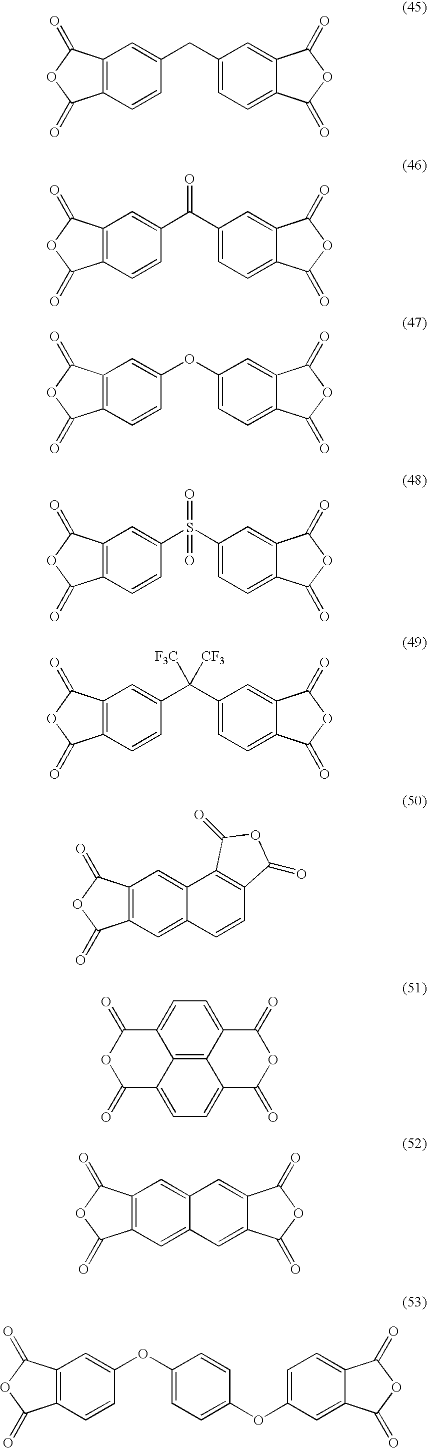

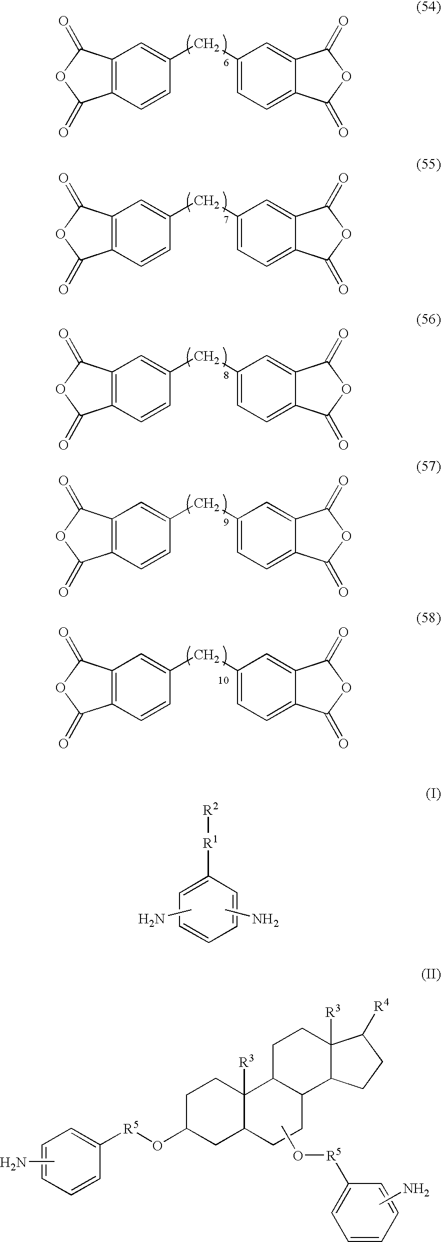

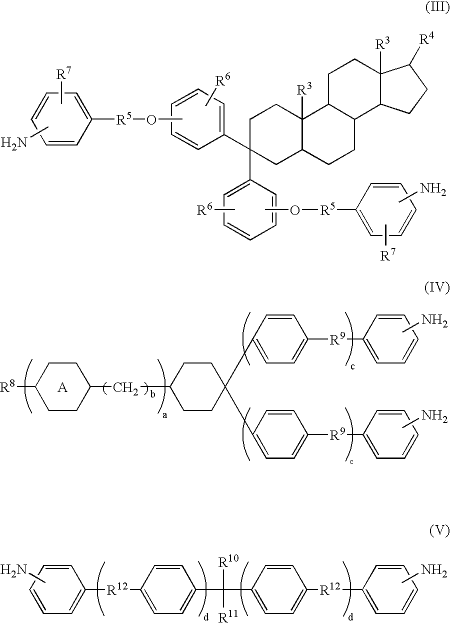

wherein:

in the formula (I), R¹ is a single bond, —O—, —CO—, —COO—, —OCO—, —CONH—, —CH₂O—, —CF₂O— or —(CH₂)ₑ—, wherein e is an integer of from 1 to 6; and R² is a group having a steroid skeleton, a group represented by the following formula (I-a), alkyl having from 1 to 30 carbon atoms, or phenyl, and when the alkyl has from 2 to 6 carbon atoms, arbitrary —CH₂— of the alkyl may be replaced by —O—, —CH═CH— or —C≡C—, and hydrogen of the phenyl may be replaced by fluorine, methyl, methoxy, fluoromethoxy, difluoromethoxy or trifluoromethoxy:

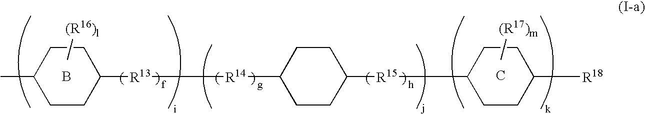

wherein R¹³, R¹⁴ and R¹⁵ are independently a single bond, —O—, —COO—, —OCO—, —CONH—, alkylene having from 1 to 4 carbon atoms, oxyalkylene having from 1 to 3 carbon atoms, or alkyleneoxy having from 1 to 3 carbon atoms; R¹⁶ and R¹⁷ are independently hydrogen, fluorine or methyl; R¹⁸ is hydrogen, fluorine, chlorine, cyano, alkyl having from 1 to 30 carbon atoms, alkoxy having from 1 to 30 carbon atoms, alkoxyalkyl having from 2 to 30 carbon atoms, fluoromethyl, difluoromethyl, trifluoromethyl, fluoromethoxy, difluoromethoxy or trifluoromethoxy, and arbitrary —CH₂— of the alkyl, alkoxy and alkoxyalkyl may be replaced by difluoromethylene or a group represented by the following formula (I-b); ring B and ring C are independently 1,4-phenylene or 1,4-cyclohexylene; f, g and h are independently an integer of from 0 to 4; i, j and k are independently an integer of from 0 to 3, and the sum of i, j and k is 1 or more; and l and m are independently 1 or 2:

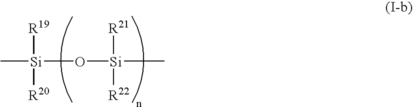

wherein R¹⁹, R²⁰, R²¹ and R²² are independently alkyl having from 1 to 10 carbon atoms or phenyl; and n is an integer of from 1 to 100;

in the formula (II), R³ is independently hydrogen or methyl; R⁴ is hydrogen or alkyl having from 1 to 30 carbon atoms; and R⁵ is independently a single bond, —CO— or —CH₂—;

in the formula (III), R³ is independently hydrogen or methyl; R⁴ is hydrogen or alkyl having from 1 to 30 carbon atoms; R⁵ is independently a single bond, —CO— or —CH₂—; and R⁶ and R⁷ are independently hydrogen, alkyl having 1 to 30 carbon atoms or phenyl;

in the formula (IV), R⁸ is hydrogen or alkyl having from 1 to 30 carbon atoms, and arbitrary —CH₂— of the alkyl may be replaced by —O—, —CH═CH— or —C≡C—; R⁹ is independently —O— or alkylene having from 1 to 6 carbon atoms; ring A is 1,4-phenylene or 1,4-cyclohexylene; a is 0 or 1; b is 0, 1 or 2; and c is independently 0 or 1; and

in the formula (V), R¹⁰ is alkyl having from 3 to 30 carbon atoms or fluorinated alkyl having from 3 to 30 carbon atoms; R¹¹ is hydrogen, alkyl having from 1 to 30 carbon atoms or fluorinated alkyl having from 1 to 30 carbon atoms; R¹² is independently —O— or alkylene having from 1 to 6 carbon atoms; and d is independently 0 or 1.

[16] The composition according to the item [15], wherein the compound having a functional group capable of reacting with a carboxyl group is a homopolymer or a copolymer of an addition-polymerizable monomer; and the functional group is oxiranyl, oxiranylene, oxetanyl, thiiranyl, aziridinyl, oxazolinyl or —NCO.

[17] The composition according to the item [15], wherein the compound having a functional group capable of reacting with a carboxyl group is an N-phenylmaleimide-glycidyl methacrylate copolymer.

[18] The composition according to the item [15], wherein the polymer is a mixture of a polyamic acid obtained by reacting at least one tetracarboxylic dianhydride represented by the formulae (1) to (40) with a diamine, and a polyamic acid obtained by reacting at least one tetracarboxylic dianhydride represented by the formulae (1) to (58) with at least one diamine represented by the formula (I).

[19] The composition according to the item [15], wherein the polymer is a mixture of a polyamic acid obtained by reacting a tetracarboxylic dianhydride represented by the formula (1) and a tetracarboxylic dianhydride represented by the formula (7) with 4,4′-diaminodiphenylmethane, and a polyamic acid obtained by reacting a tetracarboxylic dianhydride represented by the formula (1) with a diamine represented by the following formula (1-25):

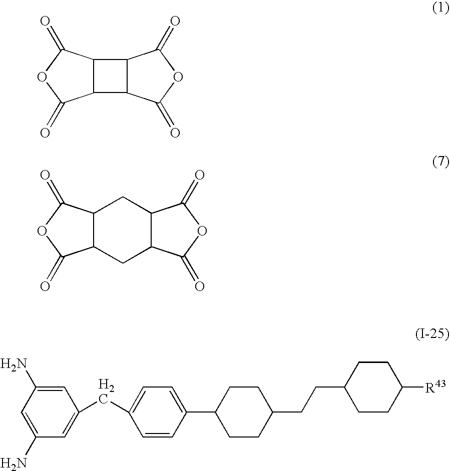

wherein R⁴³ is hydrogen, alkyl having from 1 to 30 carbon atoms or alkoxy having from 1 to 30 carbon atoms.

[20] A thin film obtained by using the composition according to one of the items [1] to [19].

An insulating layer provided on a substrate by using the composition according to one of the items [1] to [19].

[22] An electronic device containing the insulating layer according to the item [21].

The composition for forming an insulating layer according to the invention will be described in detail below.

The composition for forming an insulating layer is a composition containing at least one polymer selected from the group consisting of a polyamic acid and a derivative of a polyamic acid, and a compound having a functional group capable of reacting with a carboxyl group contained in a constitutional unit of the polymer. Examples of the derivative of a polyamic acid include a polyimide obtained through total or partial dehydration ring-closing reaction of a polyamic acid, a polyamic acid ester obtained by totally or partially esterifying carboxyl groups of a polyamic acid, a polyamic acid-polyamide copolymer obtained through reaction of a tetracarboxylic dianhydride having been partially replaced by a dicarboxylic acid halide or the like, and a polyamideimide obtained through total or partial dehydration ring-closing reaction of a polyamic acid-polyamide copolymer.

A polyamic acid is a polymer obtained by reacting a tetracarboxylic dianhydride with a diamine. One of preferred examples of the polyamic acid is a polymer obtained by reacting at least one tetracarboxylic acid derivative selected from the group consisting of tetracarboxylic dianhydrides represented by the formulae (1) to (40) shown below and derivatives of the tetracarboxylic dianhydrides, with a diamine. In the preferred examples, the tetracarboxylic acid derivative may be used in combination with at least one tetracarboxylic acid derivative having a skeleton that is different from the skeletons shown by the formulae (1) to (40). The polyamic acid is referred to as a polyamic acid (A-1). The polyamic acid (A-1) and derivatives thereof are generically referred to as a polyamic acid A. The polyamic acid (A-1) is preferred as the polyamic acid A.

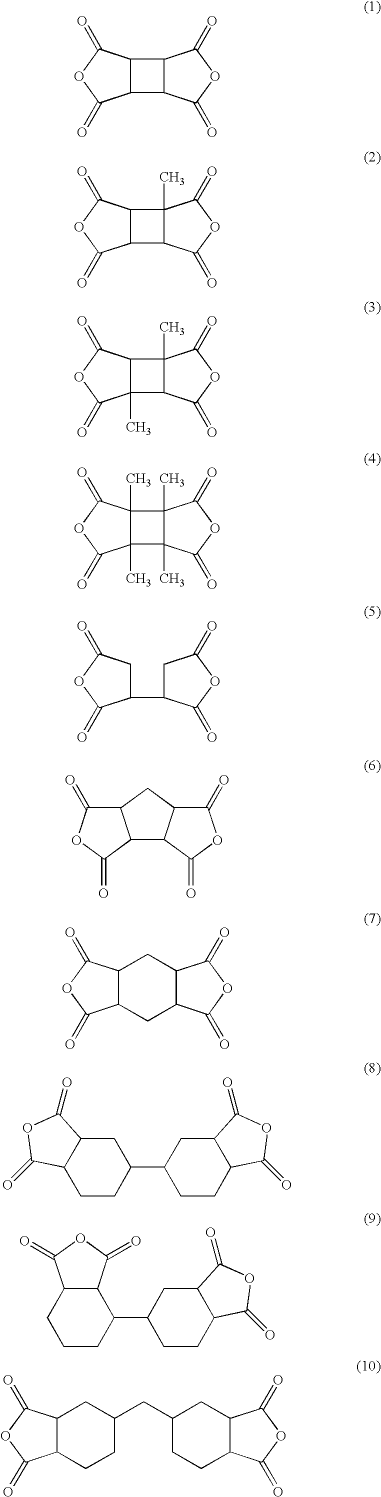

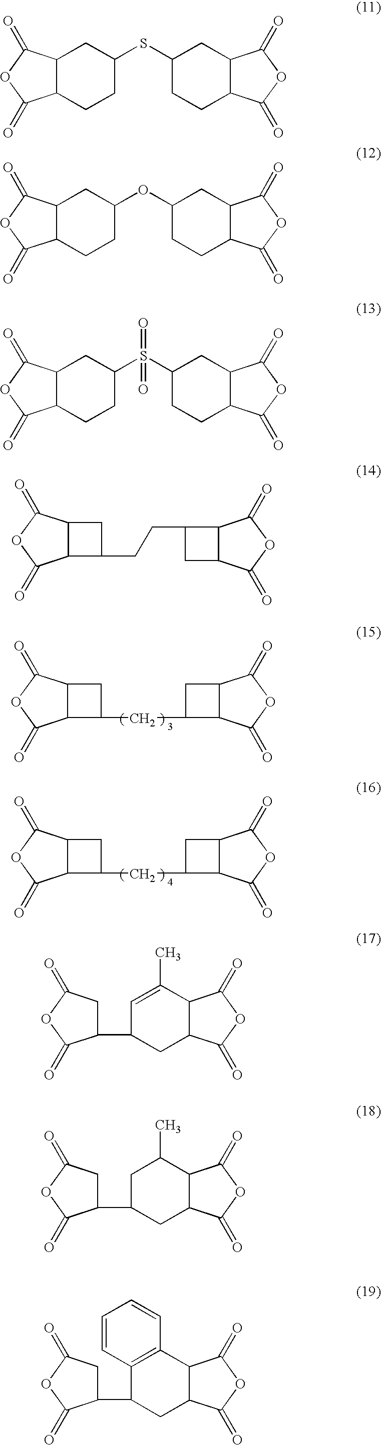

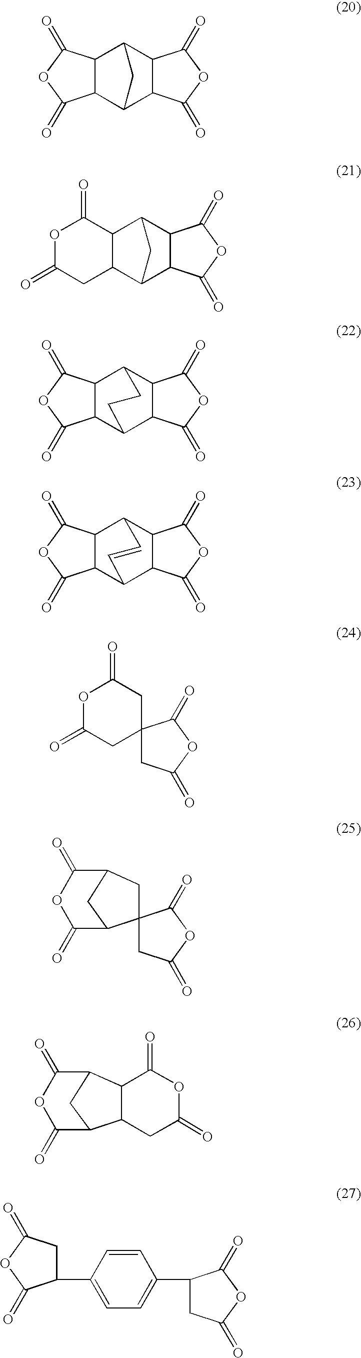

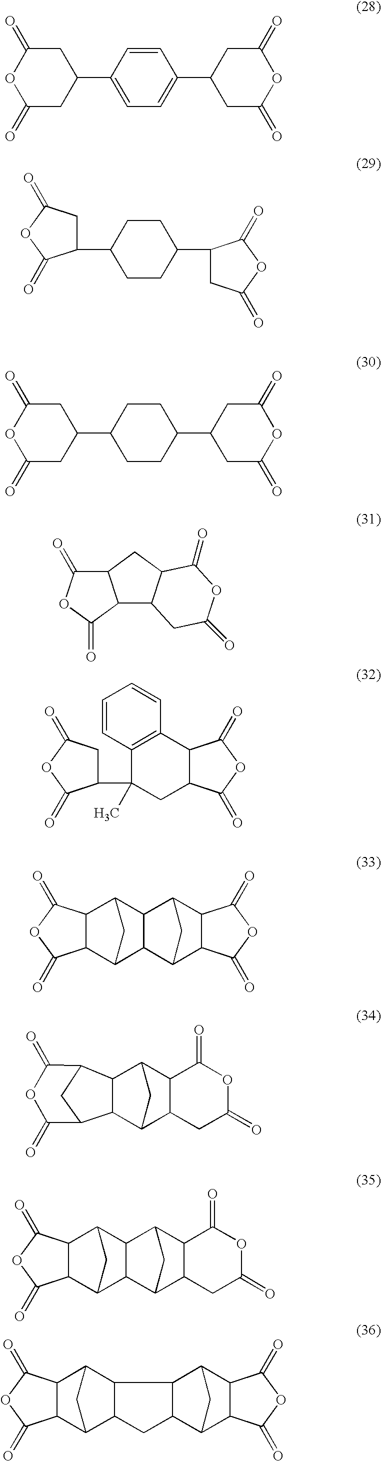

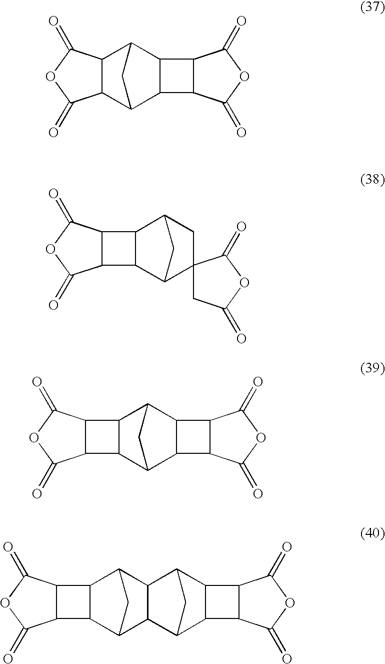

In order to improve the insulating property of the insulating layer, it is preferred to use at least one tetracarboxylic acid derivative selected from tetracarboxylic dianhydride represented by the formulae (1) to (7) and (14) to (26) and derivatives thereof, and it is more preferred to use at least one tetracarboxylic acid derivative selected from tetracarboxylic dianhydride represented by the formulae (1), (6), (7) and (20) to (26) and derivatives thereof.

In the following description, tetracarboxylic dianhydrides represented by the formulae (1) to (40) and derivatives thereof are generically referred to as a tetracarboxylic acid derivative A. The tetracarboxylic acid derivative having a skeleton that is different from the skeletons contained in the formulae (1) to (40) is referred to as an other tetracarboxylic acid derivative (a). In order to improve the insulating property of the insulating layer, the molar fraction of the tetracarboxylic acid derivative A with respect to the total amount of the tetracarboxylic acid derivative A and the other tetracarboxylic acid derivative (a) is preferably from 0.5 to 1, and more preferably from 0.7 to 1.

The production methods of the tetracarboxylic acid derivatives represented by the aforementioned formulae are disclosed, for example, in JP S59-212495 for the compound (1), JP-A H3-137125 for the compounds (2) and (3), JP 2003-192685 for the compound (4), JP H8-325196 for the compounds (7), (8), (10) and (12), JP S55-36406 for the compound (14), JP S58-170776 for the compounds (16) and (19), JP S63-57589 for the compound (17), JP S59-170087 for the compound (18), JP S58-109479 for the compounds (23) and (28), JP H8-259949 for the compounds (24) and (25), JP 2003-313180 for the compounds (26) and (27), JP H2-235842 for the compound (30), JP H2-149539 for the compounds (31), (32) and (33), JP 2003-137843 for the compound (34), JP 2004-18422 for the compound (35), JP 2002-316990 for the compound (36), and JP 2003-96070 for the compound (37).

Preferred examples of the diamine (hereinafter, referred to as a diamine A) as a counterpart of the reaction using the tetracarboxylic acid derivative A are shown below.

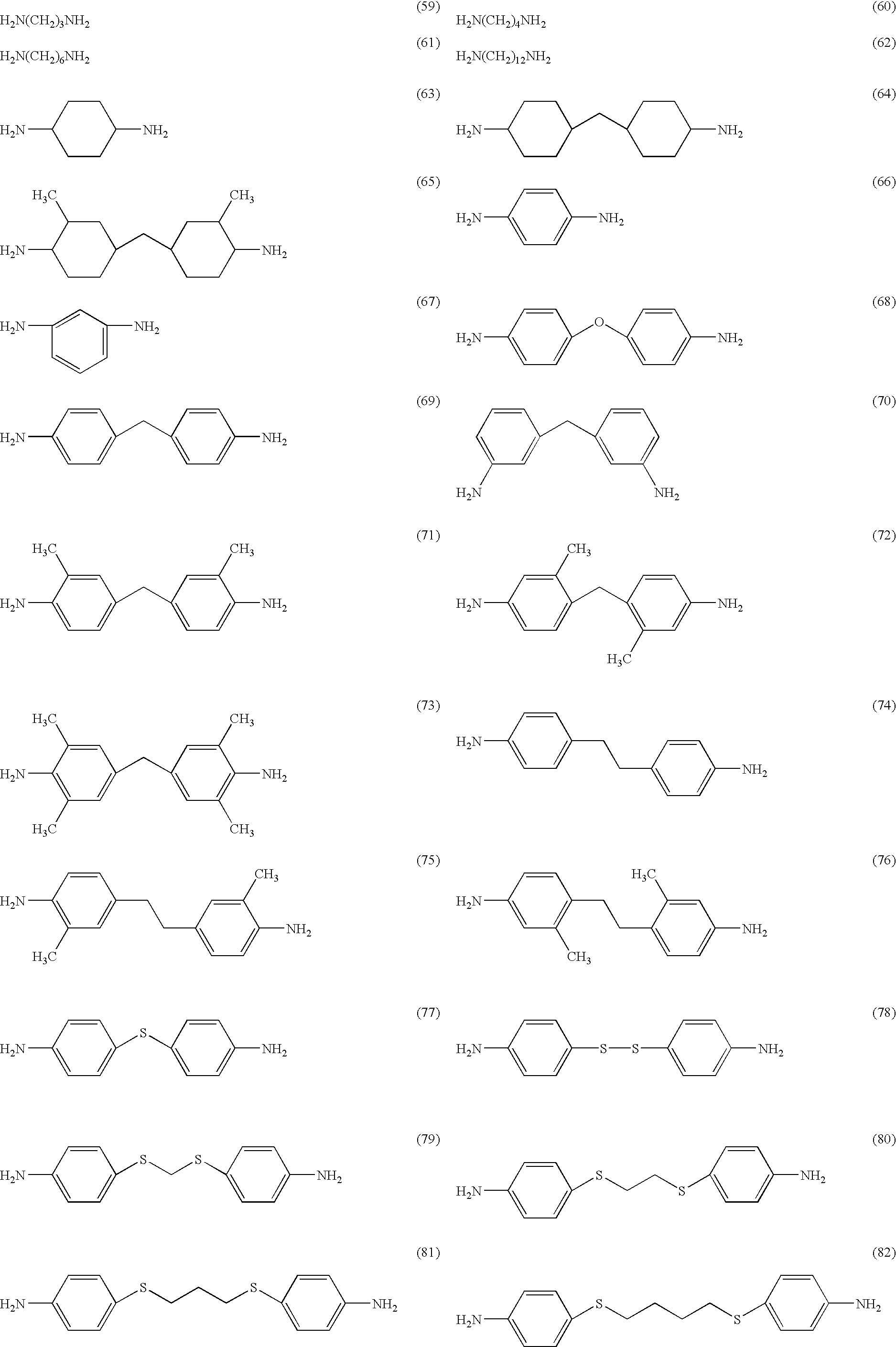

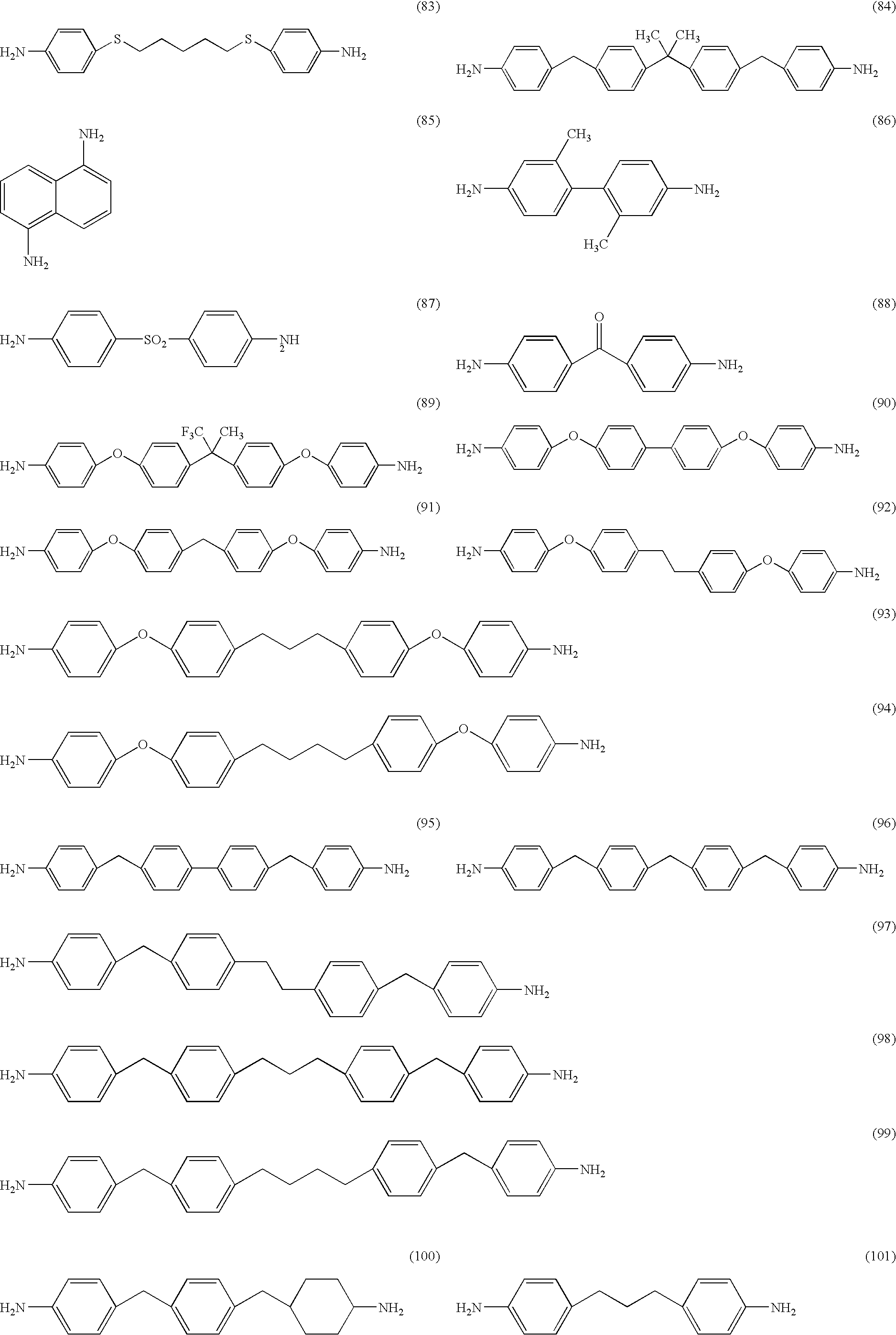

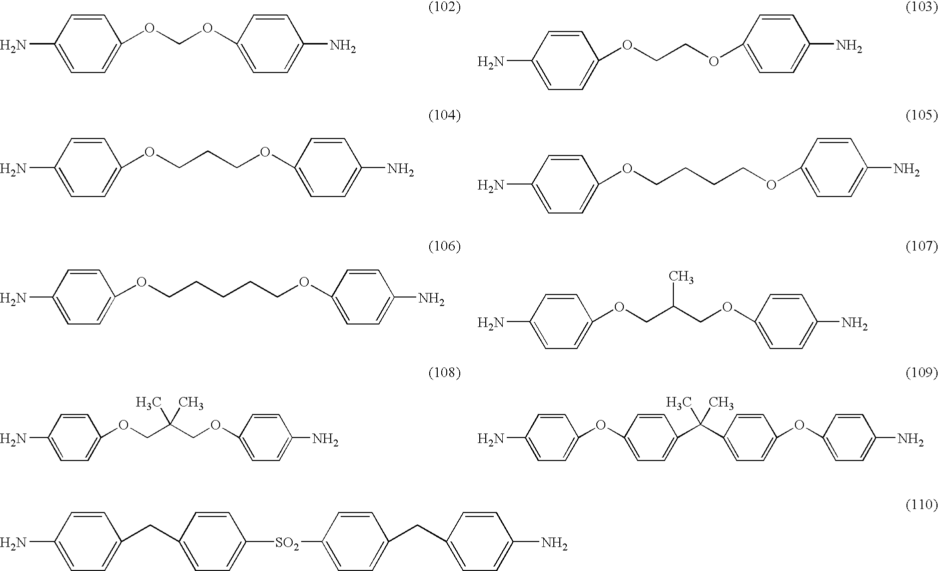

Examples of the diamine A also include a diamine having a siloxane bond represented by the following formula:

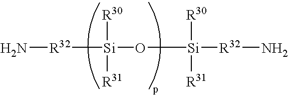

wherein R³⁰ and R³¹ are independently alkyl having from 1 to 3 carbon atoms or phenyl; R³² is alkylene having from 1 to 6 carbon atoms, 1,4-phenylene or 1,4-phenylene replaced by alkyl; and p is an integer of from 1 to 10.

Another preferred examples of the polyamic acid is a polymer obtained by reacting at least one tetracarboxylic acid derivative selected from the group consisting of tetracarboxylic dianhydrides represented by the formulae (1) to (58) shown below and derivatives of the tetracarboxylic dianhydrides, with a diamine having a side chain. In the preferred examples, a diamine having no side chain may be used in combination. The tetracarboxylic acid derivative may be used in combination with at least one tetracarboxylic acid derivative having a skeleton that is different from the skeletons shown by the formulae (1) to (58). The polyamic acid is referred to as a polyamic acid (B-1). The polyamic acid (B-1) and derivatives thereof are generically referred to as a polyamic acid B. The polyamic acid (B-1) is preferred as the polyamic acid B.

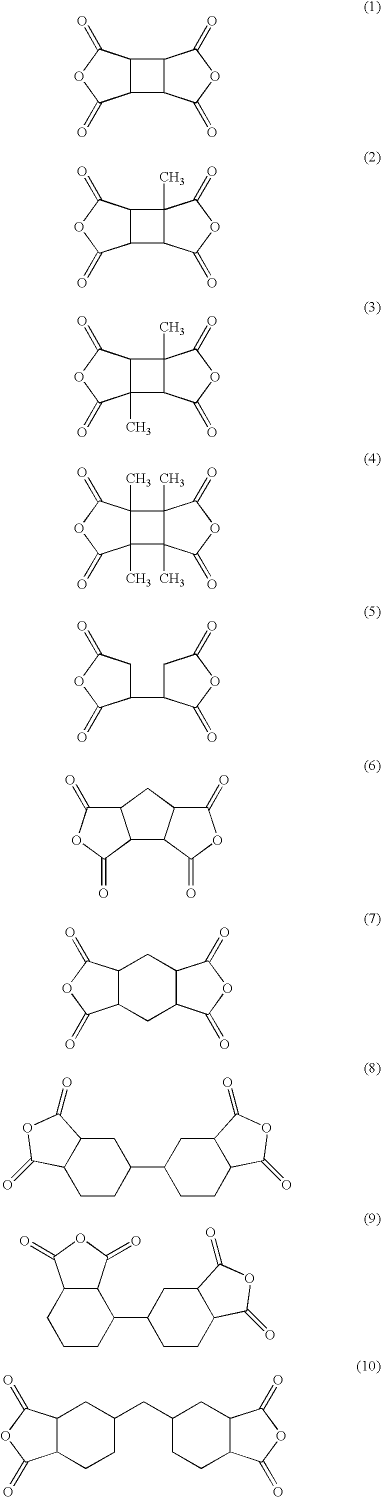

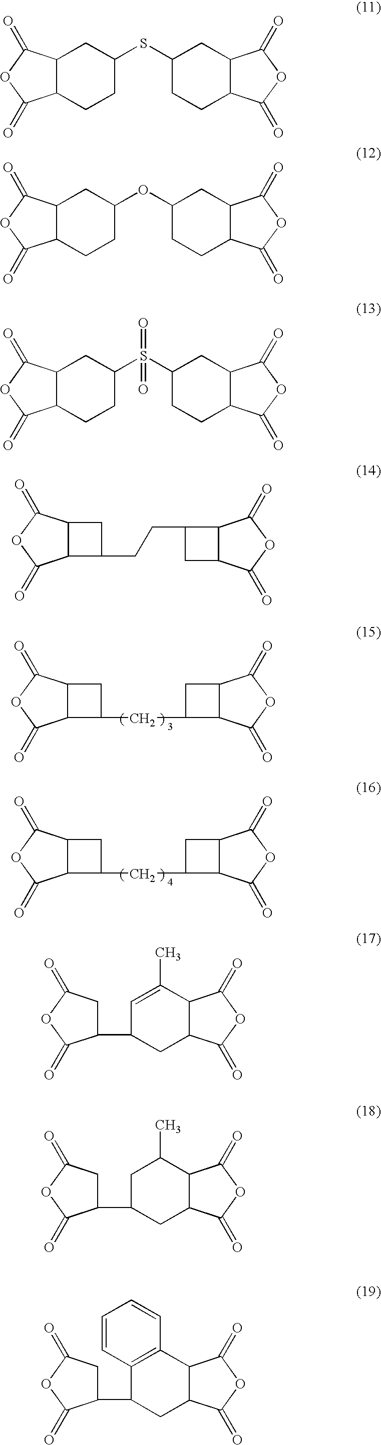

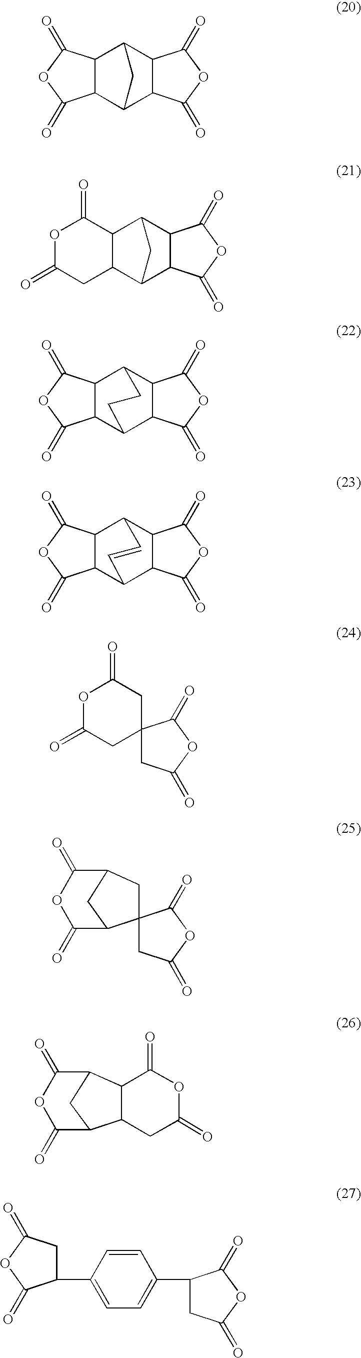

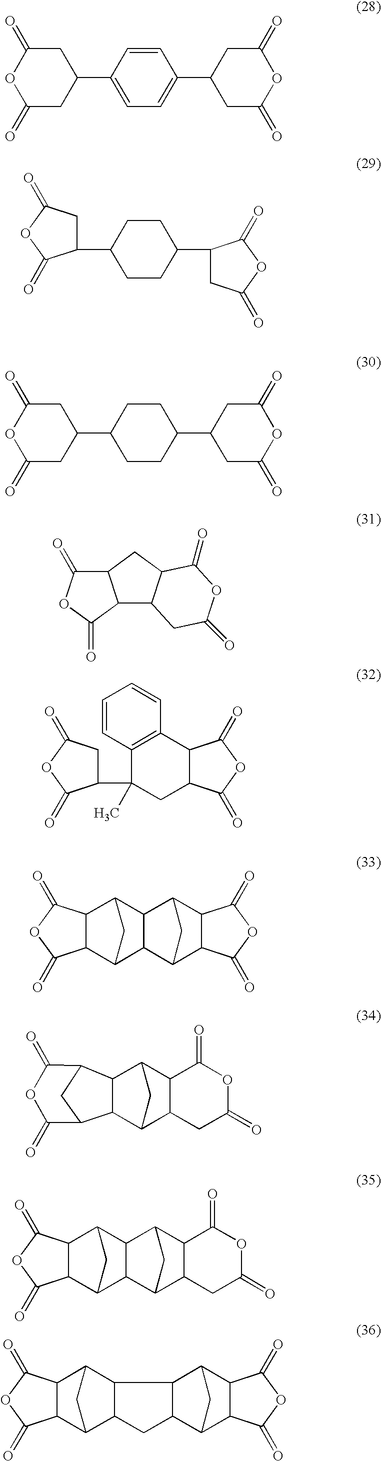

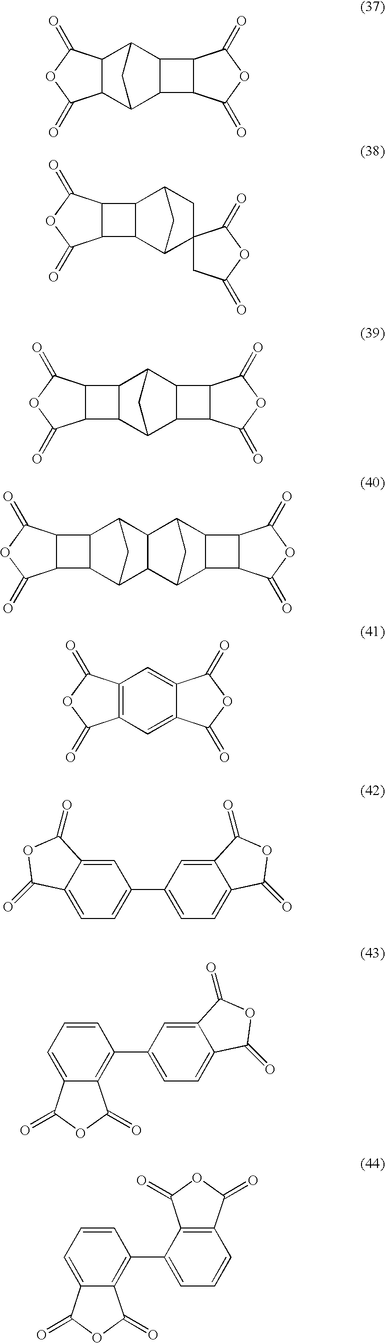

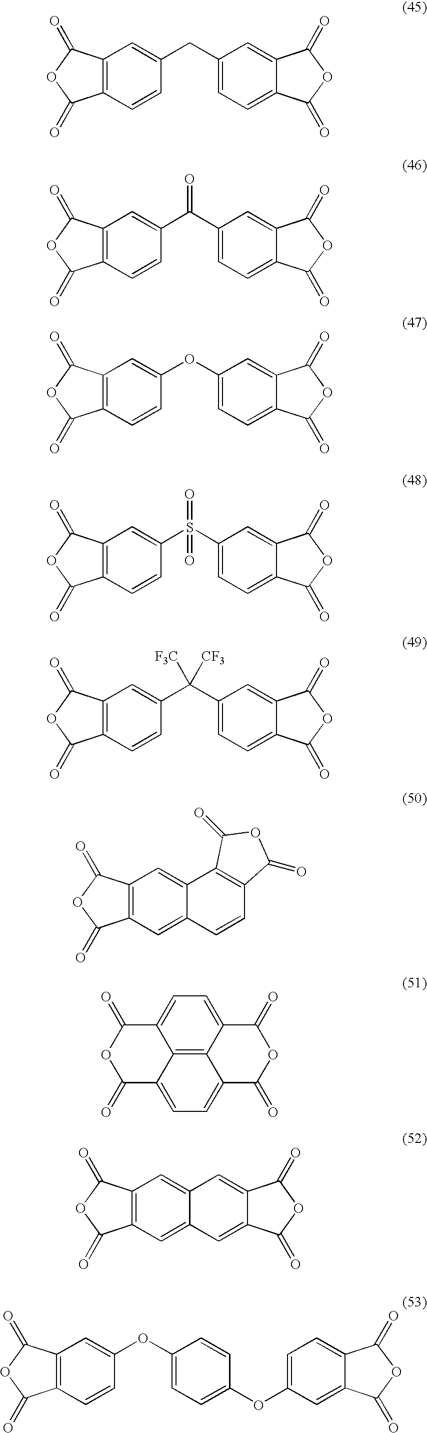

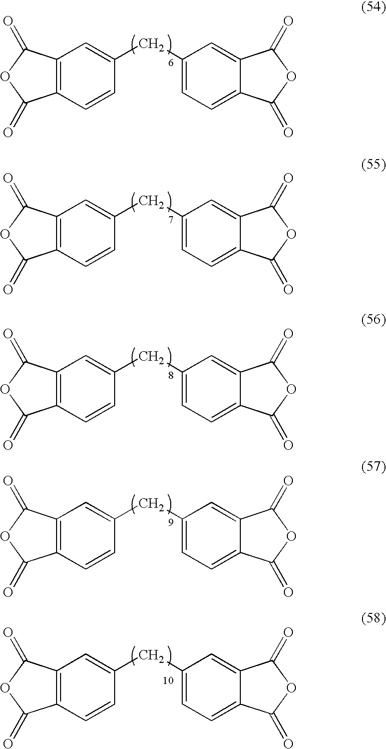

In the following description, tetracarboxylic dianhydrides represented by the formulae (1) to (58) and derivatives thereof are generically referred to as a tetracarboxylic acid derivative B. The tetracarboxylic acid derivative having a skeleton that is different from the skeletons shown in the formulae (1) to (58) is referred to as an other tetracarboxylic acid derivative (b). The diamine having a side chain is referred to as a diamine B, and the diamine having no side chain is referred to as a diamine (b).

In order to improve the insulating property of the insulating layer formed by using the polyamic acid B, it is preferred to use a tetracarboxylic acid derivative having a skeleton contained in the formulae (1) to (31). More preferred examples of the skeleton contained in the tetracarboxylic acid derivative include the skeletons contained in the formulae (1) to (10) and (14) to (23), and further preferred examples thereof include the skeletons contained in the formulae (1), (5), (7) and (14) to (26).

The diamine B is a diamine having a substituent having 3 or more carbon atoms as a side chain with respect to the main chain connecting two amino groups. Accordingly, the polyamic acid B obtained by using the diamine also has a side chain. The polyamic acid having a side chain has a tendency of decreasing surface energy, and is expected to improve the TFT characteristics.

The side chain of the diamine B may be appropriately selected depending on characteristics to be obtained. Specific examples of the side chain include phenyl, and alkyl, alkenyl or alkynyl having 3 or more carbon atoms; phenoxy, and alkoxy, alkenyloxy or alkynyloxy having 3 or more carbon atoms; benzoyl, and acyl, alkenylcarbonyl or alkynylcarbonyl having 3 or more carbon atoms; benzoyloxy, and acyloxy, alkenylcarbonyloxy or alkynylcarbonyloxy having 3 or more carbon atoms; phenoxycarbonyl, and alkoxycarbonyl, alkenyloxycarbonyl or alkynyloxycarbonyl having 3 or more carbon atoms; phenylaminocarbonyl, and alkylaminocarbonyl, alkenylaminocarbonyl or alkynylaminocarbonyl having 3 or more carbon atoms; and a cyclic alkylene having 3 or more carbon atoms, but the invention is not limited to these examples.

Preferred examples of the diamine B include compounds represented by the following formulae (I) to (V). It is preferred to use at least one selected from the group consisting of diamines represented by the formulae.

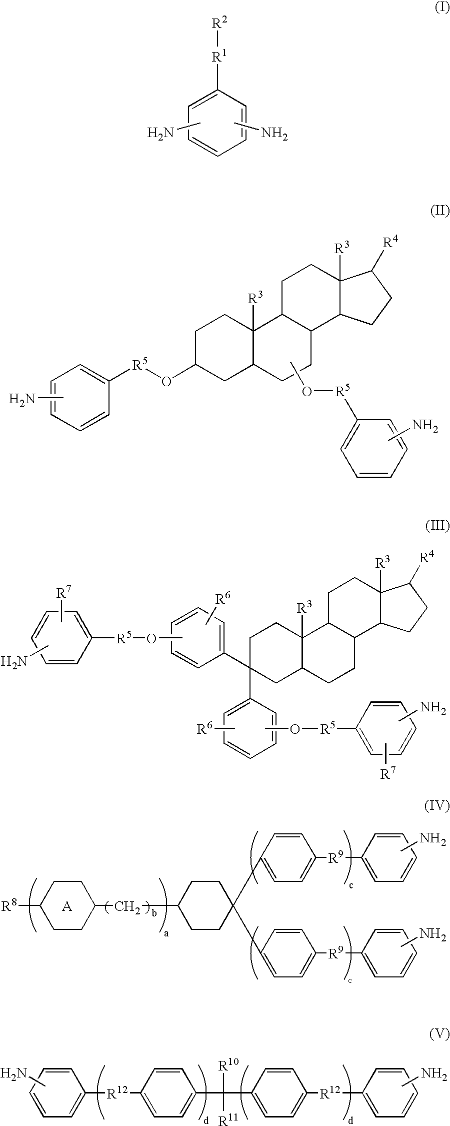

In the formula (I), R¹ is a single bond, —O—, —CO—, —COO—, —OCO—, —CONH—, —CH₂O—, —CF₂O— or —(CH₂)ₑ—, wherein e is an integer of from 1 to 6. R² is a group having a steroid skeleton, a group represented by the following formula (I-a), alkyl having from 1 to 30 carbon atoms, or phenyl. In a case where the alkyl has from 2 to 6 carbon atoms, arbitrary —CH₂- of the alkyl may be replaced by —O—, —CH═CH— or —C≡C—. Arbitrary hydrogen of the phenyl may be replaced by fluorine, methyl, methoxy, fluoromethoxy, difluoromethoxy or trifluoromethoxy. The positions on the benzene ring where the two amino groups are bonded may be arbitrary, and the relationship of the positions where the two amino groups are bonded is preferably meta-relationship or para-relationship. Furthermore, the positions where the two amino groups are preferably the 3-position and the 5-position, or the 2-position and the 5-position, where the position where R²-R¹- is bonded is designated as 1-position.

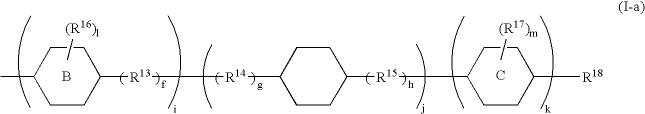

In the formula (I-a), R¹³, R¹⁴ and R¹⁵ are independently a single bond, —O—, —COO—, —OCO—, —CONH—, alkylene having from 1 to 4 carbon atoms, oxyalkylene having from 1 to 3 carbon atoms, or alkyleneoxy having from 1 to 3 carbon atoms. R¹⁶ and R¹⁷ are independently hydrogen, fluorine or methyl. Ring B and ring C are independently 1,4-phenylene or 1,4-cyclohexylene. f, g and h are independently an integer of from 0 to 4. i, j and k are independently an integer of from 0 to 3, and the sum of i, j and k is 1 or more. l and m are independently 1 or 2.

In the formula (I-a), R¹⁸ is hydrogen, fluorine, chlorine, cyano, alkyl having from 1 to 30 carbon atoms, alkoxy having from 1 to 30 carbon atoms, alkoxyalkyl having from 2 to 30 carbon atoms, fluoromethyl, difluoromethyl, trifluoromethyl, fluoromethoxy, difluoromethoxy or trifluoromethoxy. Arbitrary —CH₂— of the alkyl, alkoxy and alkoxyalkyl may be replaced by difluoromethylene or a group represented by the following formula (I-b).

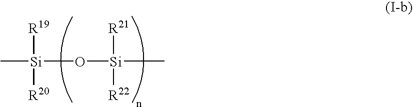

In the formula (I-b), R¹⁹, R²⁰, R²¹ and R²² are independently alkyl having from 1 to 10 carbon atoms or phenyl; and n is an integer of from 1 to 100.

In the formula (II), R³ is independently hydrogen or methyl; R⁴ is hydrogen or alkyl having from 1 to 30 carbon atoms; and R⁵ is independently a single bond, —CO— or —CH₂—. In the case where R⁴ is alkyl, the alkyl preferably contains from 1 to 10 carbon atoms. The position, where NH₂-phenylene-R⁵—O— is bonded, is preferably the 3-position or the 6-position of the steroid ring. The position, where the amino group is bonded, is preferably the meta-position or the para-position with respect to the position where R⁵ is bonded.

In the formula (III), R³ is independently hydrogen or methyl; R⁴ is hydrogen or alkyl having from 1 to 30 carbon atoms; R⁵ is independently a single bond, —CO— or —CH₂—; and R⁶ and R⁷ are independently hydrogen, alkyl having 1 to 30 carbon atoms or phenyl. R⁴ is preferably alkyl having from 1 to 10 carbon atoms. In the case where R⁶ or R⁷ is alkyl, the alkyl preferably contains from 1 to 4 carbon atoms. The position on the benzene ring, where aminophenyl-R⁵—O— is bonded, is preferably the meta-position or the para-position with respect to the carbon atom, to which the steroid ring is bonded. The position on the benzene ring, where the amino group is bonded, is preferably the meta-position or the para-position with respect to the position where R⁵ is bonded.

In the formula (IV), R⁸ is hydrogen or alkyl having from 1 to 30 carbon atoms, and arbitrary —CH₂— of the alkyl may be replaced by —O—, —CH═CH— or —C≡C—; R⁹ is independently —O— or alkylene having from 1 to 6 carbon atoms; ring A is 1,4-phenylene or 1,4-cyclohexylene; a is 0 or 1; b is 0, 1 or 2; and c is independently 0 or 1. R⁸ is preferably hydrogen or alkyl having not replaced. The position on the benzene ring, where the amino group is bonded, is preferably the meta-position or the para-position with respect to the position where R⁹ is bonded.

In the formula (V), R¹⁰ is alkyl having from 3 to 30 carbon atoms or fluorinated alkyl having from 3 to 30 carbon atoms; R¹¹ is hydrogen, alkyl having from 1 to 30 carbon atoms or fluorinated alkyl having from 1 to 30 carbon atoms; R¹² is independently —O— or alkylene having from 1 to 6 carbon atoms; and d is independently 0 or 1. R¹⁰ is preferably alkyl having from 3 to 10 carbon atoms or perfluoroalkyl having from 3 to 10 carbon atoms. R¹¹ is preferably hydrogen, alkyl having from 1 to 10 carbon atoms or perfluoroalkyl having from 1 to 10 carbon atoms. The position on the benzene ring where the amino group is bonded is preferably the meta-position or the para-position with respect to the position where R¹² is bonded.

Specific examples of the diamine represented by the formula (I) are shown below.

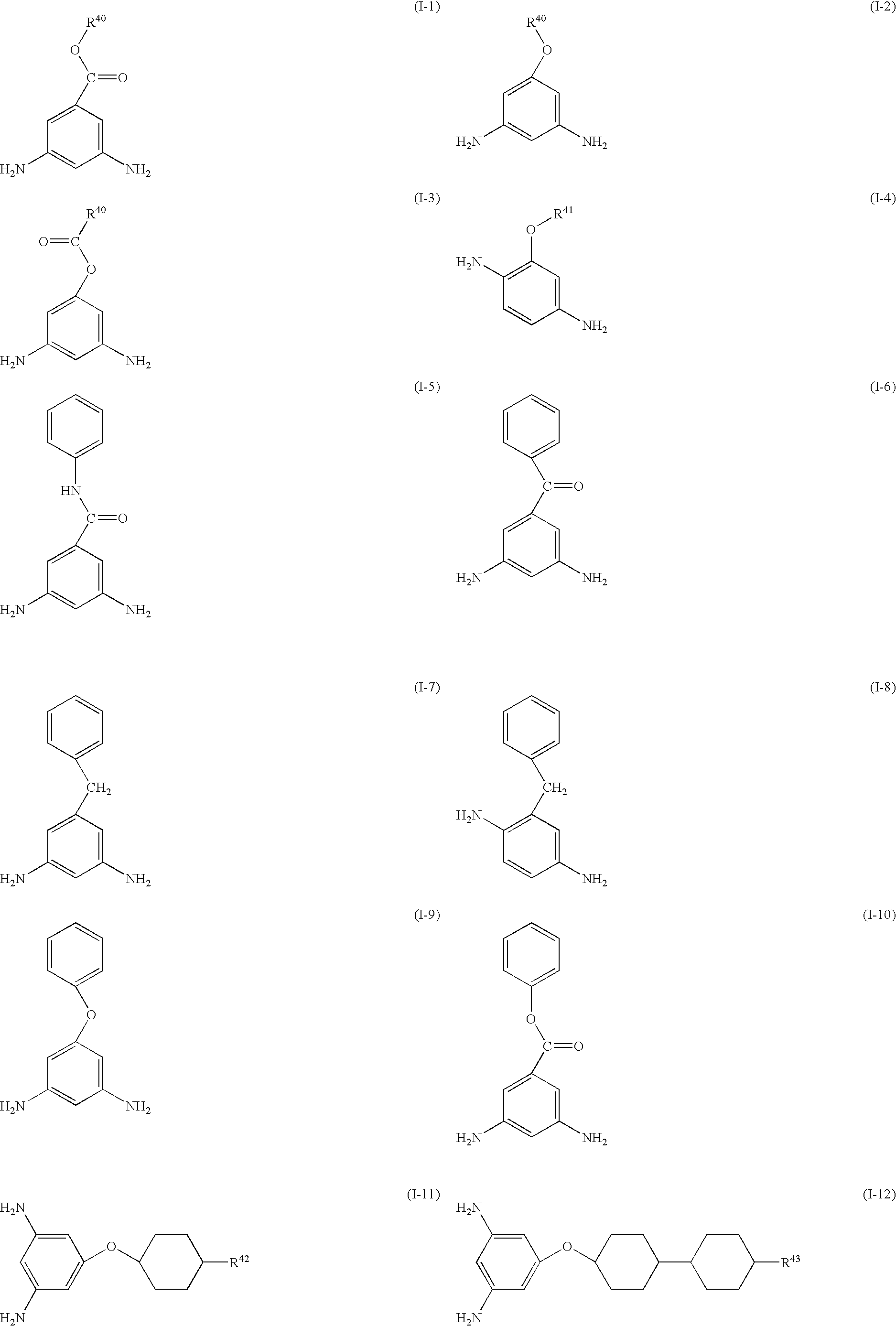

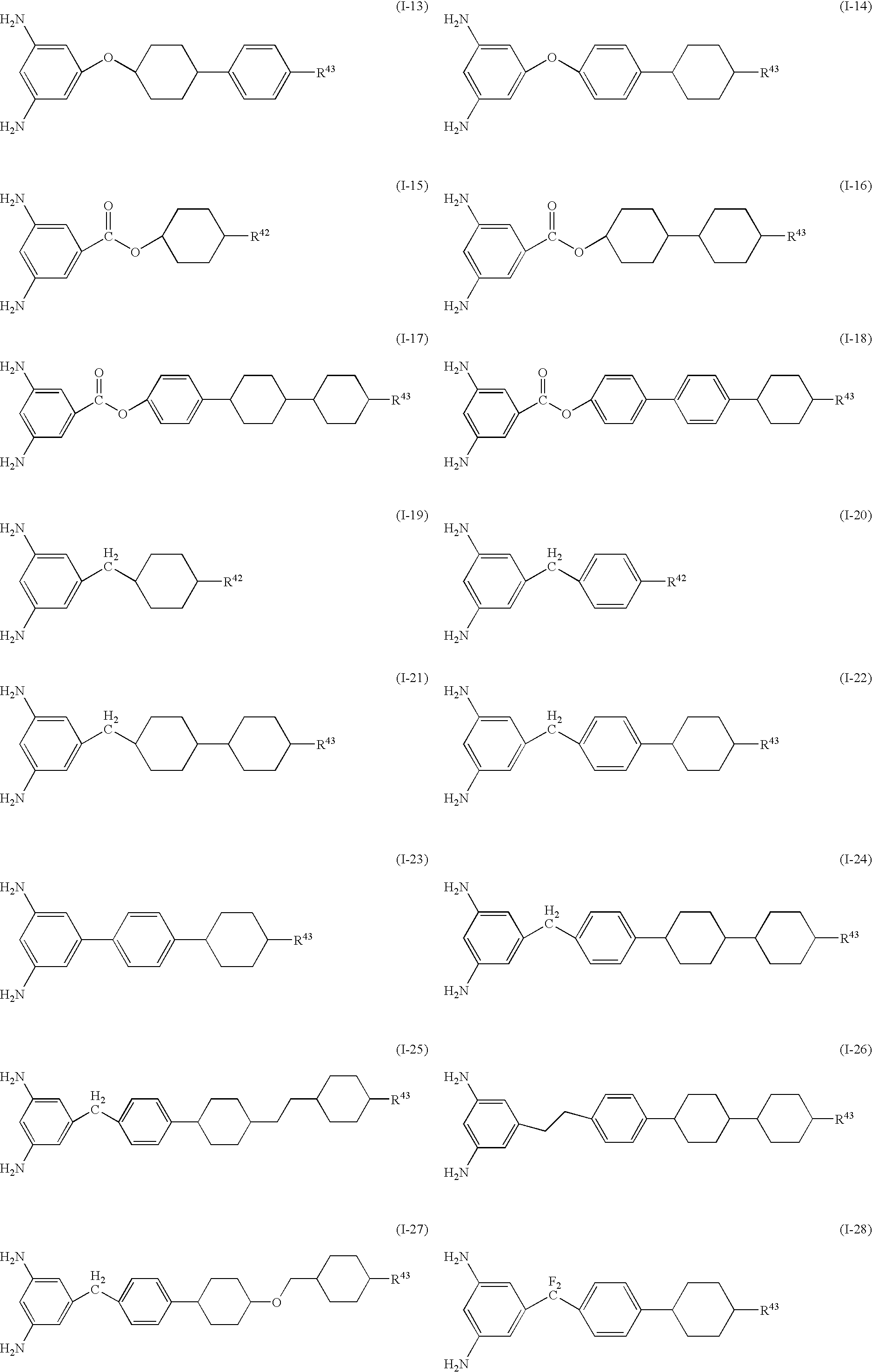

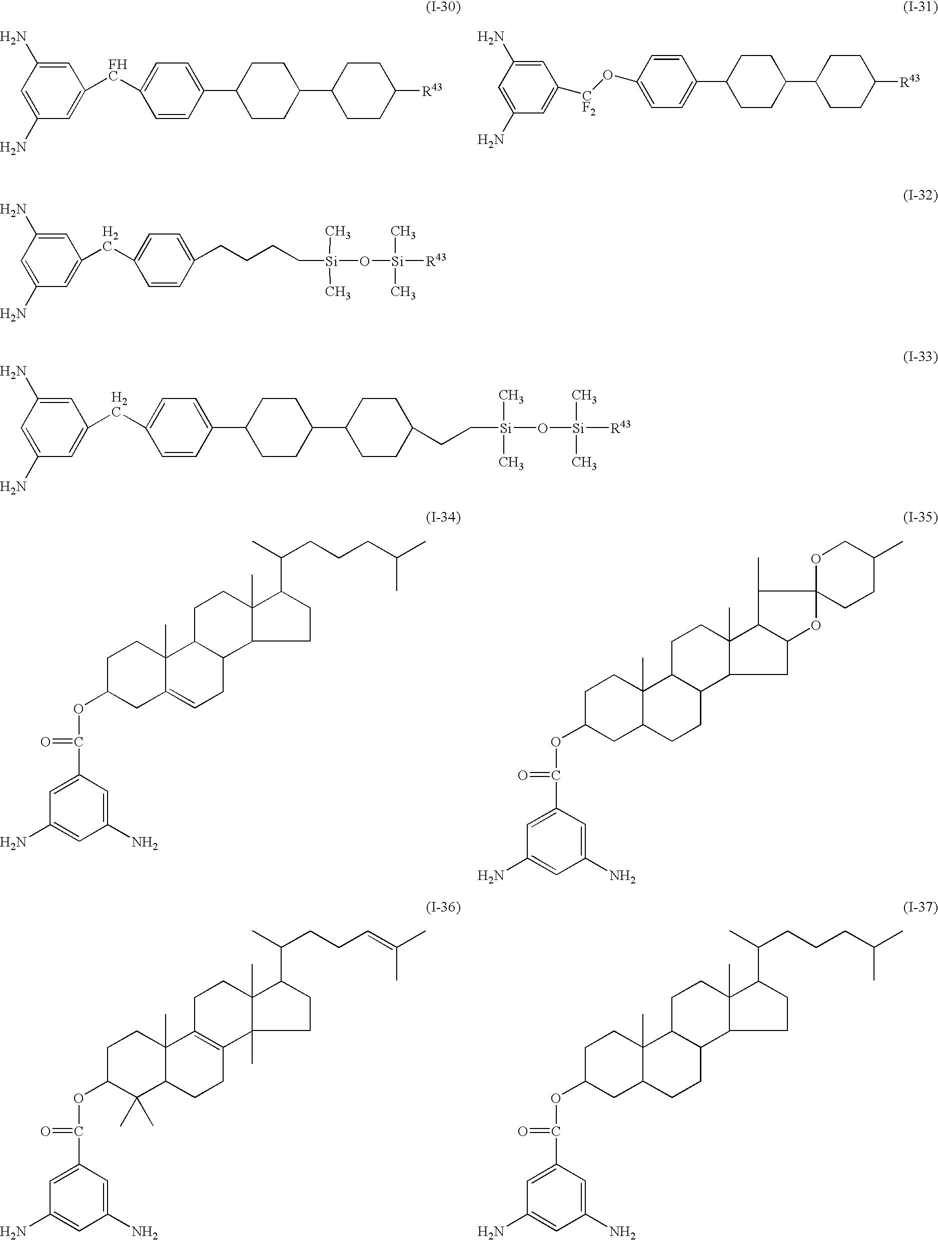

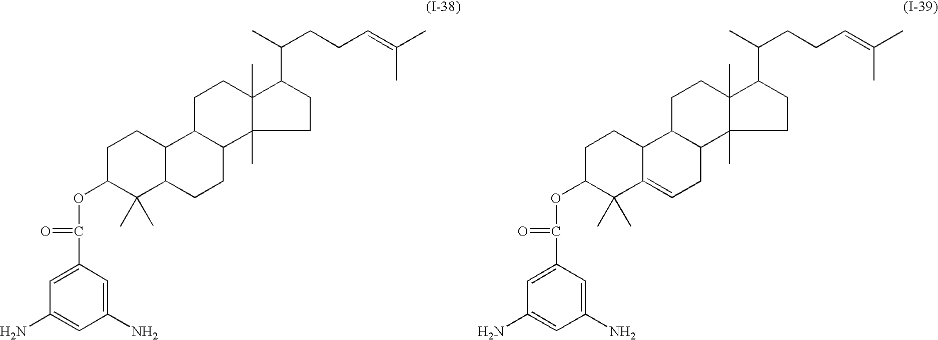

In these formulae, R⁴⁰ is alkyl having from 4 to 30 carbon atoms, and the carbon number of the alkyl is preferably from 4 to 12. R⁴¹ is alkyl having from 6 to 20 carbon atoms. R⁴² is alkyl having from 1 to 30 carbon atoms or alkoxy having from 1 to 30 carbon atoms, and the carbon number of the alkyl and the alkoxy is preferably from 1 to 10. R⁴³ is hydrogen, alkyl having from 1 to 30 carbon atoms or alkoxy having from 1 to 30 carbon atoms, and the carbon number of the alkyl and the alkoxy is preferably from 1 to 10.

The production methods of the diamines represented by the aforementioned formulae are disclosed, for example, in JP H5-27244 for the compounds (I-2) to (I-4), JP H9-278724 for the compounds (I-12), (I-14) and (I-16), JP 2002-162630 for the compounds (I-19) to (I-22), (I-24) and (I-25), JP 2003-96034 for the compounds (I-26) to (I-31), JP 2003-267982 for the compounds (I-32) and (I-33), and JP H4-281427 for the compounds (I-34) to (I-39).

Specific examples of the diamine represented by the formula (II) are shown below. The production method of the diamine represented by the formula (II) is disclosed, for example, in JP H8-269084.

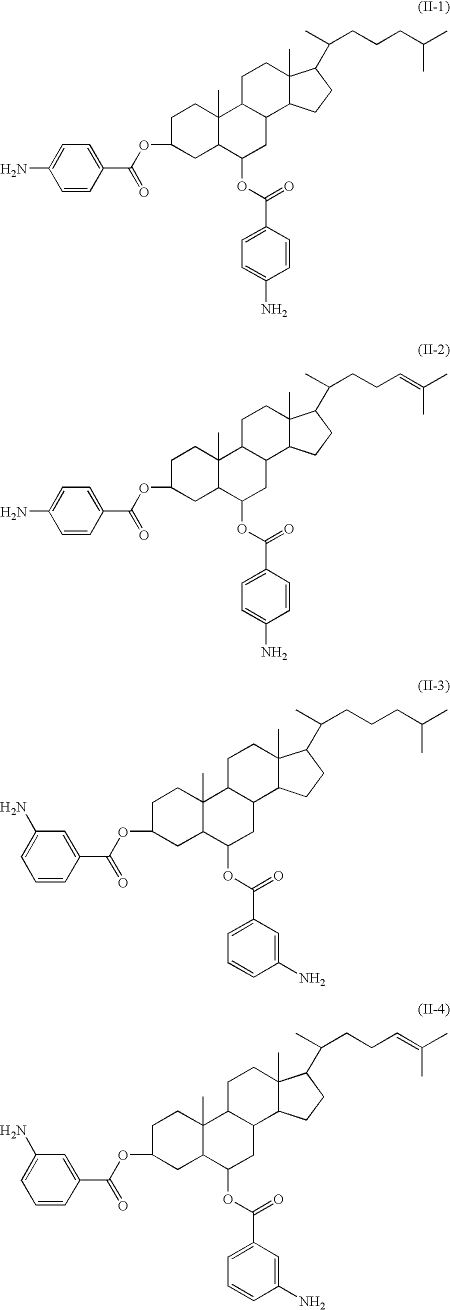

Specific examples of the diamine represented by the formula (III) are shown below. The production method of the diamine represented by the formula (III) is disclosed, for example, in JP H9-143196.

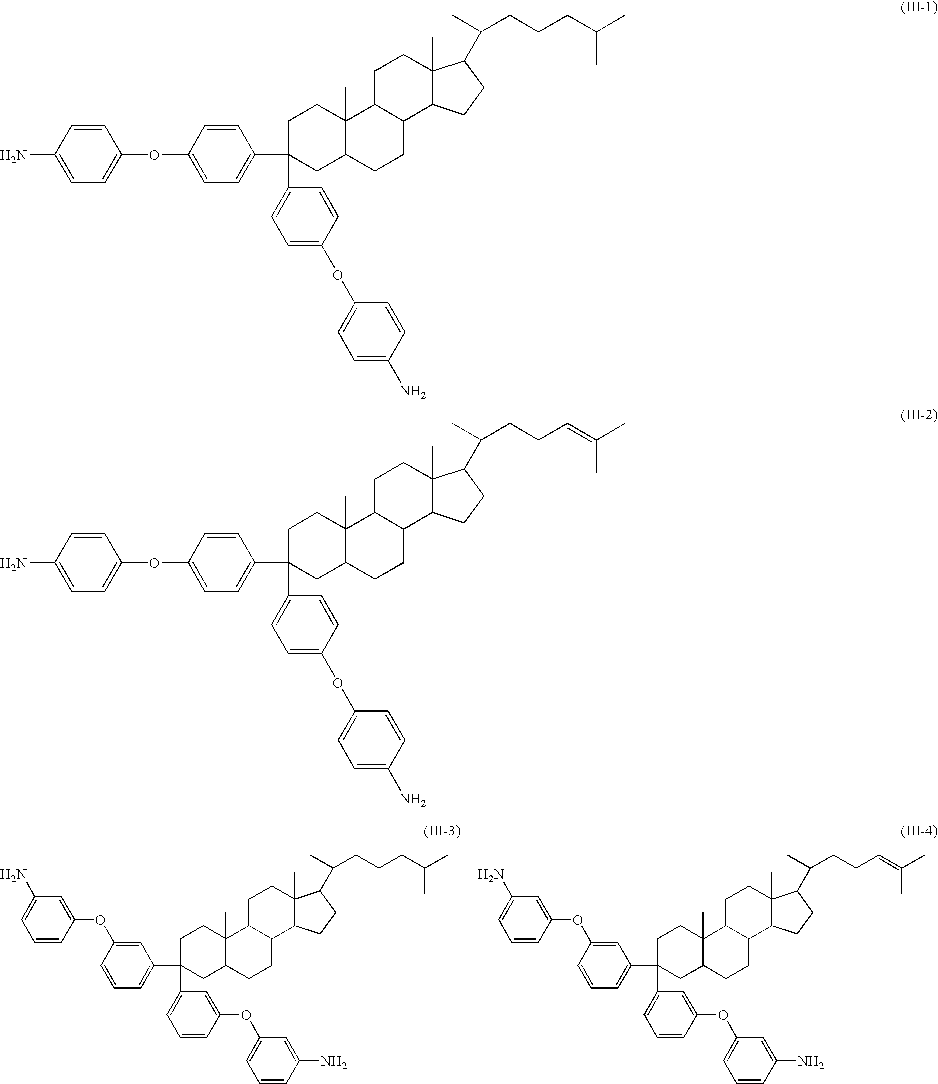

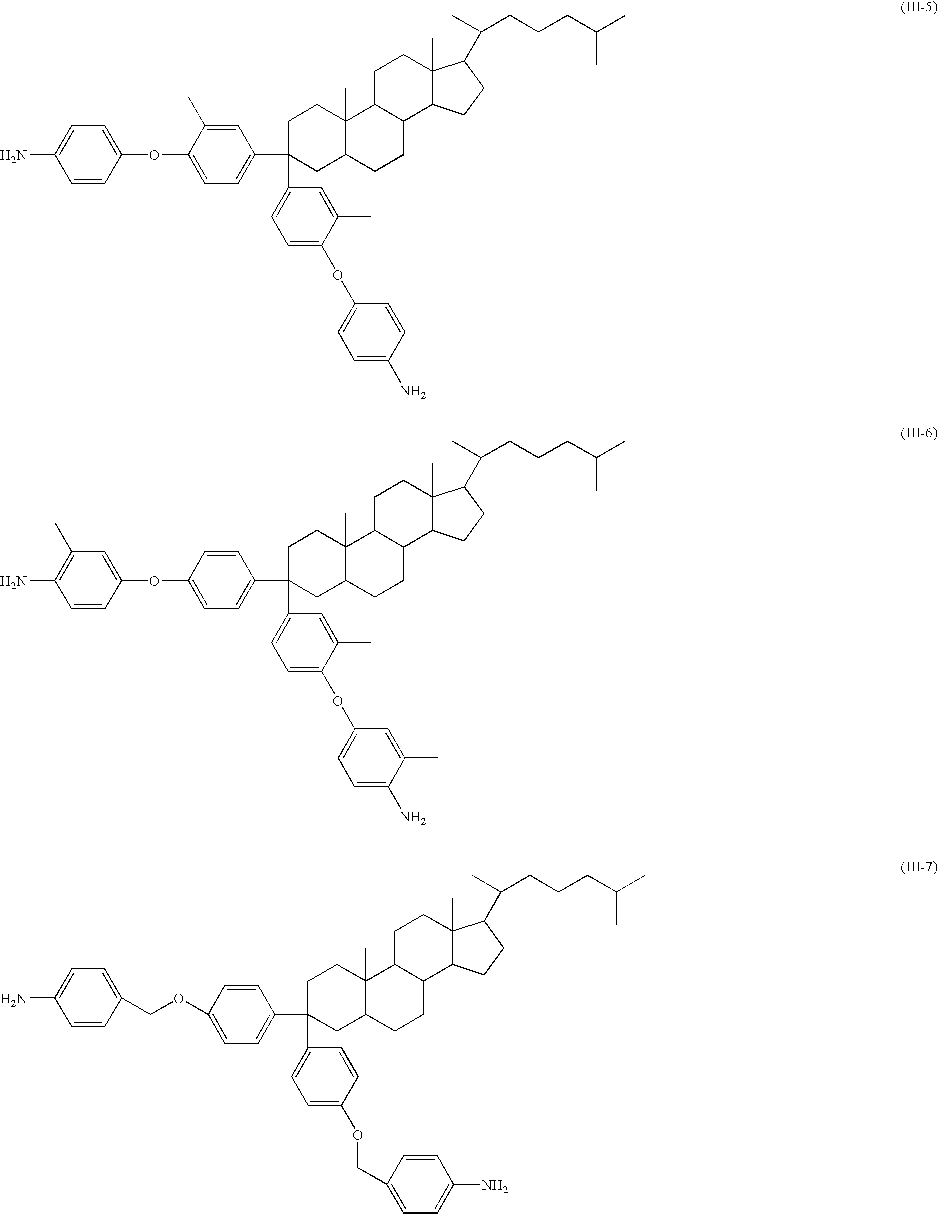

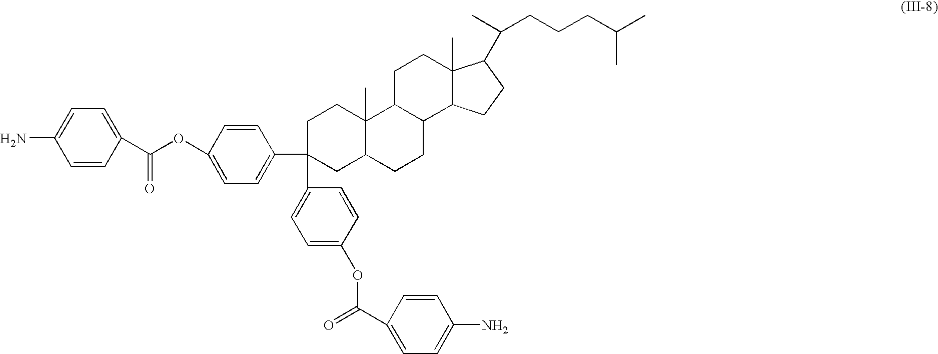

Specific examples of the diamine represented by the formula (IV) and the diamine represented by the formula (V) are shown below.

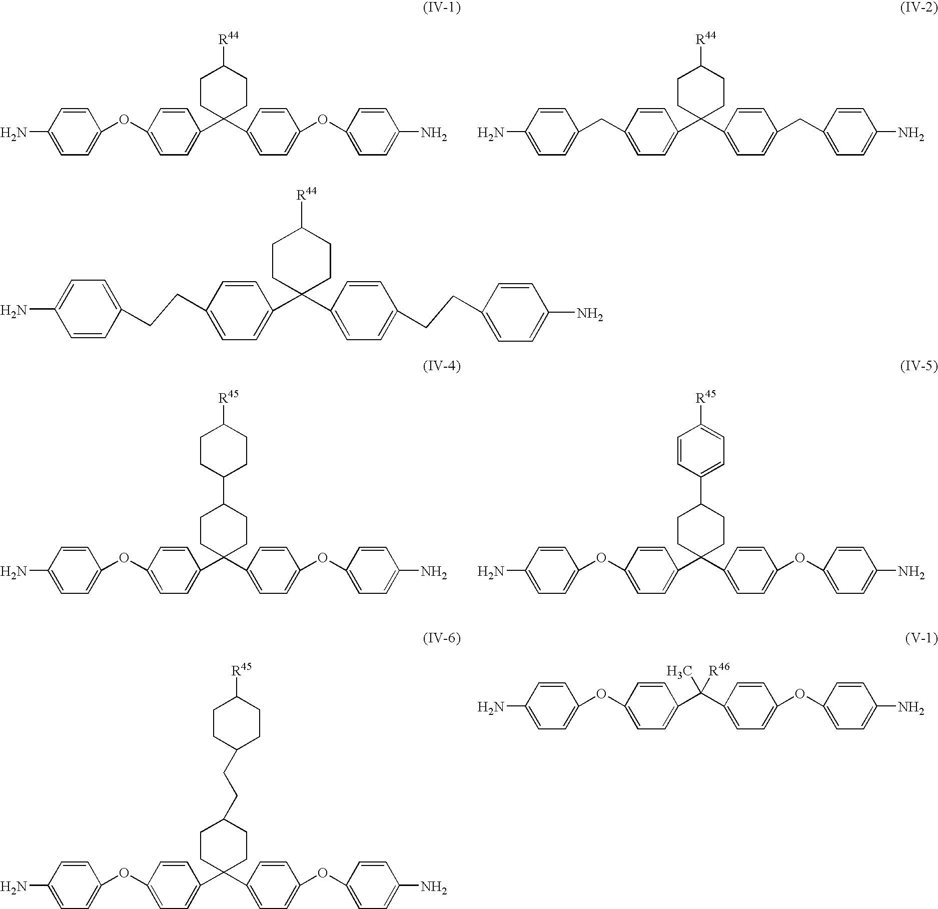

In these formulae, R⁴⁴ is alkyl having from 1 to 30 carbon atoms, and the carbon number of the alkyl is preferably from 1 to 10. R⁴⁵ is alkyl having from 1 to 30 carbon atoms, and the carbon number of the alkyl is preferably from 1 to 10. R⁴⁶ is alkyl having from 3 to 30 carbon atoms or perfluoroalkyl having from 3 to 30 carbon atoms, and the carbon number of the alkyl and the perfluoroalkyl is preferably from 3 to 10. The production methods of the diamines represented by the aforementioned formulae are disclosed, for example, in JP H2-129155 for the diamine of the formula (IV-1), JP H6-228061 for the diamine of the formula (IV-2), JP 2002-363142 for the diamine of the formula (IV-3), JP H3-167162 for the diamine of the formula (IV-4), JP H6-157434 for the diamine of the formula (IV-5), JP H3-220162 for the diamine of the formula (IV-6), and JP H1-6246 for the diamine of the formula (V-1).

As the diamine (b) (diamine having no side chain) in the invention, the similar compounds as in the diamine A may be selected. The molar fraction of the diamine B with respect to the total amount of the diamine B and the diamine (b) may be appropriately determined depending on the structure of the side chain of the diamine B and the characteristics to be obtained, and is preferably from 0.30 to 1.

Upon producing the polyamic acid in the invention, a monoamine as a terminal stopping agent may be added to the diamine.

The composition for forming an insulating layer used for forming an insulating layer of the invention contains the polymer, which is at least one of the polyamic acid A and the polyamic acid B, and the compound having at least one functional group capable of reacting with a carboxyl group contained in a constitutional unit of the polymer, in one molecule. Accordingly, the composition for forming an insulating layer used for forming an insulating layer of the invention may contain both the polyamic acid A and the polyamic acid B. In this case, the weight ratio of the polyamic acid A and the polyamic acid B (A/B) is preferably 99/1 to 50/50, and more preferably from 95/5 to 70/30. In this case, furthermore, both the polyamic acid A and the polyamic acid B are polyamic acids, i.e., the polyamic acid (A-1) and the polyamic acid (B-1) are preferably used in combination. The weight ratio may be appropriately determined depending on the insulating property to be obtained.

In the following description, the compound having at least one functional group capable of reacting with a carboxyl group contained in a constitutional unit of the polymer in one molecule may be referred to as a functional compound. The addition amount of the functional compound may be from 0.01 to 0.50, and preferably from 0.02 to 0.30, in terms of weight ratio based on the amount of the polymer. The reason why the range of the weight ratio is very large is that the addition amount of the functional compound may be small, for example, in the case where a derivative, such as a polyamic acid partially imidized and a solubilized polyimide, is used. In order to improve the characteristics of the insulating film, the weight ratio is preferably 0.01 or more, and in order to prevent the insulating characteristics from being decreased due to the unreacted functional compound, the weight ratio is preferably 0.50 or less. The composition for forming an insulating layer can be produced by dissolving the functional compound in a solution of at least one of the polyamic acid A and the polyamic acid B.

Examples of the functional group capable of reacting with a carboxyl group include oxiranyl, oxiranylene, oxetanyl, thiiranyl, aziridinyl, oxazolinyl and —NCO.

Examples of the compound having one group of oxiranyl or oxiranylene in one molecule include phenyl glycidyl ether, dibutyl glycidyl ether, 3,3,3-trifluoromethylpropylene oxide, styrene oxide, hexafluoropropylene oxide, cyclohexene oxide, N-glycidylphthalimide, (nonafluoro-N-butyl)epoxide, perfluoroethyl glycidyl ether, epichlorohydrin, epibromohydrin, N,N-diglycidylaniline, 3-(2-(perfluorohexyl)ethoxy)-1,2-epoxypropane, (3-glycidoxypropyl)trimethoxysilane, (3-glycidoxypropyl)methyldimethoxysilane, (3-glycidoxypropyl)methyldiethoxysilane, 2-(3,4-epoxycyclohexyl)ethyltrimethoxysilane, 5,6-epoxyhexyltriethoxysilane and (3-glycidoxypropyl)dimethylethoxysilane.

Examples of the compound having two groups of oxiranyl in one molecule include ethylene glycol diglycidyl ether, polyethylene glycol diglycidyl ether, propylene glycol diglycidyl ether, tripropylene glycol diglycidyl ether, polypropylene glycol diglycidyl ether, neopentyl glycol diglycidyl ether, 1,6-hexanediol diglycidyl ether, glycerin diglycidyl ether, 2,2-dibromoneopentyl glycol diglycidyl ether, 3,4-epoxycyclohexenylmethyl-3′,4′-epoxycyclohexene carboxylate and 3-(N,N-diglycidyl)aminopropyltrimethoxysilane.

Examples of the compound having four groups of oxiranyl in one molecule include 1,3,5,6-tetraglycidyl-2,4-hexanediol, N,N,N′,N′-tetraglycidyl-m-xylenediamine, 1,3-bis(N,N-diglycidylaminomethyl)cyclohexane, N,N,N′,N′-tetraglycidyl-4,4′-diaminodiphenylmethane and 3-(N-allyl-N-glycidyl)aminopropyltrimethoxysilane.

In addition to the above, examples of the compound having oxiranyl include oligomers and polymers having oxiranyl. Specific examples of the addition-polymerizable monomer having oxiranyl include glycidyl (meth)acrylate, 3,4-epoxycyclohexyl (meth)acrylate and methylglycidyl (meth)acrylate.

Specific examples of other monomers that undergo copolymerization with the monomer having oxiranyl include (meth)acrylic acid, methyl (meth)acrylate, ethyl (meth)acrylate, isopropyl (meth)acrylate, butyl (meth)acrylate, iso-butyl (meth)acrylate, t-butyl (meth)acrylate, cyclohexyl (meth)acrylate, benzyl (meth)acrylate, 2-hydroxyethyl (meth)acrylate, 2-hydroxypropyl (meth)acrylate, styrene, methylstyrene, chloromethylstyrene, (3-ethyl-3-oxetanyl)methyl (meth)acrylate, N-cyclohexylmaleimide and N-phenylmaleimide.

Preferred examples of a homopolymer of the monomer having oxiranyl include polyglycidyi methacrylate. Preferred examples of a copolymer of the monomer having oxiranyl and the other monomer include an N-phenylmaleimide-glycidyl methacrylate copolymer, an N-cyclohexylmaleimide-glycidyl methacrylate copolymer, a benzyl methacrylate-glycidyl methacrylate copolymer, a butyl methacrylate-glycidyl methacrylate copolymer, a 2-hydroxyethyl methacrylate-glycidyl methacrylate copolymer, a (3-ethyl-3-oxetanyl)methyl methacrylate copolymer and a styrene-glycidyl methacrylate copolymer.

Among these, particularly preferred examples thereof include N,N,N′,N′-tetraglycidyl-m-xylenediamine, 1,3-bis(N,N-diglycidylaminomethyl)cyclohexane, N,N,N′,N′-tetraglycidyl-4,4′-diaminodiphenylmethane, 3,4-epoxycyclohexenylmethyl-3′,4′-epoxycyclohexene carboxylate and an N-phenylmaleimide-glycidyl methacrylate copolymer.

Examples of the compound having thiiranyl include those compounds that are obtained by oxiranyl of the compounds having oxiranyl is replaced by ethylene sulfide according, for example, to the method disclosed in J. Org. Chem., vol. 28, p. 229 (1963).

Examples of the compound having oxetanyl include EPICLON (a trade name, produced by Dainippon Ink And Chemicals, Inc.), bis((3-ethyl-3-oxetanylmethoxy)methyl)benzene, bis((3-ethyl-3-oxetanylmethoxy)methyl-phenyl)methane, bis((3-ethyl-3-oxetanylmethoxy)methyl-phenyl)ether, bis((3-ethyl-3-oxetanylmethoxy)methyl-phenyl)propane, bis((3-ethyl-3-oxetanylmethoxy)methyl-phenyl)sulfone, bis((3-ethyl-3-oxetanylmethoxy)methyl-phenyl)ketone, bis((3-ethyl-3-oxetanylmethoxy)methyl-phenyl)hexafluoropropane, tri((3-ethyl-3-oxetanylmethoxy)methyl)benzene and tetra((3-ethyl-3-oxetanylmethoxy)methyl)benzene. In addition to the above, examples of the compound having oxetanyl include oligomers and polymers having oxetanyl.

Examples of the compound having aziridinyl include 2,4,6-tris(1′-adiridinyl)-1,3,5-triazine, ω-adiridinylpropionic acid 2,2-dihydroxymethylbutanol triester, 2,4,6-tris(2-methyl-1-adiridinyl)-1,3,5-triazine, 2,4,6-tris(2-ethyl-1-adiridinyl)-1,3,5-triazine, 4,4′-bis(ethyleneiminocarbonylamino)diphenylmethane, bis(2-ethyl-1-adiridinyl)benzene-1,3-dicarboxylic amide, tris(2-ethyl-1-adiridinyl)benzene-1,3,5-tricarboxylic amide, bis(2-ethyl-1-adiridinyl)sebacic amide, 1,6-bis(ethyleneiminocarbonylamino)hexane, 2,4-diethyleneureidotoluene, 1,1′-carbonyl-bis-ethyleneimine, polymethylene-bis-ethyleneurea (C₂ to C₄) and N,N′-bis(4,6-diethyleneimino-1,3,5-triazin-2-yl)-hexamethylenediamine. In addition to the above, examples of the compound having aziridinyl include oligomers and polymers having aziridinyl.

Examples of the compound having oxazolinyl include 2,2′-bis(2-oxazoline), 1,2,4-tris(2-oxazolinyl-2)benzene, 4-furan-2-ylmethylene-2-phenyl-4H-oxazol-5-one, 1,4-bis(4,5-dihydro-2-oxazolinyl)benzene, 1,3-bis(4,5-dihydro-2-oxazolinyl)benzene, 2,3-bis(4-isopropenyl-2-oxazolin-2-yl)butane, 2,2′-bis-4-benzyl-2-oxazoline, 2,6-bis(isopropyl-2-oxazolin-2-yl)pyridine, 2,2′-isopropylidenebis(4-tert-butyl-2-oxazoline), 2,2′-isopropylidenebis(4-phenyl-2-oxazoline), 2,2′-methylenebis(4-tert-butyl-2-oxazoline) and 2,2′-methylenebis (4-phenyl-2-oxazoline). In addition to the above, examples of the compound having oxazolinyl include oligomers and polymers having oxazolinyl, such as EPOCROS (a trade name, produced by Nippon Shokubai Co., Ltd.

Examples of the compound having two groups of —NCO in one molecule include phenylene-1,3-diisocayante, phenylene-1,4-diisocyanate, 1-methoxyphenylene-2,4-diisocyanate, 1-methylphenylene-2,4-diisocyanate, 2,4-tolylenediisocyanate, 2,6-tolylenediisocyanate, 1,3-xylylenediisocyanate, 1,4-xylylenediisocyanate, biphenylene-4,4′-diisocyanate, 3,3′-dimethoxybiphenylene-4,4′-diisocyanate, 3,3′-dimethylbiphenylene-4,4′-diisocyanate, diphenylmethane-2,4′-diisocyanate, diphenylmethane-4,4′-diisocyanate, 3,3′-dimethoxydiphenylmethane-4,4′-diisocyanate, 3,3′-dimethyldiphenylmethane-4,4′-diisocyanate, naphthylene-1,5-diisocyanate, cyclobutylene-1,3-diisocyanate, cyclopentylene-1,3-diisocyanate, cyclohexylene-1,3-diisocyanate, cyclohexylene-1,4-diisocyanate, 1-methylcyclohexylene-2,4-diisocyanate, 1-methylcyclohexylene-2,6-diisocyanate, 1-isocyanate-3,3,5-trimethyl-5-isocyanatemethylcyclohexane, cyclohexane-1,3-bis(methylisocyanate), cyclohexane-1,4-bis(methylisocyanate), isophoronediisocyanate, dicyclohexylmethane-2,4′-diisocyanate, dicyclohexylmethane-4,4′-diisocyanate, ethylenediisocyanate, tetramethylene-1,4-diisocyanate, hexamethylene-1,6-diisocyanate, dodecamethylene-1,12-diisocyanate and lysinediisocyanate methyl ester.

Examples of the compound having three groups of —NCO in one molecule include phenyl-1,3,5-triisocyanate, diphenylmethane-2,4,4′-triisocyanate, diphenylmethane-2,5,4′-triisocyanate, triphenylmethane-2,4′,4″-triisocyanate, triphenylmethane-4,4′,4″-triisocyanate, diphenylmethane-2,4,2′,4′-tetraisocyaante, diphenylmethane-2,5,2‘5’-tetraisocyanate, cyclohexane-1,3,5-triisocyanate, cyclohexane-1,3,5-tris(methylisocyanate), 3,5-dimethylcyclohexanel,3,5-tris(methylisocyanate), 1,3,5-trimethylcyclohexane-1,3,5-tris(methylisocyanate), dicyclohexylmethane-2,4,2′-triisocyanate and dicyclohexylmethane-2,4,4′-triisocyanate.

The production method of the polyamic acid will be described. The polyamic acid can be produced by a known production method. For example, a diamine and, depending on necessity, a monoamine are charged in a reactor equipped with a material charging port, a nitrogen introducing port, a thermometer, an agitator and a condenser. An amide polar solvent, such as N-methyl-2-pyrrolidone and dimethylformamide, a tetracarboxylic dianhydride and, depending on necessity, a derivative of a tetracarboxylic dianhydride are then charged. At this time, the total molar number of the tetracarboxylic dianhydride is preferably from 0.9 to 1.1 times the total molar number of the diamine.

The mixture is reacted under agitating at a reaction temperature of from 0 to 70° C. for 1 to 48 hours to obtain a solution of a polyamic acid. A polyamic acid having a low molecular weight can be obtained by reacting at a reaction temperature of from 50 to 80° C. The resulting solution of a polyamic acid may be diluted with a solvent for controlling the viscosity.

In order to obtain a soluble polyimide from the polyamic acid, an acid anhydride, such as acetic anhydride, propionic anhydride and trifluoroacetic anhydride, as a dehydrating agent and a tertiary amine, such as triethylamine, pyridine and collidine, as a dehydration ring-closing catalyst are added to the solution of the polyamic acid, and the mixture is treated at a temperature of from 20 to 150° C. for imidation.

The imidation can be effected in such a manner that a large amount of a poor solvent is added the solution of the polyamic acid to precipitate the polyamic acid, and the polyamic acid thus precipitated is subjected to imidation with a dehydrating agent and a dehydration ring-closing catalyst at a temperature of from 20 to 150° C. in the similar manner as above. Examples of the poor solvent include an alcohol solvent, such as methanol, ethanol and isopropanol, and a glycol solvent.

In the imidation reaction, the molar ratio of the dehydration ring-closing catalyst with respect to the dehydrating agent is preferably from 0.1 to 10. The total using amount of the dehydration ring-closing catalyst and the dehydrating agent is preferably from 1.5 to 10 times the total molar number of the tetracarboxylic dianhydride. The imidation rate can be controlled by changing the addition amounts of the dehydrating agent and the dehydration ring-closing catalyst for imidation, the reaction temperature and the reaction time. The resulting polyimide may be used after separating from the solvent and then again dissolving in a solvent described later, or may be used without separation from the solvent.

A polyamic acid ester can be obtained by converting the tetracarboxylic dianhydride to a tetracarboxylic acid dialkyl ester dihalide, followed by reacting with a diamine. Furthermore, a polyamic acid ester having carboxyl groups having been partially esterified can be obtained by using the tetracarboxylic dianhydride and the tetracarboxylic acid dialkyl ester dihalide in combination.

The polyamic acid ester can also be obtained by reacting a polyamic acid with an alcohol. In this case, a polyamic acid ester having carboxyl groups having been totally or partially esterified can be obtained by controlling the reaction conditions, such as the molar fraction of the alcohol.

As having been described, a part of the tetracarboxylic dianhydride may be a dicarboxylic acid halide. The reaction between the tetracarboxylic dianhydride containing a dicarboxylic acid halide and a diamine provides a polyamic acid-polyamide copolymer. The ratio of the dicarboxylic acid halide with respect to the tetracarboxylic dianhydride is not particularly limited unless the advantages of the invention are impaired.

A polyamideimide can be produced by imidizing the polyamic acid-polyamide copolymer. The polyamic acid-polyamide copolymer and the polyamideimide may be used after separating from the solvent and then again dissolving in a solvent described later, or may be used without separation from the solvent, as similar to the case of the polyimide.

The production method of the polymer of the addition-polymerizable monomer will be described. The polymer of the addition-polymerizable monomer can be produced by using a known radical polymerization method.

A solution used in radical polymerization is not limited as far as it is inert to polymerization reaction and is stable under the polymerization reaction conditions. Specific examples of the solvent include ethyl acetate, butyl acetate, ethylene glycol monoisopropyl ether, ethylene glycol monobutyl ether, ethylene carbitol, propylene glycol monomethyl ether, propylene glycol monomethyl ether acetate, ethylene glycol monobutyl ether acetate, methyl ethyl ketone, cyclohexanone, diethylene glycol dimethyl ether, diethylene glycol diethyl ether, toluene, xylene, γ-butyrolactone, N-methylpyrrolidone, N,N-dimethylacetamide and tetrahydrofuran. Preferred examples among these include cyclohexanone, methyl ethyl ketone, γ-butyrolactone, N-methylpyrrolidone, propylene glycol monomethyl ether and toluene. The solvent may be used solely or as a mixed solvent.

The polymerization reaction is generally carried out at a monomer concentration in the reaction solution of from 5 to 50 parts by weight, the polymerization initiator concentration therein of from 0.01 to 10 parts by weight at a reaction temperature of from 30 to 160° C. for a reaction time of from 1 to 12 hours. A chain transfer agent may be added for controlling the molecular weight. Examples of the chain transfer agent include chloroform, carbon tetrachloride, n-hexylmercaptan, n-octylmercaptan, n-dodecylmercaptan, tert-dodecylmercaptan, thioglycolic acid, dimethylxanthogen sulfide, diisopropylxanthogen sulfide, terpinolene and α-methylstyrene dimer.

The content of at least one of the polyamic acid A and the polyamic acid B, and the compound having a functional group capable of reacting with a carboxyl group in the composition for forming an insulating layer may be appropriately selected depending on the coating method, and is preferably from 0.5 to 40%, and more preferably from 1 to 20%, in the case where such a printing machine as an offset printing machine and an ink-jet printing machine (hereinafter, abbreviated as a printing machine in some cases), but may be appropriately adjusted with respect to the viscosity of the solution.

The composition for forming an insulating layer of the invention may contain a solvent. Examples of the solvent include those solvents that are used in production and use of the polymer component, such as the polyamic acid, the solubilized polyimide, the polyamic acid ester, the polyamic acid-polyamide copolymer and the polyamide imide, and the solvents may be appropriately selected depending on purposes. The solvent is preferably a mixed solvent containing a non-protonic polar solvent as a good solvent for at least one of the polyamic acid and the derivative thereof, and an other solvent that changes the surface tension for improving the coating property.

Examples of the non-protonic polar solvent include N-methyl-2-pyrrolidone, dimethylimidazolidinone, N-methylcaprolactam, N-methylpropionamide, N,N-dimethylacetamide, dimethylsulfoxide, N,N-dimethylformamide, N,N-diethylformamide, diethylacetamide, γ-butyrolactone and γ-valerolactone, and among these, N-methyl-2-pyrrolidone, dimethylimidazolidinone, γ-butyrolactone and γ-valerolactone are preferred among these.

Examples of the other solvent include alkyl lactate, 3-methyl-3-methoxybutanol, tetralin, isophorone, ethylene glycol monoalkyl ether, such as ethylene glycol monoethyl ether, diethylene glycol monoalkyl ether, such as diethylene glycol monoethyl ether, ethylene glycol monoalkyl (or monophenyl) acetate, triethylene glycol monoalkyl ether, propylene glycol monoalkyl ether, such as propylene glycol monobutyl ether, dialkyl malonate, such as diethyl malonate, and dipropylene glycol monoalkyl ether, such as dipropylene glycol monomethyl ether, and also include ester compounds (such as acetates) of the glycol monoalkyl ethers. Among these, ethylene glycol monobutyl ether, diethylene glycol monoethyl ether, propylene glycol monobutyl ether and dipropylene glycol monomethyl ether are preferred.

The ratio of the non-protonic polar solvent and the other solvent may be appropriately determined in consideration of the printing property, coating property, solubility, storage stability and the like of the composition for forming an insulating layer. The non-protonic polar solvent is preferably such a solvent that is excellent in solubility and storage stability, and the other solvent is preferably such a solvent that is excellent in printing property and coating property.

Various kinds of additives may be added to the composition for forming an insulating layer. The various kinds of additives may be selected depending on the purposes Examples of the additives include a surfactant for the purpose of improving the coating property, an antistatic agent for the purpose of improving the antistatic property, and a coupling agent, such as silane coupling agent and titanium coupling agent, for the purpose of improving the adhesion property to a substrate.

Examples of the silane coupling agent include vinyltrimethoxysilane, vinyltriethoxysilane, N-(2-aminoethyl)-3-aminopropylmethyldimethoxysilane, N-(2-aminoethyl)-3-aminopropylmethyltrimethoxysilane, p-aminophenyltrimethoxysilane, p-aminophenyltriethoxysilane, m-aminophenyltrimethoxysilane, m-aminophenyltriethoxysilane, 3-aminopropyltrimethoxysilane, 3-aminopropyltriethoxysilane, 3-glycidoxypropyltrimethoxysilane, 3-glycidoxypropylmethyldimethoxysilane, 2-(3,4-epoxycyclohexyl)ethyltrimethoxysilane, 3-chloropropylmethyldimethoxysilane, 3-chloropropyltrimethoxysilane, 3-methacryloxypropyltrimethoxysilane, 3-mercaptopropyltrimethoxysilane, N-(1,3-dimethylbutylidene)-3-(triethoxysilyl)-1-propylamine and N,N′-bis(3-(trimethoxysilyl)propyl)ethylenediamine.

The addition amount of the additive is generally from 0 to 10%, and preferably from 0.1 to 3%, based on the total weight of the polyamic acid and the derivative thereof.

Examples of the coating method for coating the solution of the composition for forming an insulating layer include a spin coating method, a printing method, a dropping method and an ink-jet method.

The viscosity of the solution of the composition for forming an insulating layer is appropriately selected depending on the coating method, and can be controlled by the structure of the polyamic acid and the derivative thereof, the compound having a functional group capable of reacting with a carboxyl group, the kind of the solvent used and the polymer concentration. For example, in the case where the composition is coated with a printing machine, the viscosity is generally from 5 to 100 mPa·s, and preferably from 10 to 90 mPa·s. In the case where the viscosity of the solution is 5 mPa·s or more, a sufficient film thickness may be obtained, and in the case where it is 100 mPa·s or less, unevenness upon printing may be prevented from occurring. In the case where the composition is coated by a spin coating method, the viscosity thereof is generally from 5 to 200 mPa·s, and preferably from 10 to 100 mPa·s.

The insulating layer of the invention can be formed by coating the composition for forming an insulating layer on a substrate and heating at a temperature of from 100 to 400° C., and preferably from 130 to 250° C.

The electronic device of the invention can be produced by accumulating a semiconductor layer on the insulating layer formed on a substrate. The semiconductor layer is preferably formed of an organic semiconductor. An organic semiconductor is generally formed into a film by dissolving in a solvent and coating, and therefore, it can be formed into a film at a low temperature as compared to the case of using an inorganic semiconductor, such as silicon, whereby the materials, such as the substrate material, can be selected from a wide range. In the case where a resin film substrate is used, in particular, the device can be thin and lightweight. Furthermore, in the case where the film is formed by coating, the cost of the equipment for producing the device can be decreased as compared to the case of forming a film of an inorganic semiconductor.

Examples of the organic semiconductor include one or more materials selected from the group consisting of fluorene, a polyfluorene derivative, polyfluorenone, a fluorenone derivative, a poly-N-vinylcarbazole derivative, a poly-γ-carbazolylethyl glutamate derivative, a polyvinylphenanthrene derivative, a polysilane derivative, an oxazole derivative, an oxadiazole derivative, an imidazole derivative, an amine derivative, such as monoarylamine and triarylamine, a benzidine derivative, a diarylmethane derivative, a triarylmethane derivative, a styrylanthracene derivative, a pyrazoline derivative, a divinylbenzene derivative, a hydrazone derivative, an indene derivative, an indenone derivative, a butadiene derivative, a pyrene derivative, such as pyrene-formaldehyde and polyvinylpyrene, a stilbene derivative, such as an α-phenylstilbene derivative and bisstilbene derivative, an enamine derivative, and a thiophene derivative, such as polyalkylthiophene, and one or more materials selected from the group consisting of pentacene, tetracene, a bisazo colorant, a trisazo colorant, a polyazo colorant, a triarylmethane colorant, a thiazine colorant, an oxazine colorant, a xanthene colorant, a cyanine colorant, a styryl colorant, a pyrylium colorant, a quinacridone colorant, an indigo colorant, a perylene colorant, a polycyclic quinone colorant, a bisbenzimidazole colorant, an indanthrone colorant, a squalirium colorant, an anthraquinone colorant, and a phthalocyanine colorant, such as copper phthalocyanine and titanyl phthalocyanine.

FIG. 1 is a schematic cross sectional view showing an example of the structure of the electronic device according to the invention. The electronic device has a substrate 1 having accumulated thereon in this order a gate electrode 2 (first electrode layer), an insulating layer 3, a second electrode layer containing a source electrode 4 and a drain electrode 5, and a semiconductor layer 6.

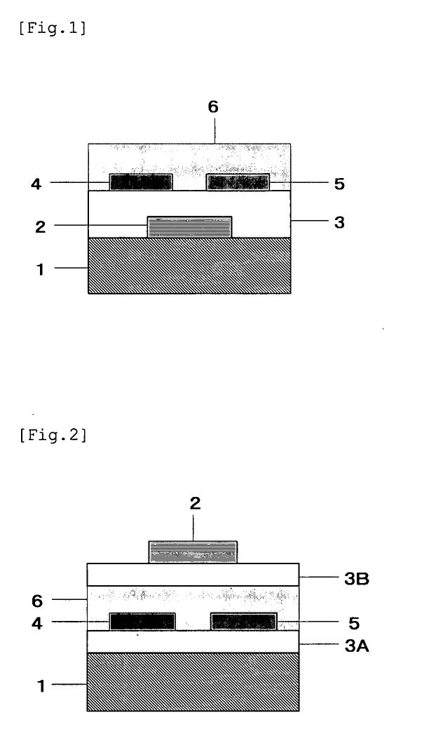

FIG. 2 is a schematic cross sectional view showing another example of the structure of the electronic device according to the invention. The electronic device has a substrate 1 having accumulated thereon in this order an insulating layer 3A (first insulating layer), a source electrode 4 and a drain electrode 5 (first electrode layer), a semiconductor layer 6, an insulating layer 3B (second insulating layer), and a gate electrode 2 (second electrode layer).

Examples of the material of the electrode include materials obtained by coating a solution containing nanomized a metal, an alloy thereof or an oxide thereof dispersed therein to form a film, and materials obtained by forming a metal, an alloy thereof or an oxide thereof into a metallic alkoxide solution, which is formed into a film by a sol-gel method. Examples of the metal include chromium, tantalum, titanium, copper, aluminum, molybdenum, tungsten, nickel, gold, palladium, platinum, silver, tin and indium. A coating composition containing at least one electroconductive polymer dispersed or dissolved in a solvent may also be used. The electroconductive polymer may be selected from the group consisting of a polyacetylene electroconductive polymer, a polyphenylene electroconductive polymer, such as polyparaphenylene and a derivative and polyphenylenevinylene and a derivative thereof, a heterocyclic electroconductive polymer, such as polypyrrole and a derivative thereof, polythiophene, polyethylenedioxythiophene and a derivative thereof and polyfuran and a derivative thereof, and an ionic electroconductive polymer, such as polyaniline and a derivative The electroconductive polymer may be used after being doped with a suitable dopant. Preferred examples of the dopant include such materials as polysulfonic acid, polystyrenesulfonic acid, naphthalenesulfonic acid and alkylnaphthalenesulfonic acid.

A material obtained by forming a solution having electroconductive carbon dispersed therein into a film may also be used as the electrode material.

### EXAMPLES

The invention will be described with reference to examples and a comparative example below, but the invention is not construed as being limited to the examples. The tetracarboxylic dianhydrides, diamines and solvents used in the examples and comparative example may be shown by the following abbreviated names.

### <Tetracarboxylic Dianhydride>

1,2,3,4-cyclobutanetetracarboxylic dianhydride (formula (1)): CBDA
1,2,4,5-cyclohexanetetracarboxylic dianhydride (formula (7)): CHDA

### <Diamine>

4,4′-diaminodiphenylmethane (formula (69)): DDM
2,2-bis(4-(4-aminophenyoxy)phenyl)propane (formula (109): BAPP
5-(4-(2-(4-heptylcyclohexyl)ethyl)cyclohexyl)phenylmethyl-1,3-diaminobenzene (formula (I-25), wherein R⁴³ is C₇H₁₅): 7Ch2Ch

### <Solvent>

N-methyl-2-pyrrolidone: NMP
butylcellosolve (ethylene glycol monobutyl ether): BC

### <Functional Compound>

N,N,N′,N′-tetraglycidyl-4,4′-diaminodiphenylmethane: TGAPM 3,4-epoxychclohexenylmethyl-3′,4′-epoxycyclohexene caboxylate: ECC
N-phenylmaleimide-glycidyl methacrylate copolymer (glycidyl methacrylate: 80% by mol): NPGM

### Synthesis Example 1

### <Synthesis of Polyamic Acid A>

2.9128 g (14.7 mmol) of DDM and 60.0 g of dehydrated NMP were charged in a 100-mL four-neck flask equipped with a thermometer, an agitator, a material charging port and a nitrogen introducing port, and dissolved in each other by agitating under a dry nitrogen stream. 1.6466 g (7.35 mmol) of CHDA and 1.4406 g (7.35 mmol) of CBDA were added thereto and reacted in a room temperature environment for 30 hours. In the case where the reaction temperature was increased during the reaction, the reaction was carried out with a reaction temperature suppressed to about 70° C.

34.0 g of BC was added to the resulting solution to prepare a solution PA1 of a polyamic acid A having a concentration of 6%. The resulting solution PA1 had a viscosity of 45.0 mPa·s.

### Synthesis Example 2

### <Synthesis of Polyamic Acid B>

4.1747 g (8.50 mmol) of 7Ch2Ch and 60.0 g of dehydrated NMP were charged in a 100-mL four-neck flask equipped with a thermometer, an agitator, a material charging port and a nitrogen introducing port, and dissolved in each other by agitating under a dry nitrogen stream. 1.675 g (8.50 mmol) of CBDA was added thereto and reacted in a room temperature environment for 30 hours. In the case where the reaction temperature was increased during the reaction, the reaction was carried out with a reaction temperature suppressed to about 70° C.

34.0 g of BC was added to the resulting solution to prepare a solution PA2 of a polyamic acid B having a concentration of 6%. The resulting solution PA2 had a viscosity of 12.3 mPa·s.

### Synthesis Example 3

<Synthesis of N-phenylmaleimide-glycidyl methacrylate Copolymer (glycidyl methacrylate: 80% by mol)>

16.0 g of N-phenylmaleimide, 52.5 g of glycidyl methacrylate and 137 g of dehydrated NMP were charged in a 100-mL four-neck flask equipped with a thermometer, an agitator, a material charging port and a nitrogen introducing port, and dissolved in each other by agitating under a dry nitrogen stream. 3 g of AIBN was added thereto and reacted at 80° C. for 6 hours. The resulting solution NPGM had a viscosity of 88.0 mPa·s.

### Example 1

1.2 g of TGAPM was added to a mixed solution of 95 g of PA1 and 5 g of PA2 to prepare a mixed solution S1, which was then spin-coated and baked in a clean oven at 180° C. for 0.5 hour, to obtain a polyimide thin film having a thickness of about 150 nm.

### Example 2

1.2 g of ECC was added to a mixed solution of 95 g of PA1 and 5 g of PA2 to prepare a mixed solution S2, which was then spin-coated and baked in a clean oven at 180° C. for 0.5 hour, to obtain a polyimide thin film having a thickness of about 154 nm.

### Example 3

2.4 g of ECC was added to a mixed solution of 95 g of PA1 and 5 g of PA2 to prepare a mixed solution S3, which was then spin-coated and baked in a clean oven at 180° C. for 0.5 hour, to obtain a polyimide thin film having a thickness of about 152 nm.

### Example 4

3.6 g of NPGM was added to a mixed solution of 95 g of PA1 and 5 g of PA2 to prepare a mixed solution S4, which was then spin-coated and baked in a clean oven at 180° C. for 0.5 hour, to obtain a polyimide thin film having a thickness of about 155 nm.

### Example 5

7.2 g of NPGM was added to a mixed solution of 95 g of PA1 and 5 g of PA2 to prepare a mixed solution S5, which was then spin-coated and baked in a clean oven at 180° C. for 0.5 hour, to obtain a polyimide thin film having a thickness of about 149 nm.

### Example 6

0.18 g of trimellitic anhydride as an epoxy curing agent was added to a mixed solution S6 of 17 g of NPGM and 5 g of PA2 to prepare a solution, which was then spin-coated and baked in a clean oven at 180° C. for 0.5 hour, to obtain a polyimide thin film having a thickness of about 153 nm.

### Comparative Example 1

A mixed solution S7 of 95 g of PA1 and 5 g of PA2 was spin-coated and baked in a clean oven at 180° C. for 0.5 hour to obtain a polyimide thin film having a thickness of about 150 nm.

### Evaluation of Volume Resistivity

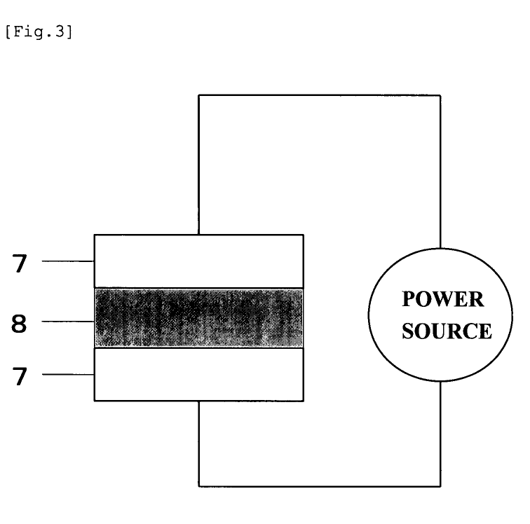

FIG. 3 is a diagram showing a constitution of a device for evaluating a volume resistivity. An Al electrode obtained by vapor deposition was used as an electrode 7. The volume resistivity was evaluated by using the device. The results obtained are shown in Table 1 below.

TABLE 1

| | | | | | | | Comparative |
|---|---|---|---|---|---|---|---|
| | Example 1 | Example 2 | Example 3 | Example 4 | Example 5 | Example 6 | Example 1 |
| Volume | 1.1 × 10¹⁵ | 3.2 × 10¹⁵ | 3.5 × 10¹⁵ | 2.5 × 10¹⁵ | 2.2 × 10¹⁵ | 8.9 × 10¹⁴ | 8.5 × 10¹³ |
| resistivity | | | | | | | |
| (Ω · m) | | | | | | | |

In general, a volume resistivity of 1×10¹⁴ Ω·cm or more is considered as good insulating property. Accordingly, it is understood that the polyimide thin films of the examples are excellent in insulating property.

### INDUSTRIAL APPLICABILITY

By using the composition for forming an insulating layer of the invention, such an insulating film can be formed that, for example, is excellent in insulating property and is improved in film strength, and an electronic device can be produced at low cost. The electronic device can be applied to an arithmetic device and a display device.

1. A composition, which is used for forming an insulating layer of an electronic device, comprising at least one polymer selected from the group consisting of a polyamic acid and a derivative of a polyamic acid, and a compound having a functional group capable of reacting with a carboxyl group contained in a constitutional unit of the polymer.

2. The composition according to claim 1, wherein the compound having a functional group capable of reacting with a carboxyl group is a compound having two or more of the functional groups in a molecule.

3. The composition according to claim 1, wherein the compound having a functional group capable of reacting with a carboxyl group is a compound having oxiranyl, oxiranylene, oxetanyl, thiiranyl, aziridinyl, oxazolinyl or —NCO in a molecule.

4. The composition according to claim 1, wherein the compound having a functional group capable of reacting with a carboxyl group is a homopolymer or a copolymer of an addition-polymerizable monomer; and the functional group is oxiranyl, oxiranylene, oxetanyl, thiiranyl, aziridinyl, oxazolinyl or —NCO.

5. The composition according to claim 1, wherein the compound having a functional group capable of reacting with a carboxyl group is an N-phenylmaleimide-glycidyl methacrylate copolymer.

6. The composition according to claim 1, wherein the polymer is at least one selected from polyamic acids obtained by reacting at least one tetracarboxylic acid derivative selected from the group consisting of tetracarboxylic dianhydrides represented by the following formulae (1) to (40) and derivatives of the tetracarboxylic dianhydrides, or a mixture of the tetracarboxylic acid derivative(s) and at least one other tetracarboxylic acid derivatives, with a diamine; and the compound having a functional group capable of reacting with a carboxyl group contained in a constitutional unit of the polymer is a compound having oxiranyl, oxiranylene, oxetanyl, thiiranyl, aziridinyl, oxazolinyl or —NCO in a molecule:

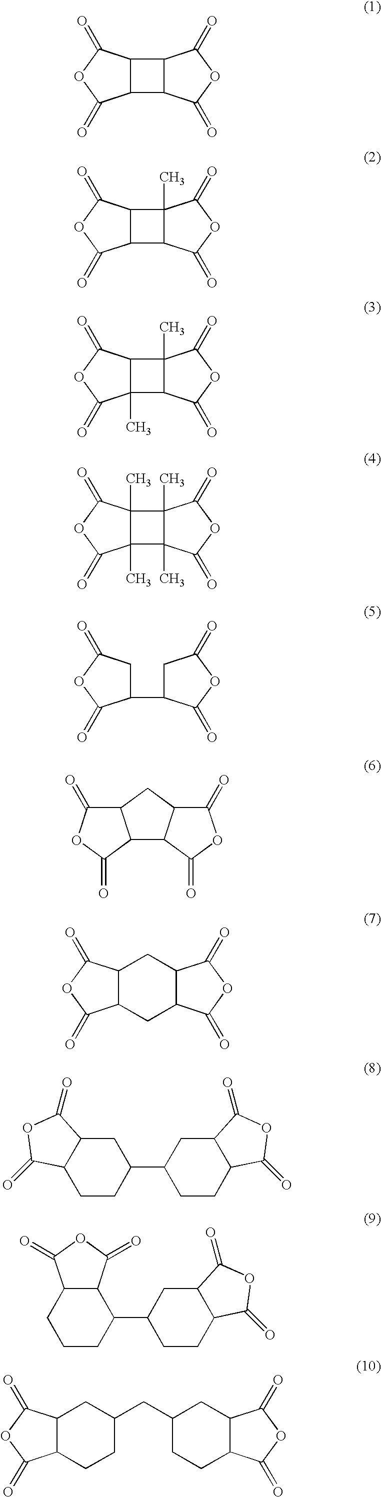

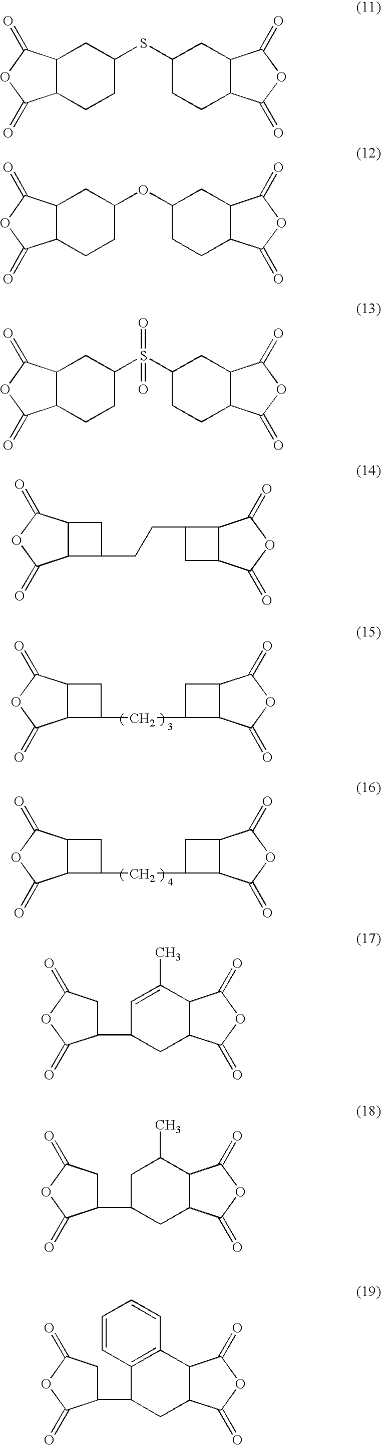

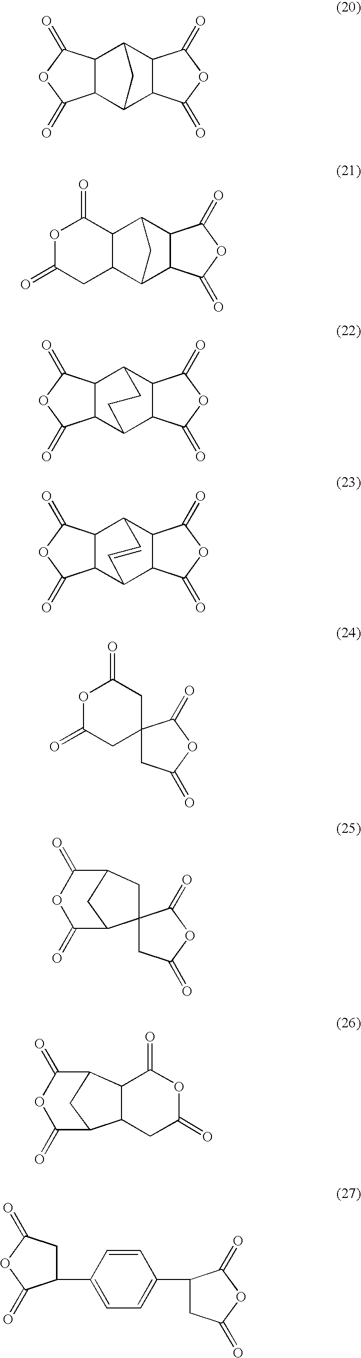

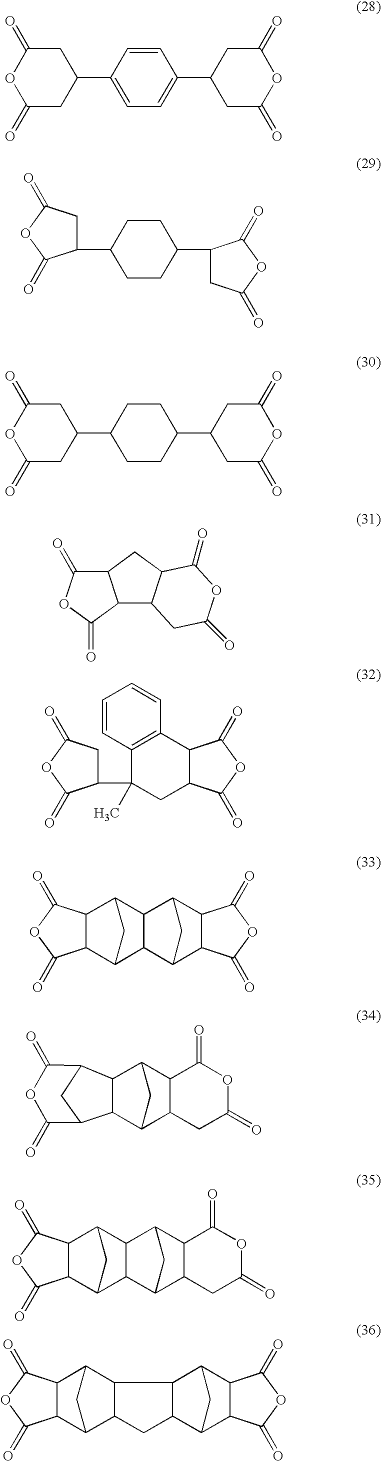

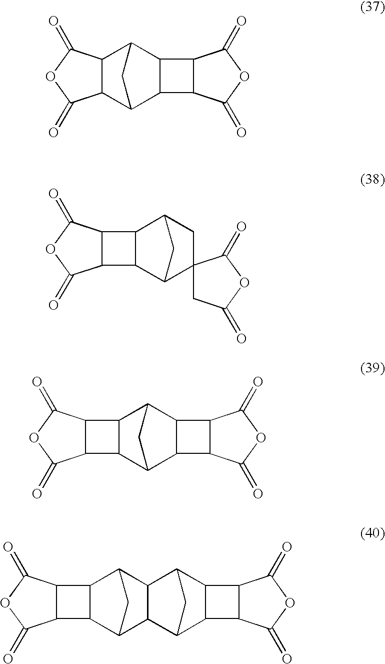

7. The composition according to claim 6, wherein the compound having a functional group capable of reacting with a carboxyl group is a homopolymer or a copolymer of an addition-polymerizable monomer; and the functional group is oxiranyl, oxiranylene, oxetanyl, thiiranyl, aziridinyl, oxazolinyl or —NCO.

8. The composition according to claim 6, wherein the compound having a functional group capable of reacting with a carboxyl group is an N-phenylmaleimide-glycidyl methacrylate copolymer.

9. The composition according to claim 1, wherein the polymer is at least one selected from polyamic acids obtained by reacting at least one tetracarboxylic acid derivative selected from the group consisting of tetracarboxylic dianhydrides represented by the following formulae (1) to (58) and derivatives of the tetracarboxylic dianhydrides, with at least one diamine having a side chain or a mixture of the diamine(s) and at least one diamine having no side chain; and the compound having a functional group capable of reacting with a carboxyl group contained in a constitutional unit of the polymer is a compound having oxiranyl, oxiranylene, oxetanyl, thiiranyl, aziridinyl, oxazolinyl or —NCO in a molecule:

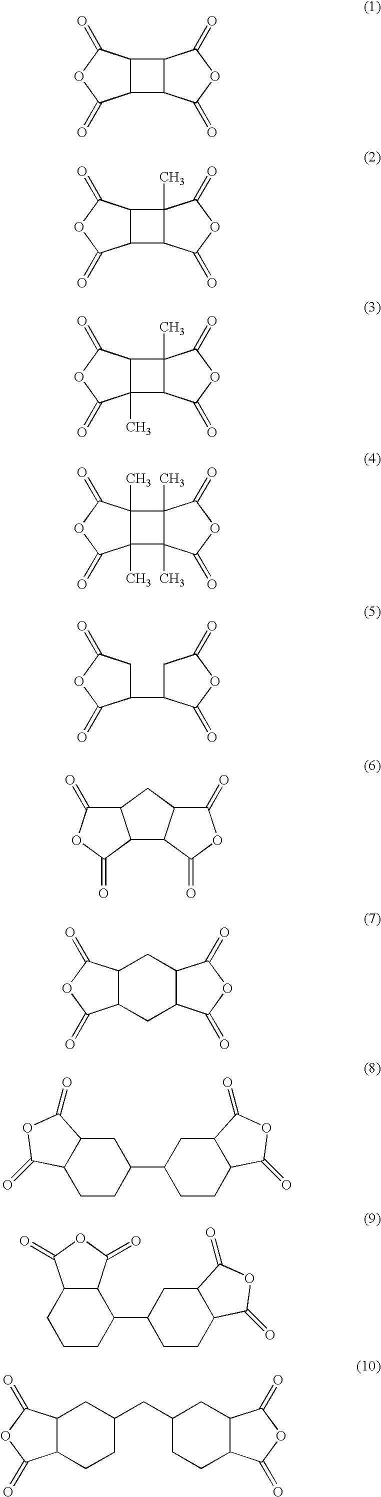

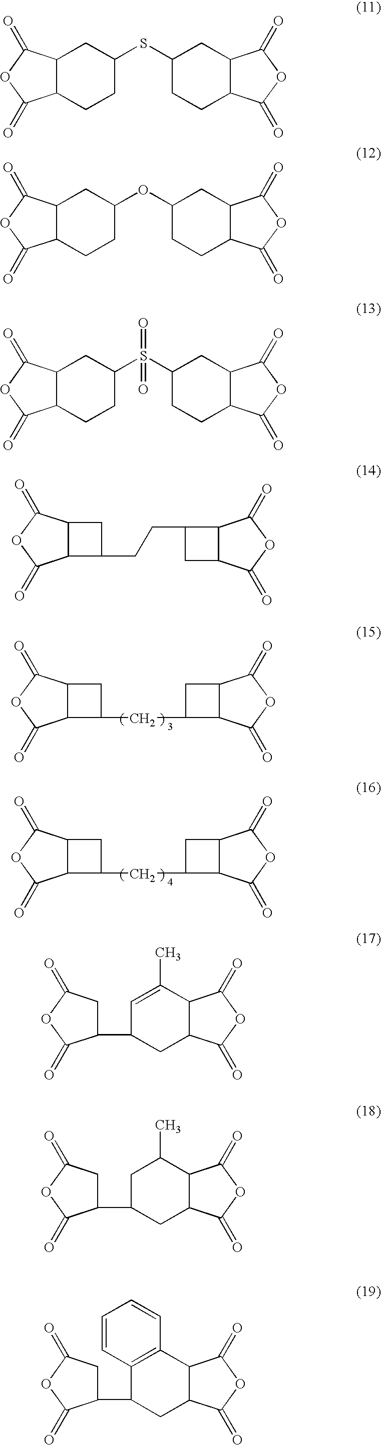

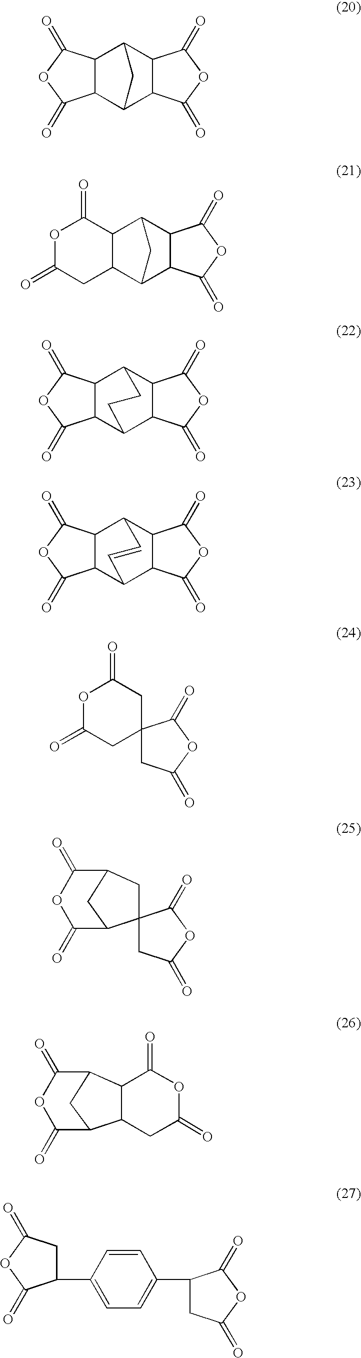

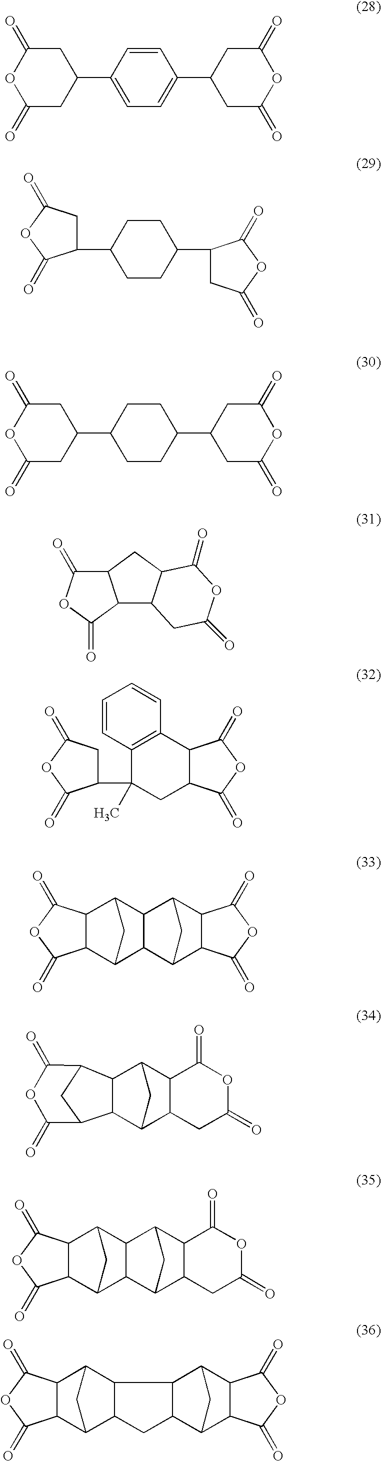

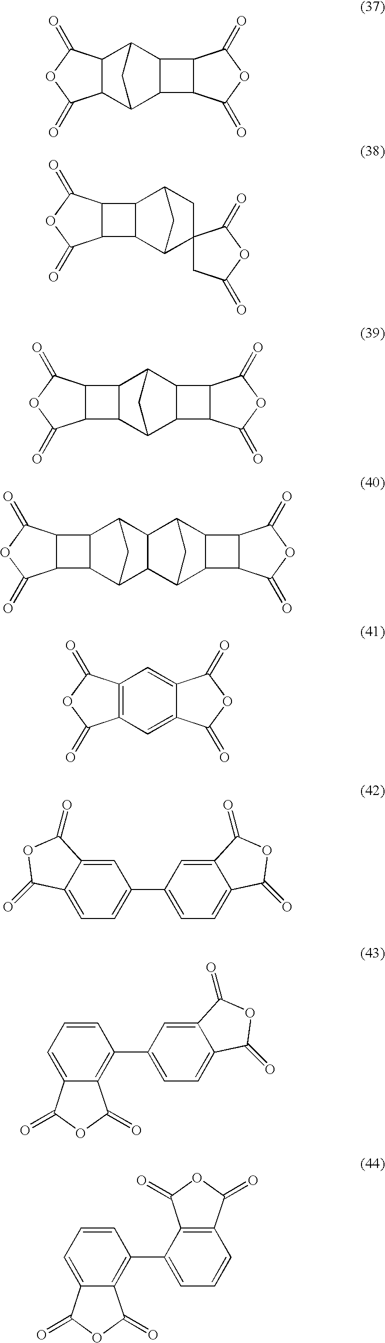

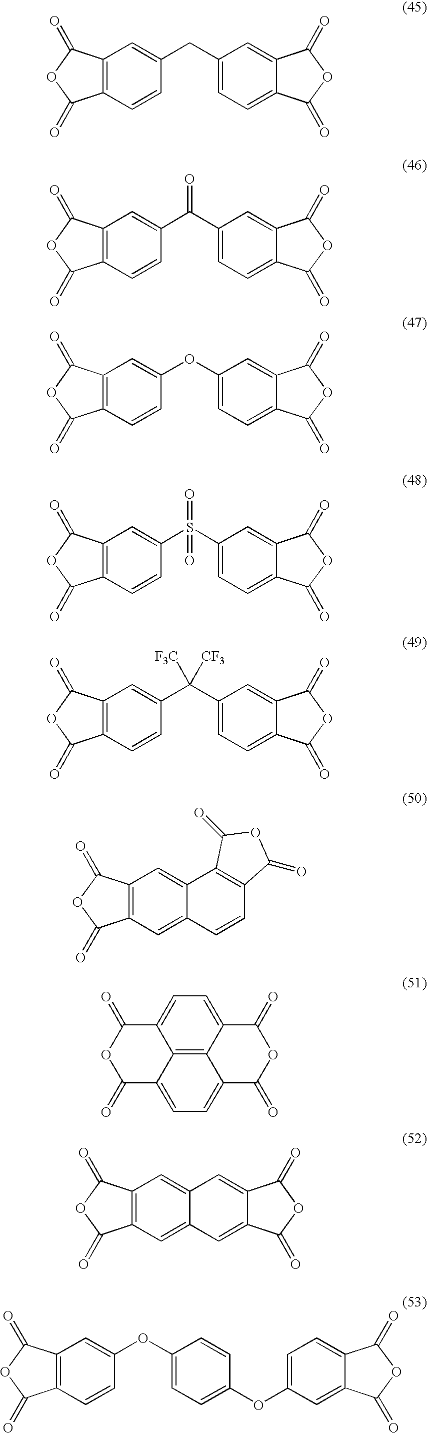

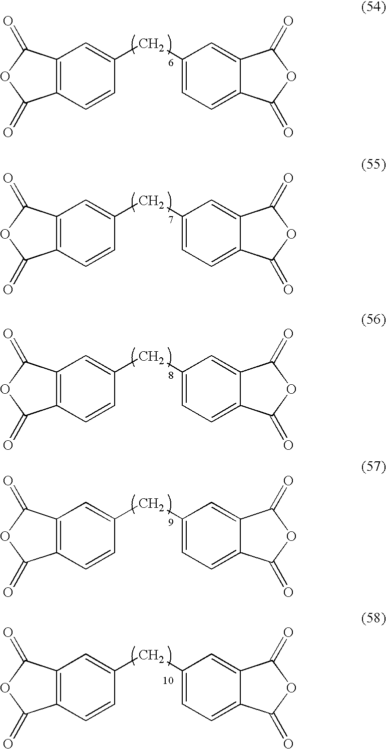

10. The composition according to claim 9, wherein the compound having a functional group capable of reacting with a carboxyl group is a homopolymer or a copolymer of an addition-polymerizable monomer; and the functional group is oxiranyl, oxiranylene, oxetanyl, thiiranyl, aziridinyl, oxazolinyl or —NCO.

11. The composition according to claim 9, wherein the compound having a functional group capable of reacting with a carboxyl group is an N-phenylmaleimide-glycidyl methacrylate copolymer.

12. The composition according to claim 1, wherein the polymer is at least one selected from polyamic acids obtained by reacting at least one tetracarboxylic acid derivative selected from the group consisting of tetracarboxylic dianhydrides represented by the following formulae (1) to (58) and derivatives of the tetracarboxylic dianhydrides, with at least one diamine, which has a side chain, selected from the group consisting of compounds represented by the following formulae (I) to (V), or a mixture of the diamine(s) and at least one diamine having no side chain; and the compound having a functional group capable of reacting with a carboxyl group contained in a constitutional unit of the polymer is a compound having oxiranyl, oxiranylene, oxetanyl, thiiranyl, aziridinyl, oxazolinyl or —NCO in a molecule: 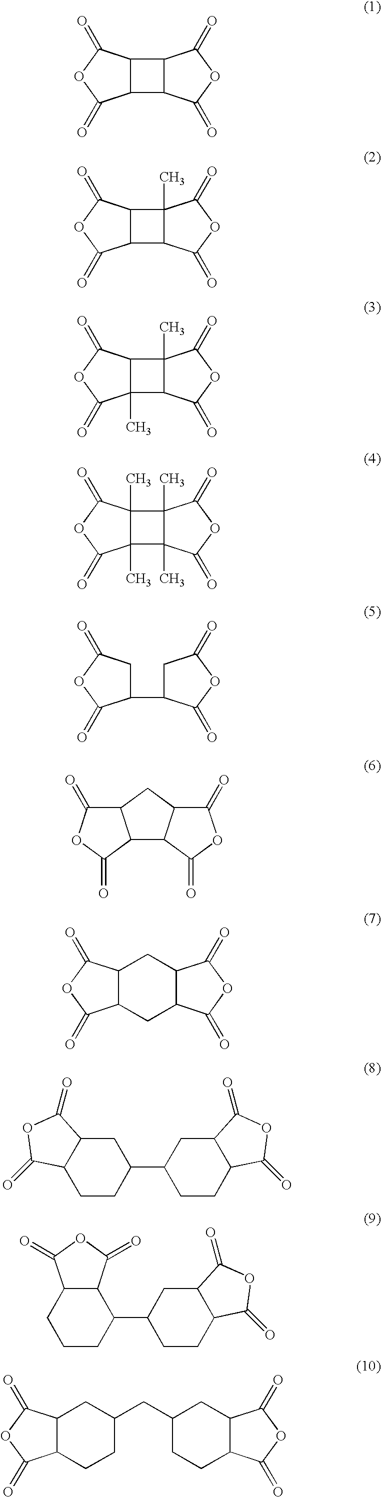 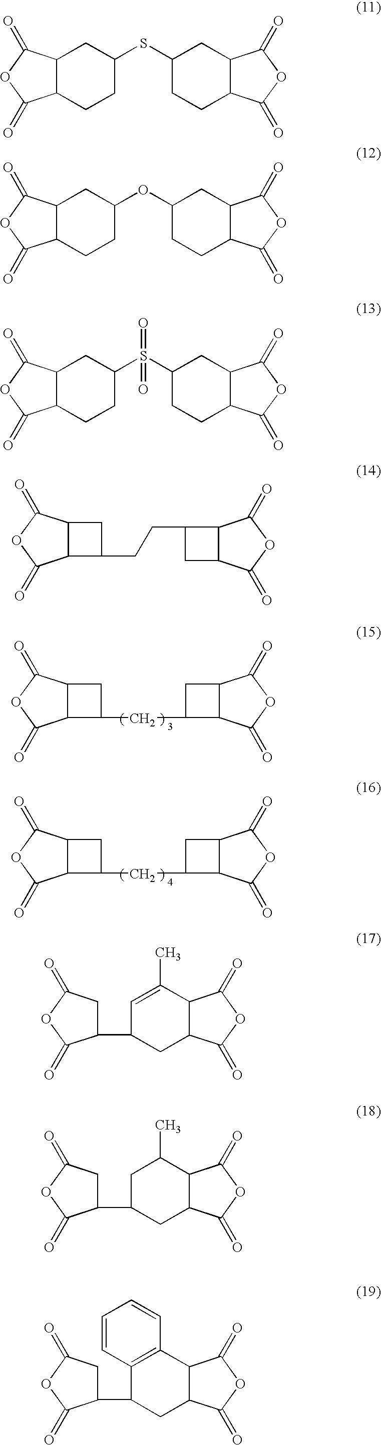 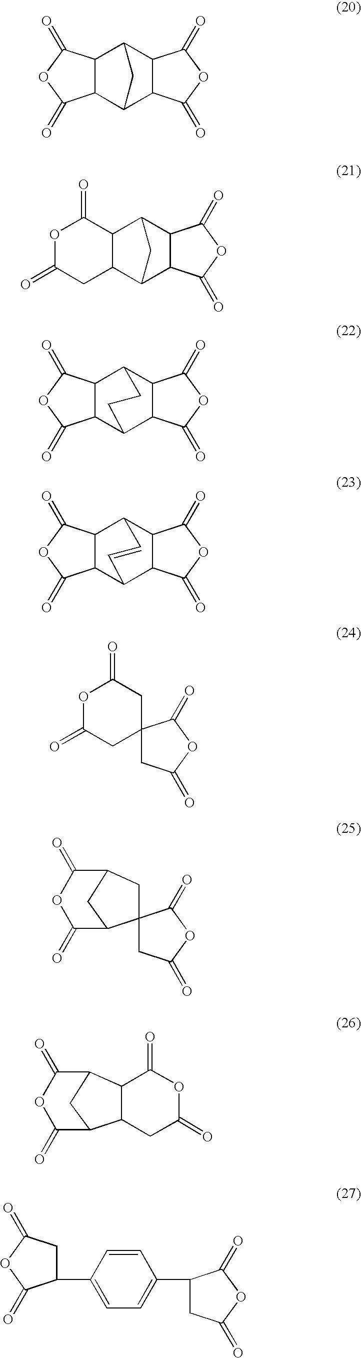 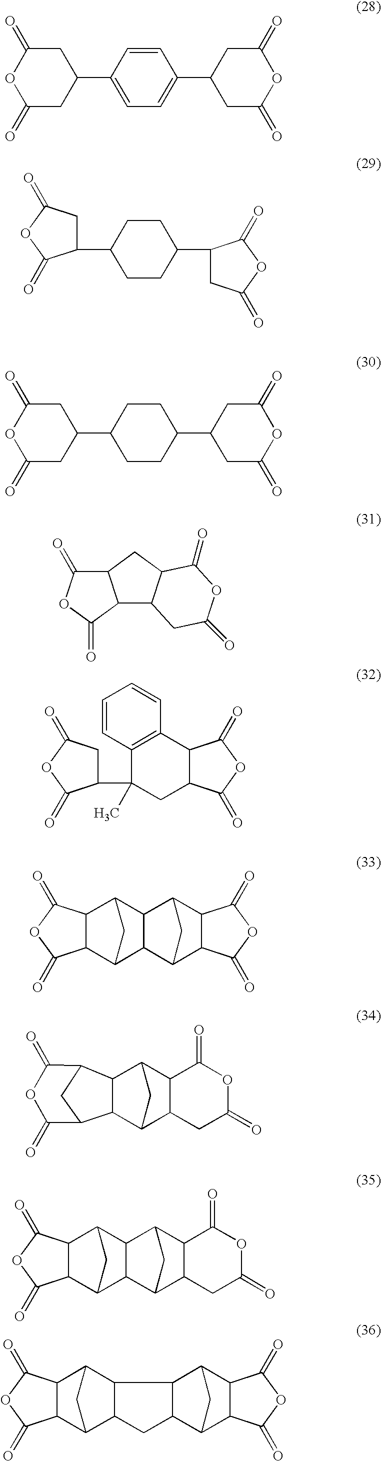 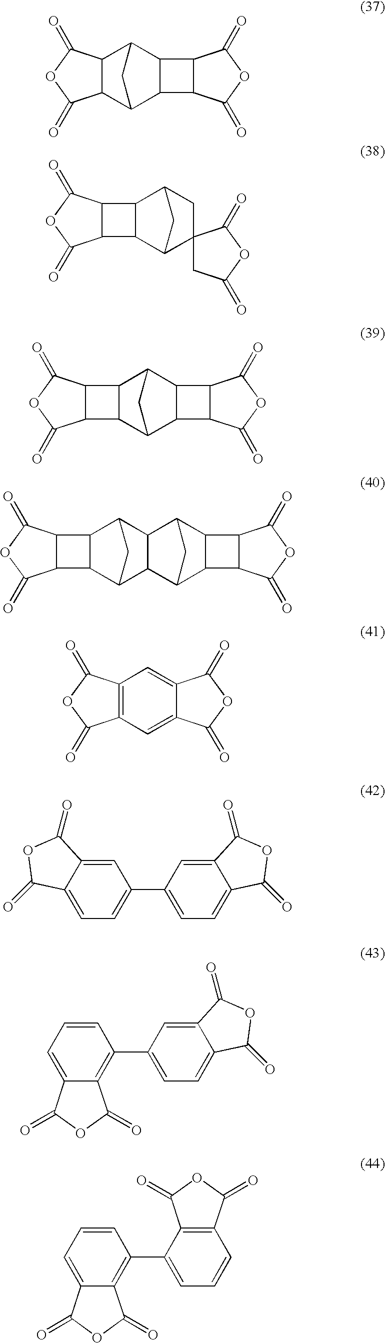 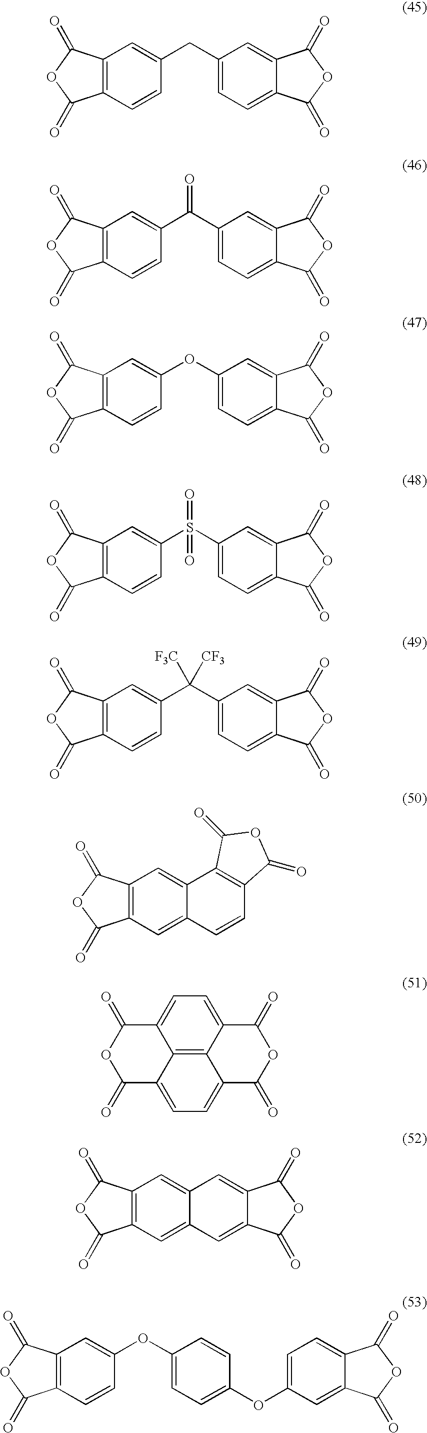 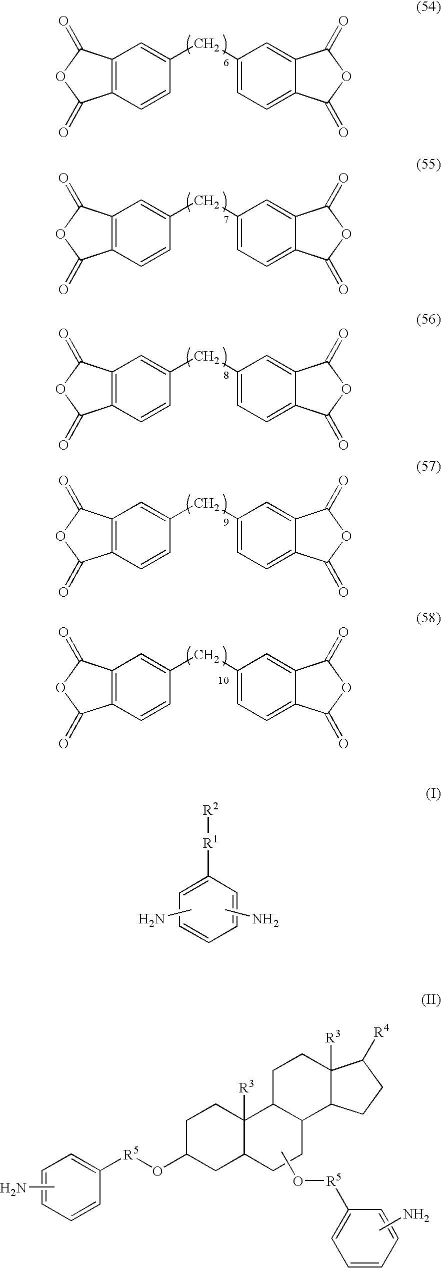 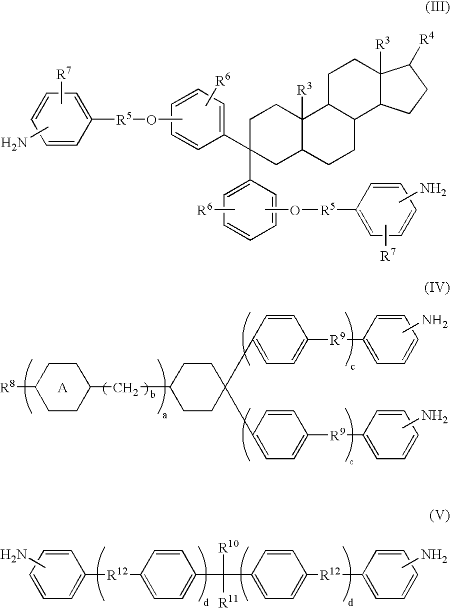
wherein:
in the formula (I), R¹ is a single bond, —O—, —CO—, —COO—, —OCO—, —CONH—, —CH₂O—, —CF₂O— or —(CH₂)ₑ—, wherein e is an integer of from 1 to 6; and R² is a group having a steroid skeleton, a group represented by the following formula (I-a), alkyl having from 1 to 30 carbon atoms, or phenyl, and when the alkyl has from 2 to 6 carbon atoms, arbitrary —CH₂— of the alkyl may be replaced by —O—, —CH═CH— or —C≡C—, and hydrogen of the phenyl may be replaced by fluorine, methyl, methoxy, fluoromethoxy, difluoromethoxy or trifluoromethoxy: 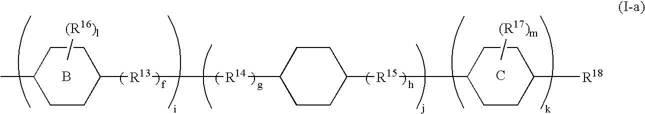
wherein R¹³, R¹⁴ and R¹⁵ are independently a single bond, —O—, —COO—, —OCO—, —CONH—, alkylene having from 1 to 4 carbon atoms, oxyalkylene having from 1 to 3 carbon atoms, or alkyleneoxy having from 1 to 3 carbon atoms; R¹⁶ and R¹⁷ are independently hydrogen, fluorine or methyl; R¹⁸ is hydrogen, fluorine, chlorine, cyano, alkyl having from 1 to 30 carbon atoms, alkoxy having from 1 to 30 carbon atoms, alkoxyalkyl having from 2 to 30 carbon atoms, fluoromethyl, difluoromethyl, trifluoromethyl, fluoromethoxy, difluoromethoxy or trifluoromethoxy, and arbitrary —CH₂— of the alkyl, alkoxy and alkoxyalkyl may be replaced by difluoromethylene or a group represented by the following formula (I-b); ring B and ring C are independently 1,4-phenylene or 1,4-cyclohexylene; f, g and h are independently an integer of from 0 to 4; i, j and k are independently an integer of from 0 to 3, and the sum of i, j and k is 1 or more; and l and m are independently 1 or 2: 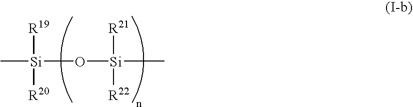
wherein R¹⁹, R²⁰, R²¹ and R²² are independently alkyl having from 1 to 10 carbon atoms or phenyl; and n is an integer of from 1 to 100;
in the formula (II), R³ is independently hydrogen or methyl; R⁴ is hydrogen or alkyl having from 1 to 30 carbon atoms; and R⁵ is independently a single bond, —CO— or —CH₂—;
in the formula (III), R³ is independently hydrogen or methyl; R⁴ is hydrogen or alkyl having from 1 to 30 carbon atoms; R⁵ is independently a single bond, —CO— or —CH₂—; and R⁶ and R⁷ are independently hydrogen, alkyl having 1 to 30 carbon atoms or phenyl;
in the formula (IV), R⁸ is hydrogen or alkyl having from 1 to 30 carbon atoms, and arbitrary —CH₂— of the alkyl may be replaced by —O—, —CH═CH— or —C≡C—; R⁹ is independently —O— or alkylene having from 1 to 6 carbon atoms; ring A is 1,4-phenylene or 1,4-cyclohexylene; a is 0 or 1; b is 0, 1 or 2; and c is independently 0 or 1; and
in the formula (V), R¹⁰ is alkyl having from 3 to 30 carbon atoms or fluorinated alkyl having from 3 to 30 carbon atoms; R¹¹ is hydrogen, alkyl having from 1 to 30 carbon atoms or fluorinated alkyl having from 1 to 30 carbon atoms;
R¹² is independently —O— or alkylene having from 1 to 6 carbon atoms; and d is independently 0 or 1.

13. The composition according to claim 12, wherein the compound having a functional group capable of reacting with a carboxyl group is a homopolymer or a copolymer of an addition-polymerizable monomer; and the functional group is oxiranyl, oxiranylene, oxetanyl, thiiranyl, aziridinyl, oxazolinyl or —NCO.

14. The composition according to claim 12, wherein the compound having a functional group capable of reacting with a carboxyl group is an N-phenylmaleimide-glycidyl methacrylate copolymer.

15. The composition according to claim 1, wherein the polymer is a mixture of a polyamic acid obtained by reacting at least one tetracarboxylic acid derivative selected from the group consisting of tetracarboxylic dianhydrides represented by the following formulae (1) to (40) and derivatives of the tetracarboxylic dianhydrides, or a mixture of the tetracarboxylic acid derivative(s) and at least one other tetracarboxylic acid derivatives, with a diamine, and a polyamic acid obtained by reacting at least one tetracarboxylic acid derivative selected from the group consisting of tetracarboxylic dianhydrides represented by the following formulae (1) to (58) and derivatives of the tetracarboxylic dianhydrides, with at least one diamine, which has a side chain, selected from the group consisting of compounds represented by the following formulae (I) to (V), or a mixture of the diamine(s) and at least one diamine having no side chain; and the compound having a functional group capable of reacting with a carboxyl group contained in a constitutional unit of the polymer is a compound having oxiranyl, oxiranylene, oxetanyl, thiiranyl, aziridinyl, oxazolinyl or —NCO in a molecule: 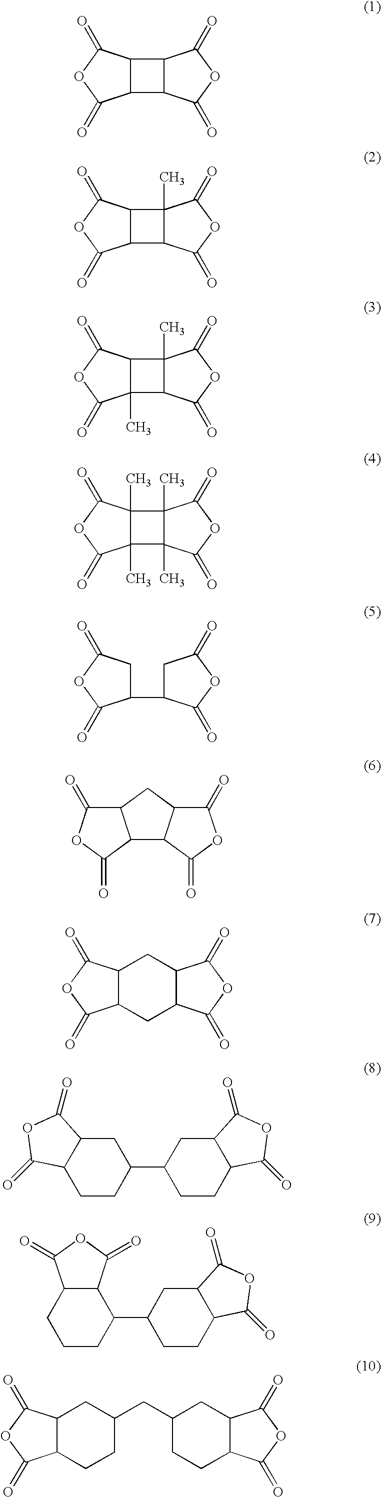 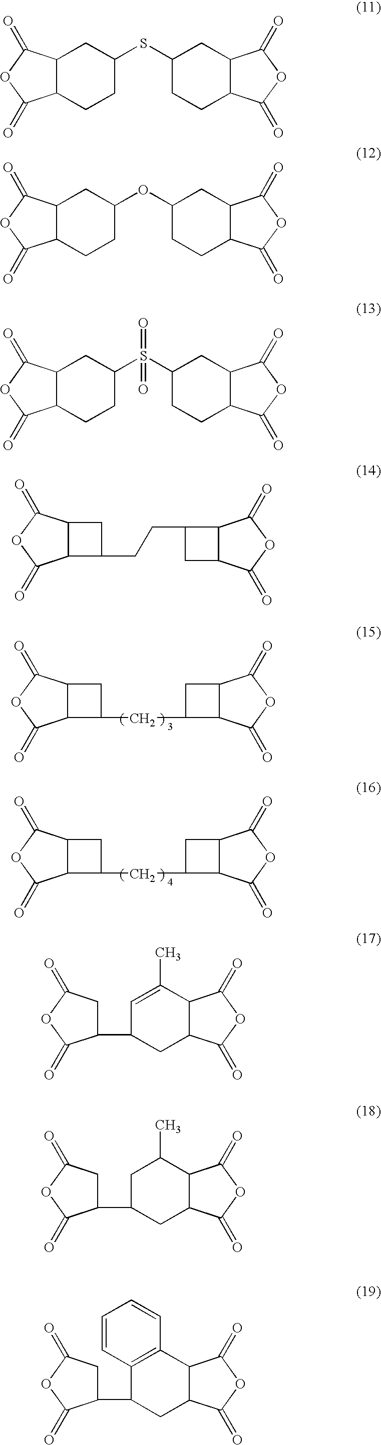 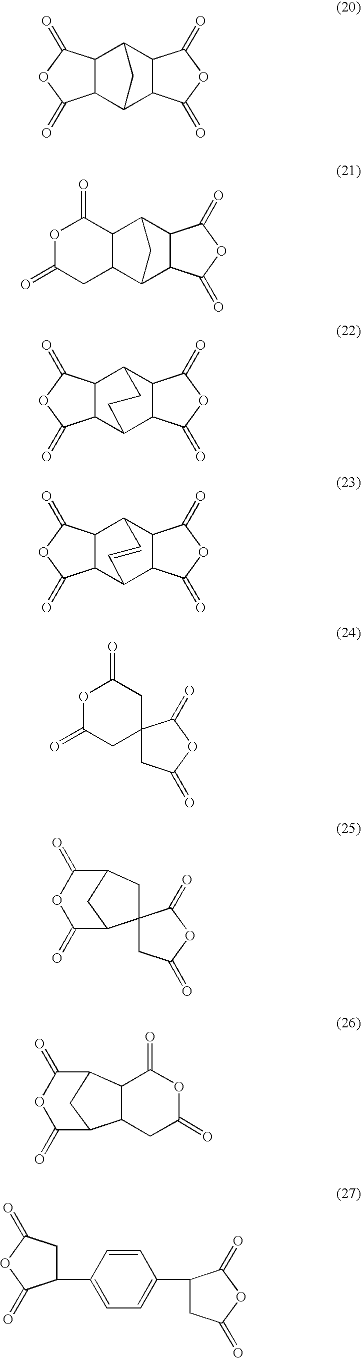 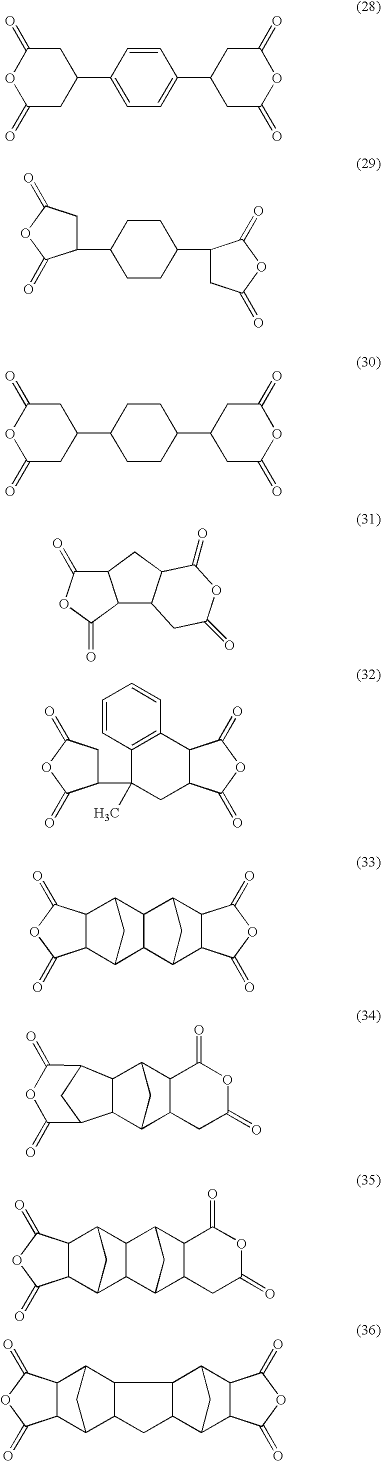 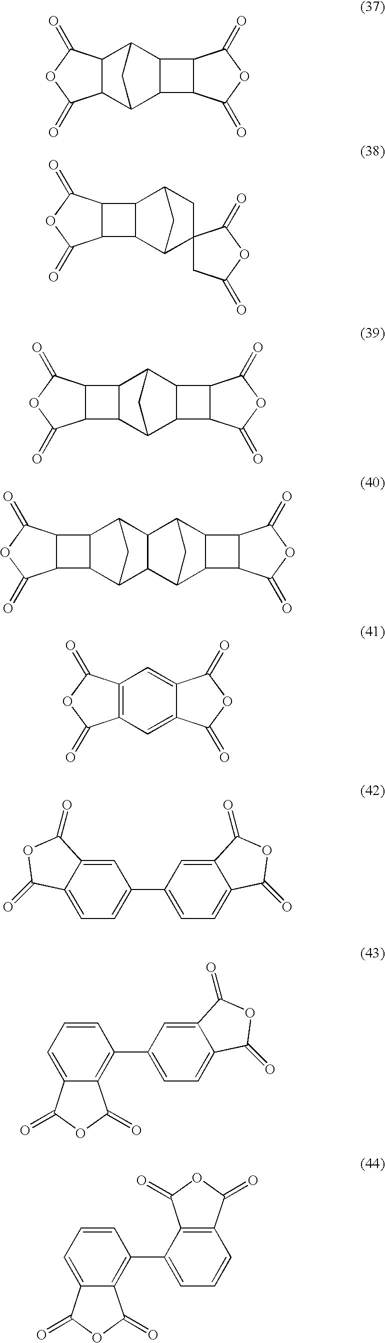 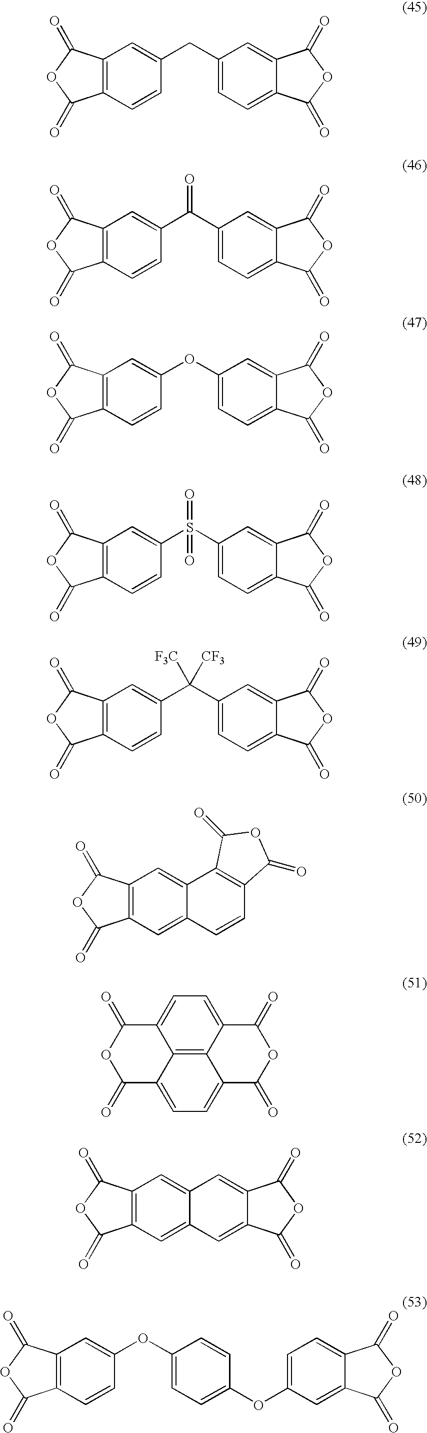 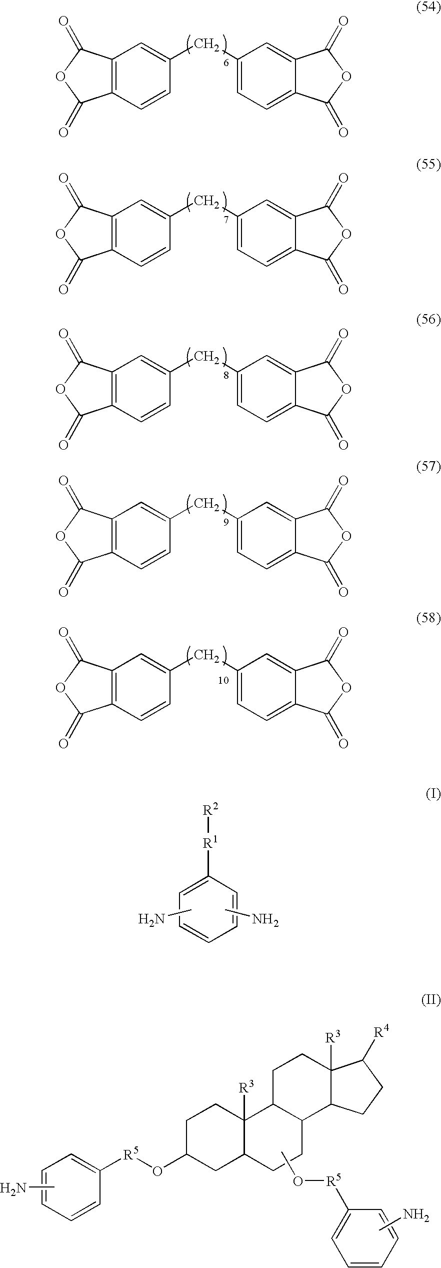 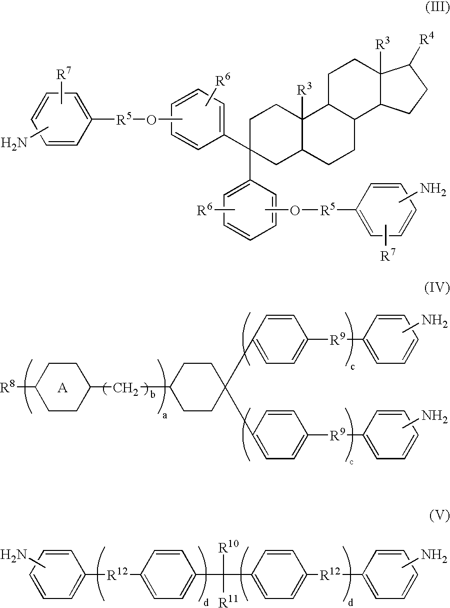
wherein:
in the formula (I), R¹ is a single bond, —O—, —CO—, —COO—, —OCO—, —CONH—, —CH₂O—, —CF₂O— or —(CH₂)ₑ—, wherein e is an integer of from 1 to 6; and R² is a group having a steroid skeleton, a group represented by the following formula (I-a), alkyl having from 1 to 30 carbon atoms, or phenyl, and when the alkyl has from 2 to 6 carbon atoms, arbitrary —CH₂— of the alkyl may be replaced by —O—, —CH═CH— or —C≡C—, and hydrogen of the phenyl may be replaced by fluorine, methyl, methoxy, fluoromethoxy, difluoromethoxy or trifluoromethoxy: 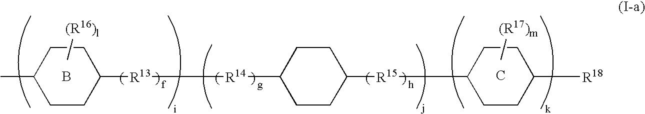
wherein R¹³, R¹⁴ and R¹⁵ are independently a single bond, —O—, —COO—, —OCO—, —CONH—, alkylene having from 1 to 4 carbon atoms, oxyalkylene having from 1 to 3 carbon atoms, or alkyleneoxy having from 1 to 3 carbon atoms; R¹⁶ and R¹⁷ are independently hydrogen, fluorine or methyl; R¹⁸ is hydrogen, fluorine, chlorine, cyano, alkyl having from 1 to 30 carbon atoms, alkoxy having from 1 to 30 carbon atoms, alkoxyalkyl having from 2 to 30 carbon atoms, fluoromethyl, difluoromethyl, trifluoromethyl, fluoromethoxy, difluoromethoxy or trifluoromethoxy, and arbitrary —CH₂— of the alkyl, alkoxy and alkoxyalkyl may be replaced by difluoromethylene or a group represented by the following formula (I-b); ring B and ring C are independently 1,4-phenylene or 1,4-cyclohexylene; f, g and h are independently an integer of from 0 to 4; i, j and k are independently an integer of from 0 to 3, and the sum of i, j and k is 1 or more; and l and m are independently 1 or 2: 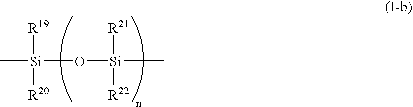
wherein R¹⁹, R²⁰, R²¹ and R²² are independently alkyl having from 1 to 10 carbon atoms or phenyl; and n is an integer of from 1 to 100;
in the formula (II), R³ is independently hydrogen or methyl; R⁴ is hydrogen or alkyl having from 1 to 30 carbon atoms; and R⁵ is independently a single bond, —CO— or —CH₂—;
in the formula (III), R³ is independently hydrogen or methyl; R⁴ is hydrogen or alkyl having from 1 to 30 carbon atoms; R⁵ is independently a single bond, —CO— or —CH₂—; and R⁶ and R⁷ are independently hydrogen, alkyl having 1 to 30 carbon atoms or phenyl;
in the formula (IV), R⁸ is hydrogen or alkyl having from 1 to 30 carbon atoms, and arbitrary —CH₂— of the alkyl may be replaced by —O—, —CH═CH— or —C≡C—; R⁹ is independently —O— or alkylene having from 1 to 6 carbon atoms; ring A is 1,4-phenylene or 1,4-cyclohexylene; a is 0 or 1; b is 0, 1 or 2; and c is independently 0 or 1; and
in the formula (V), R¹⁰ is alkyl having from 3 to 30 carbon atoms or fluorinated alkyl having from 3 to 30 carbon atoms; R¹¹ is hydrogen, alkyl having from 1 to 30 carbon atoms or fluorinated alkyl having from 1 to 30 carbon atoms; R¹² is independently —O— or alkylene having from 1 to 6 carbon atoms; and d is independently 0 or 1.

16. The composition according to claim 15, wherein the compound having a functional group capable of reacting with a carboxyl group is a homopolymer or a copolymer of an addition-polymerizable monomer; and the functional group is oxiranyl, oxiranylene, oxetanyl, thiiranyl, aziridinyl, oxazolinyl or —NCO.

17. The composition according to claim 15, wherein the compound having a functional group capable of reacting with a carboxyl group is an N-phenylmaleimide-glycidyl methacrylate copolymer.

18. The composition according to claim 15, wherein the polymer is a mixture of a polyamic acid obtained by reacting at least one tetracarboxylic dianhydride represented by the formulae (1) to (40) with a diamine, and a polyamic acid obtained by reacting at least one tetracarboxylic dianhydride represented by the formulae (1) to (58) with at least one diamine represented by the formula (I).

19. The composition according to claim 15, wherein the polymer is a mixture of a polyamic acid obtained by reacting a tetracarboxylic dianhydride represented by the formula (1) and a tetracarboxylic dianhydride represented by the formula (7) with 4,4′-diaminodiphenylmethane, and a polyamic acid obtained by reacting a tetracarboxylic dianhydride represented by the formula (1) with a diamine represented by the following formula (I-25): 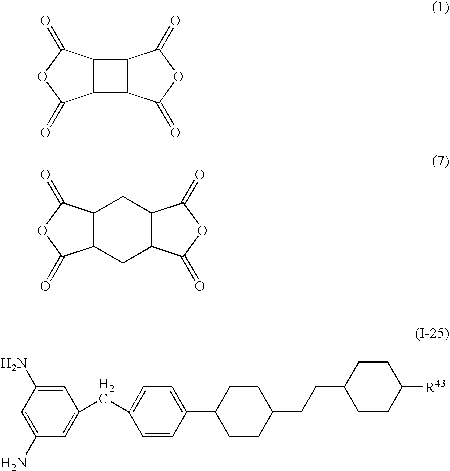
wherein R⁴³ is hydrogen, alkyl having from 1 to 30 carbon atoms or alkoxy having from 1 to 30 carbon atoms.

20. A thin film obtained by using the composition according to claim 1.

21. An insulating layer provided on a substrate by using the composition according to claim 1.

22. An electronic device containing the insulating layer according to claim 21.
